(19) United States
(12) Patent Application Publication
(10) Pub. No.: US 2016/0321757 A1
(43) Pub. Date: Nov. 3, 2016

(54) METHODS AND SYSTEMS FOR GENERATING, AND RESPONDING TO, REQUESTS FOR PROPOSALS AND REQUESTS FOR INFORMATION FOR INSURANCE PRODUCTS

(71) Applicant: PACIFIC RESOURCES BENEFITS ADVISORS, LLC, Chicago, IL (US)

(72) Inventors: Neale Hegarty, West Simsbury, CT (US); Paul Rogers, Upton, MA (US)

(21) Appl. No.: 14/699,394

(22) Filed: Apr. 29, 2015

(51) Int. Cl. G06Q 40/08; G06Q 30/06

(52) U.S. Cl. CPC G06Q 40/08; G06Q 30/0611

(57) ABSTRACT

The present disclosure relates to methods and systems for generating, and responding to, requests for proposals (RFPs) and/or requests for information (RFIs) for insurance products. The methods and systems may generate requests for proposals (RFPs) and/or requests for information (RFIs) based on RFP/RFI questions stored in a RFP/RFI questions library database. At least some of the RFP/RFI questions, stored in the RFP/RFI questions library database, may include a respective merge field.

### TECHNICAL FIELD

The present disclosure relates to methods and systems for generating, and responding to, requests for proposals (RFPs) and/or requests for information (RFIs) for insurance products. More particularly, the present disclosure relates to methods and systems for generating, and responding to, requests for proposals (RFPs) and/or requests for information (RFIs) based on RFP/RFI questions stored in a RFP/RFI questions library database.

### BACKGROUND

Requests for proposals (RFPs) and requests for information (RFIs) often include a number of questions and/or items that individuals need to respond to when answering the RFP and/or the RFI. Often times, the individual that is creating a RFP and/or a RFI will be including questions, and other information, that is common to a series of RFPs and/or RFIs. Sometimes, only a portion of any given question, or other information, changes from one RFP and/or RFI to another.

Similarly, any given RFP and/or RFI may include items to be included, such as major lines of coverage (LOCs) and minor lines of coverage (LOCs) in the context of insurance related RFPs/RFIs. Any given RFP and/or RFI may further include information regarding individuals being invited to respond, such as insurance carriers in the context of insurance related RFPs/RFIs. The lines of coverage and/or the carriers may, for example, be common to a series of RFPs and/or RFIs.

Methods and systems are needed for creating and responding to RFPs and RFIs that automatically include certain information based on other information that is provided by a creator and/or responder.

### SUMMARY

A system for generating an insurance related request for proposal (RFP) and/or a request for information (RFI) may include a computing device having a memory and a processor. The system may also include a RFP/RFI question data receiving module stored on the memory that, when executed by the processor, causes the processor to receive RFP/RFI question data, wherein the RFP/RFI question data is representative of RFP/RFI questions to be included in the RFP and/or the RFI, and wherein at least some of the RFP/RFI questions include a respective information merge field. The system may further include a RFP/RFI creation data receiving module stored on the memory that, when executed by the processor, causes the processor to receive RFP/RFI creation data, wherein the RFP/RFI creation data is representative of information related to insurance products and insurance carriers to be included in the RFP and/or the RFI, and wherein the RFP/RFI creation data further includes information merge data. The system may yet also include a RFP/RFI question data and information merge data merging module stored on the memory that, when executed by the processor, causes the processor to merge the information merge data into at least one information merge field of at least one RFP/RFI question to generate RFP/RFI merged question data. The system may yet further include a RFP/RFI generation module stored on the memory that, when executed by the processor, causes the processor to generate a RFP and/or a RFI based on at least a portion of the RFP/RFI question data, the RFP/RFI creation data and the RFP/RFI merged question data.

In another embodiment, a computer implemented method for generating an insurance related request for proposal (RFP) and/or a request for information (RFI) may include receiving RFP/RFI question data in response to a processor executing a RFP/RFI question data receiving module, wherein the RFP/RFI question data is representative of a library of RFP/RFI questions. The method may also include receiving RFP/RFI creation data in response to the processor executing a RFP/RFI creation data receiving module that, when executed by the processor, causes the processor to, wherein the RFP/RFI creation data is representative of information related to insurance products and insurance carriers to be included in the RFP and/or the RFI, and wherein the RFP/RFI creation data further includes lines of coverage data. The method may further include generating included RFP/RFI question data in response to the processor executing an included RFP/RFI question data generation module, wherein the included RFP/RFI question data is representative of a first sub-set of RFP/RFI questions contained within the library of RFP/RFI questions, wherein the included RFP/RFI question data is based on the lines of coverage data, and wherein the library of RFP/RFI questions contains a second sub-set of RFP/RFI questions that are not included in the included RFP/RFI question data. The method may yet further include generating a RFP and/or a RFI based on the RFP/RFI included RFP/RFI question data and the RFP/RFI creation data in response to the processor executing a RFP/RFI generation module.

In a further embodiment, a non-transitory computer-readable medium storing instructions that, when executed by a processor, cause the processor to generate an insurance related request for proposal (RFP) and/or a request for information (RFI) may include a RFP/RFI question data receiving module that, when executed by a processor, causes the processor to receive RFP/RFI question data, wherein the RFP/RFI question data is representative of a library of RFP/RFI questions. The non-transitory computer-readable medium may also include a RFP/RFI creation data receiving module that, when executed by a processor, causes the processor to receive RFP/RFI creation data, wherein the RFP/RFI creation data is representative of information related to insurance products and insurance carriers to be included in the RFP and/or the RFI, and wherein the RFP/RFI creation data further includes lines of coverage data. The non-transitory computer-readable medium may further include an included RFP/RFI question data generation module that, when executed by a processor, causes the processor to generate included RFP/RFI question data, wherein the included RFP/RFI question data is representative of a first sub-set of RFP/RFI questions contained within the library of RFP/RFI questions, wherein the included RFP/RFI question data is based on the lines of coverage data, and wherein the library of RFP/RFI questions contains a second sub-set of RFP/RFI questions that are not included in the included RFP/RFI question data. The non-transitory computer-readable medium may yet further include a RFP/RFI generation module that, when executed by a processor, causes the processor to generate a RFP and/or a RFI based on the RFP/RFI included RFP/RFI question data and the RFP/RFI creation data.

### BRIEF DESCRIPTION OF THE DRAWINGS

FIG. 1 depicts a high-level block diagram of an example computer system for creating and responding to requests for proposals (RFPs) and/or requests for information (RFIs);

FIG. 2 depicts a block diagram of an example device for creating requests for proposals (RFPs) and/or requests for information (RFIs);

FIG. 3 depicts a block diagram of an example device for responding to requests for proposals (RFPs) and/or requests for information (RFIs);

FIG. 4 depicts a flow diagram of an example method for creating requests for proposals (RFPs) and/or requests for information (RFIs);

FIG. 5 depicts a flow diagram of an example method for responding to requests for proposals (RFPs) and/or requests for information (RFIs);

FIGS. 6-12 depict example user interfaces for creating requests for proposals (RFPs) and/or requests for information (RFIs);

FIGS. 13-17 depict example user interfaces for adding lines of coverage when creating requests for proposals (RFPs) and/or requests for information (RFIs);

FIGS. 18-26 depict example user interfaces related to adding questions when creating requests for proposals (RFPs) and/or requests for information (RFIs);

FIGS. 27-29 depict example user interfaces for adding rates when creating requests for proposals (RFPs) and/or requests for information (RFIs);

FIGS. 30-43 depict example user interfaces for viewing and modifying questions when creating requests for proposals (RFPs) and/or requests for information (RFIs);

FIG. 44 depicts an example user interface for adding special instructions when creating requests for proposals (RFPs) and/or requests for information (RFIs);

FIG. 45 depicts an example user interface for reviewing an RFP and/or RFI from a carrier's perspective when creating requests for proposals (RFPs) and/or requests for information (RFIs);

FIGS. 46-51 depict example user interfaces for adding carriers when creating requests for proposals (RFPs) and/or requests for information (RFIs);

FIGS. 52 and 53 depict example user interfaces for adding exceptions when creating requests for proposals (RFPs) and/or requests for information (RFIs);

FIGS. 54 and 55 depict example user interfaces for sharing documents related to requests for proposals (RFPs) and/or requests for information (RFIs);

FIGS. 56-63 depict example user interfaces for locking, submitting and opening requests for proposals (RFPs) and/or requests for information (RFIs) for carrier response;

FIGS. 64A-D depict example user interfaces for generating carrier questions when creating and responding to requests for proposals (RFPs) and/or requests for information (RFIs);

FIGS. 65-67 depict example user interfaces submitting requests for proposals (RFPs) and/or requests for information (RFIs);

FIG. 68 depicts an example user interface for locking/unlocking requests for proposals (RFPs) and/or requests for information (RFIs);

FIG. 69 depicts an example user interface for version requests for proposals (RFPs) and/or requests for information (RFIs);

FIGS. 70 and 71 depict example user interfaces for generating chapters when creating requests for proposals (RFPs) and/or requests for information (RFIs);

FIG. 72 depicts an example list of minor lines of coverage for requests for proposals (RFPs) and/or requests for information (RFIs);

FIG. 73 depicts an example user interface for displaying requests for proposals (RFPs) and/or requests for information (RFIs);

FIGS. 74A and 74B depict example user interfaces for navigating a carrier portal when responding to requests for proposals (RFPs) and/or requests for information (RFIs);

FIGS. 75-83 depict example user interfaces for presenting question types when creating and responding to requests for proposals (RFPs) and/or requests for information (RFIs);

FIGS. 84 and 85 depict example user interfaces for attaching files when responding to requests for proposals (RFPs) and/or requests for information (RFIs);

FIGS. 86A and 86B depict example user interfaces for printing requests for proposals (RFPs) and/or requests for information (RFIs);

FIGS. 87 and 88 depict example user interfaces for locking requests for proposals (RFPs) and/or requests for information (RFIs);

FIG. 89 depict example user interfaces for versioning responses for requests for proposals (RFPs) and/or requests for information (RFIs);

FIGS. 90 and 91 depict example additional features for requests for proposals (RFPs) and/or requests for information (RFIs);

FIG. 92 depicts example minor lines of coverage for use in requests for proposals (RFPs) and/or requests for information (RFIs); and

FIGS. 93-95 depict example frequently asked questions related to creating and responding to requests for proposals (RFPs) and/or requests for information (RFIs).

### DETAIL DESCRIPTION

Methods and systems are provided for creating and responding to request for proposals (RFP)/request for information (RFI). The methods and systems include various features for preparing for creation of a RFP and/or a RFI, creating a new RFP and/or RFI, “Carrier” review of a RFP and/or a RFI portal, opening an RFP and/or RFI to carriers, RFP and/or RFI submit and lock process, managing carrier responses to RFPs and/or RFIs, generating RFP and/or RFI documents, closing out an RFP and/or an RFI.

In order to successfully create a RFP and/or a RFI, and to ensure that associated questions accurately reflect a current plan design, the following may be created prior to a RFP/RFI release: all existing plans for the RFP, e.g., Basic Life (CH 4), all plan classes for the RFP, e.g., Class 1—all employees (CH 4), all rates/rate tables, all ASO services, and plan administration detail (CH 5).

In order to accommodate system upgrades and user feedback, enhancements may be made to the systems and methods via associated user interfaces as described herein. For example, new fields, pick lists and plan class layouts may be updated to reflect changing client needs. Existing plan and plan class data may be reviewed prior to beginning the RFP/RFI process. All fields at the plan class level may be populated, even if a particular provision does not apply to a given plan. Not Applicable (N/A) may be indicated such that carriers have an opportunity to provide feedback regarding these provisions. Chapter 4 provision questions may be included in all RFPs/RFIs.

Plan Administration records may be tied to appropriate minor line(s) of coverage, e.g., a Basic Life, Optional Life, Dependent Life, and Basic accidental death and dismemberment (AD&D) plans must be tied to the same Life and accidental death and dismemberment (AD&D) such that plan administration records and/or plan administration questions may be automatically pulled into the RFP/RFI. For complicated plan design that does not fit into existing fields, “OTHER” may be chosen as a plan design option and a correct attachment may be referenced in a benefit amount comments section. An attachment may be clearly label using established file naming conventions such that individuals may know which attachment is being referenced for the given plan design.

Because a new set of questions does not to be created and stored for each RFP/RFI, associated computer hardware (e.g., processor, memory, etc.) requirements are minimized. Furthermore, associated user interfaces are simplified.

This may be equally relevant when releasing a RFP/RFI. An attachment name may match up to a field populated in the RFP/RFI portal such that carriers know which attachment should be utilized for plan design. Methods and systems to upload an attachment into a chatter feed, with all other RFP/RFI materials for release with the RFP/RFI, is discussed elsewhere herein.

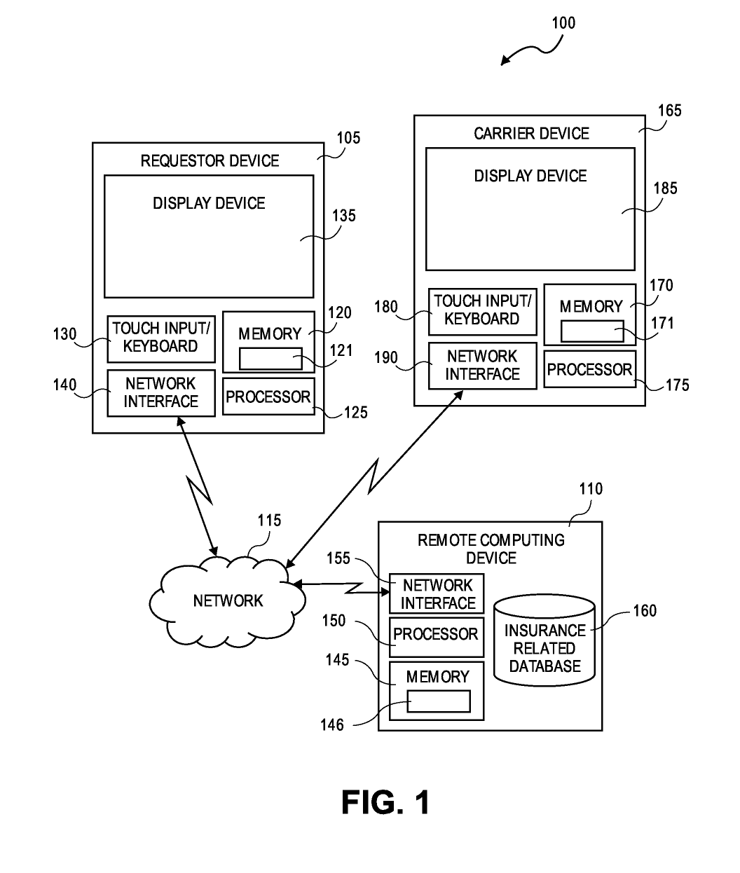

With reference to FIG. 1, a high-level block diagram of an example computer system for creating and responding to requests for proposals (RFPs) and/or requests for information (RFIs) 100 may include a requester device 105 in communication with a remote computer device (e.g., a server) 110 via a network 115. A computer system 100 may implement communications between a requester device 105 and a remote computing device 110 (e.g., a remote server) to provide, for example, RFP/RFI data to an insurance related database 160. For example, a computer system 100 may acquire RFP/RFI data from, for example, a user of a requester device 105. As described in detail herein, a computer system 100 may generate RFI/RFP data based on RFP/RFI question data stored in a RFP/RFI question library database (e.g., insurance related database 160 of FIG. 1).

For clarity, only one requestor device 105 is depicted in FIG. 1. While FIG. 1 depicts only one requestor device 105, it should be understood that any number of requestor devices 105 may be supported and that each requestor device 105 may be any appropriate computing device, such as a mobile telephone, a personal data assistant, a tablet or a lap-top computer. A requestor device 105 may include a memory 120 and a processor 125 for storing and executing, respectively, a module 121. The module 121, stored in the memory 120 as a set of computer-readable instructions, may be related to an application for generating a RFP/RFI that, when executed on a processor 125, causes data representative of a RFP/RFI to be stored in the memory 120. As described in detail herein, the module 121 may facilitate interaction between an associated requestor device 105 and a remote computing device 110. The processor 125, further executing the module 121, may facilitate communications between a remote computing device 110 and a requestor device 105 via a network interface 140 and a network 115.

A requestor device 105 may include a display device 135 which may be any type of electronic display device such as a liquid crystal display (LCD), a light emitting diode (LED) display, a plasma display, a cathode ray tube (CRT) display, or any other type of known or suitable electronic display. A display device 135 may exhibit a display which depicts a user interface for configuring a requestor 105 to communicate with a remote computing device 110. A requestor device 105 may include a user input device 130, such as a touch input/keyboard/pointing device (e.g., a mouse) that provides a mechanism for a user of the requestor device 105 to launch a requestor device insurance application and, for example, to interact with a system for generating a RFP/RFI. The user input device 130 may be configured as an integral part of a display device 135, such as a touch screen display device. The network interface 140 may be configured to facilitate communications between a requestor device 105 and a remote computing device 110 via any wireless communication network 115, including for example a wireless LAN, MAN or WAN, WiFi, the Internet, or any combination thereof. Moreover, a requestor device 105 may be communicatively connected to a remote computing device 110 via any suitable communication system, such as via any publicly available or privately owned communication network, including those that use wireless communication structures, such as wireless communication networks, including for example, wireless LANs and WANs, satellite and cellular telephone communication systems, etc. A requestor device 105 may cause, for example, RFP/RFI data to be transmitted to, and stored in, for example, a remote server 110 memory 145 and/or a remote insurance related database 160.

With further reference to FIG. 1, the computer system for creating and responding to requests for proposals (RFPs) and/or requests for information (RFIs) 100 may include a carrier device 165 in communication with the remote computer device (e.g., a server) 110 via the network 115. A computer system 100 may implement communications between a carrier device 165 and a remote computing device 110 (e.g., a remote server) to provide, for example, RFP/RFI response data to an insurance related database 160. For example, a computer system 100 may acquire RFP/RFI response data from, for example, a user of a carrier device 165. As described in detail herein, a computer system 100 may generate RFI/RFP response data based on RFP/RFI answer data received from a user of a carrier device 165.

For clarity, only one carrier device 165 is depicted in FIG. 1. While FIG. 1 depicts only one carrier device 165, it should be understood that any number of carrier devices 165 may be supported and that each carrier device 165 may be any appropriate computing device, such as a mobile telephone, a personal data assistant, a tablet or a lap-top computer. A carrier device 165 may include a memory 170 and a processor 175 for storing and executing, respectively, a module 171. The module 171, stored in the memory 170 as a set of computer-readable instructions, may be related to an application for generating a RFP/RFI response that, when executed on a processor 175, causes data representative of a RFP/RFI response to be stored in the memory 170. As described in detail herein, the module 171 may facilitate interaction between an associated carrier device 165 and a remote computing device 110. The processor 175, further executing the module 171, may facilitate communications between a remote computing device 110 and a carrier device 165 via a network interface 190 and a network 115.

A carrier device 165 may include a display device 185 which may be any type of electronic display device such as a liquid crystal display (LCD), a light emitting diode (LED) display, a plasma display, a cathode ray tube (CRT) display, or any other type of known or suitable electronic display. A display device 185 may exhibit a display which depicts a user interface for configuring a carrier 165 to communicate with a remote computing device 110. A carrier device 165 may include a user input device 180, such as a touch input/keyboard/pointing device (e.g., a mouse) that provides a mechanism for a user of the carrier device 165 to launch a carrier device insurance application and, for example, to interact with a system for generating a RFP/RFI response. The user input device 180 may be configured as an integral part of a display device 185, such as a touch screen display device. The network interface 190 may be configured to facilitate communications between a carrier device 165 and a remote computing device 110 via any wireless communication network 115, including for example a wireless LAN, MAN or WAN, WiFi, the Internet, or any combination thereof. Moreover, a carrier device 165 may be communicatively connected to a remote computing device 110 via any suitable communication system, such as via any publicly available or privately owned communication network, including those that use wireless communication structures, such as wireless communication networks, including for example, wireless LANs and WANs, satellite and cellular telephone communication systems, etc. A carrier device 165 may cause, for example, RFP/RFI response data to be transmitted to, and stored in, for example, a remote server 110 memory 145 and/or a remote insurance related database 160.

A remote computing device 110 may include a memory 145 and a processor 150 for storing and executing, respectively, a module 146. The module 146, stored in the memory 145 as a set of computer-readable instructions, may facilitate applications related to generating RFPs/RFIs. The module 146 may also facilitate communications between the remote computing device 110 and a carrier device 165 via a network interface 155 and the network 115 and other functions and instructions.

A remote computing device 110 may be communicatively coupled to an insurance related database 160. While the insurance related database 160 is shown in FIG. 1 as being communicatively coupled to the remote computing device 110, it should be understood that the insurance related database 160 may be located within separate remote servers (or any other suitable computing devices) communicatively coupled to the remote computing device 110. Optionally, portions of insurance related database 160 may be associated with memory modules that are separate from one another, such as a memory 120 of a requestor device 105.

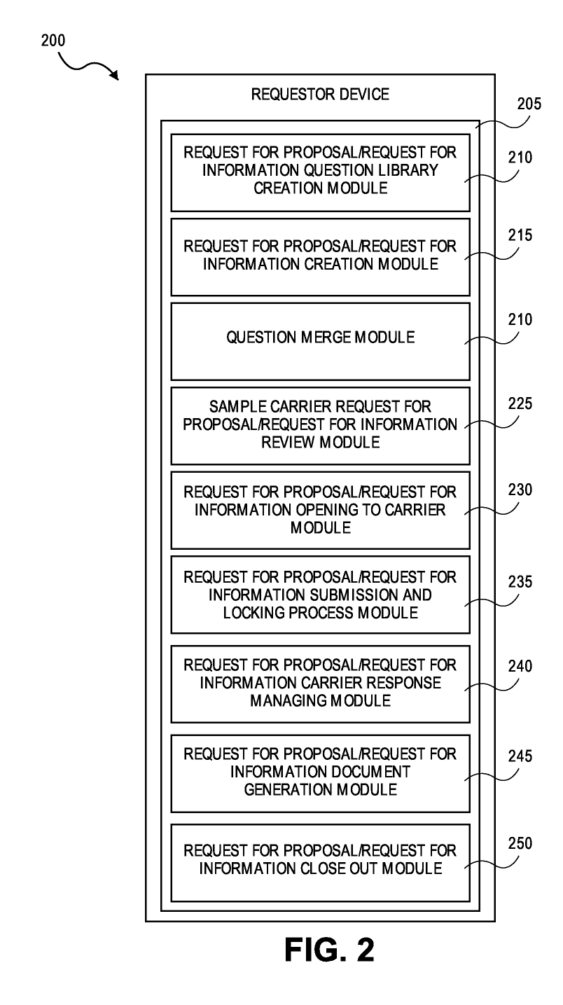

Turning to FIG. 2, a requestor device 200 for responding to requests for proposals (RFPs) and/or requests for information (RFIs) may include a RFP/RFI question library creation module 210, a RFP/RFI creation module 215, a question merge module 220, a sample carrier RFP/RFI review module 225, a RFP/RFI opening to carrier module 230, a RFP/RFI submission and locking module 235, a RFP/RFI carrier response managing module 240, a RFP/RFI document generation module 245, and a RFP/RFI close out module 250 stored on a memory 205. The requestor device 200 may be similar to, for example, the requestor device 105 of FIG. 1.

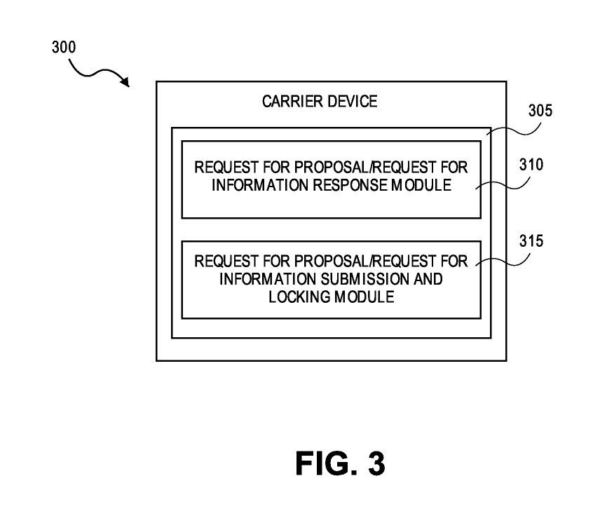

With reference to FIG. 3, a block diagram of an example requestor device 300 for responding to requests for proposals (RFPs) and/or requests for information (RFIs) is depicted. The requestor device 300 may be similar to, for example, the requestor device 165 of FIG. 1. The requestor device 300 may include a RFP/RFI response module 310 and a RFP/RFI submission and locking module 315 stored on a memory 305.

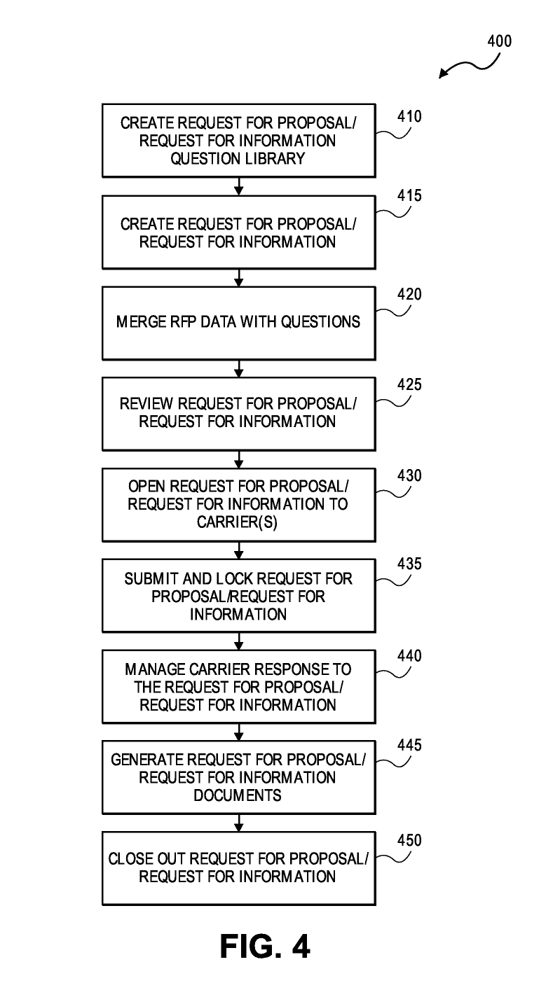

Turning to FIG. 4, a method for creating requests for proposals (RFPs) and/or requests for information (RFIs) 400 may be implemented by a processor (e.g., processor 125 of requestor device 105 of FIG. 1) executing, for example, modules 210-250 of FIG. 2. In particular, processor 125 may execute a RFP/RFI question library creation module 210 to create RFP/RFI question data. The RFP/RFI question data may be representative of a plurality of RFP/RFI questions, and the RFP/RFI question data may be store in a RFP/RFI question library database (e.g., insurance related database 160 of FIG. 1. As described herein, at least a portion of the RFP/RFI questions may include RFP/RFI information merge fields which may, for example, be automatically populated with corresponding RFP/RFI data when an associated RFP/RFI is created. Related RFP/RFI question data may be entered by either a RFP/RFI requestor using, for example, a requestor device 105 of FIG. 1, or a RFP/RFI responder (i.e., an insurance carrier) using, for example, a carrier device 165 of FIG. 1.

Processor 125 may execute a RFP/RFI creation module 215 to create RFP/RFI data. The RFP/RFI data may be representative of a RFP and/or a RFP. The RFP/RFI data may include RFP/RFI question merge data. Related RFP/RFI question data may be entered by either a RFP/RFI requestor using, for example, a requestor device 105 of FIG. 1.

Processor 125 may execute a question merge module 220 to merge RFP/RFI question merge data into a respective RFP/RFI question information merge field. Any given RFP/RFI question may be automatically included in a corresponding RFP and/or RFI based, for example, on a line of coverage (LOC) included within the respective RFP and/or RFI. Any given LOC may be included within an RFP and/or RFI by a RFP/RFI requestor using, for example, a requestor device 105 of FIG. 1.

Processor 125 may execute a sample carrier RFP/RFI review module 225 to allow a RFP/RFI requestor to, for example, review a respective RFP and/or RFI from a perspective of an insurance carrier. Thereby, accuracy of the given RFP and/or RFI may be improved. Processor 125 may execute a RFP/RFI opening to carrier module 230 to open a RFP and/or RFI for response by an insurance carrier, or insurance carriers. Processor 125 may execute a RFP/RFI submission and locking module 235 to submit and/or lock a given RFP and/or RFI.

Processor 125 may execute a RFP/RFI carrier response managing module 240 to manage carrier responses to a given RFP and/or RFI. For example, a RFP/RFI requestor may manage carrier responses using a requestor device 105.

Processor 125 may execute a RFP/RFI document generation module 245 to generate RFP and/or RFI documents. For example, a RFP/RFI requestor may create RFP/RFI documents using a requestor device 105. Processor 125 may execute a RFP/RFI close out module 250 to close out a RFP and/or a RFI. For example, a RFP/RFI requestor may close out a RFP and/or a RFI using a requestor device 105.

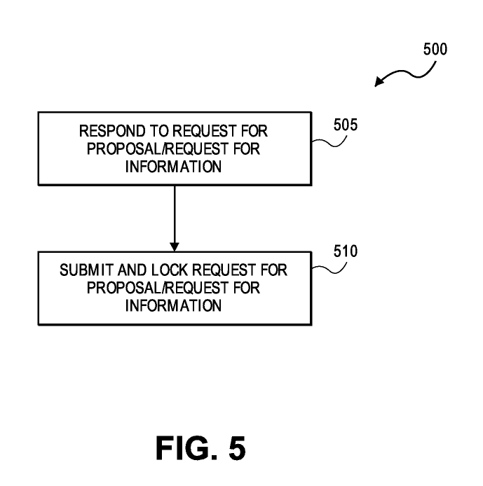

With reference to FIG. 5, a flow diagram of an example method for responding to requests for proposals (RFPs) and/or requests for information (RFIs) 500 may be implemented by a processor (e.g., processor 175 of carrier device 165 of FIG. 1) executing, for example, modules 310-315 of FIG. 3. For example, the processor 165 may execute a RFP/RFI response module 310 to generate RFP/RFI response data. The RFP/RFI response data may be representative of insurance carrier responses to a given RFP and/or RFI. The processor 165 may execute a RFP/RFI submission and locking module 315 to submit and/or lock a given RFP and/or RFI, for example, subsequent to an insurance carrier entering a response using, for example, a carrier device 165 of FIG. 1.

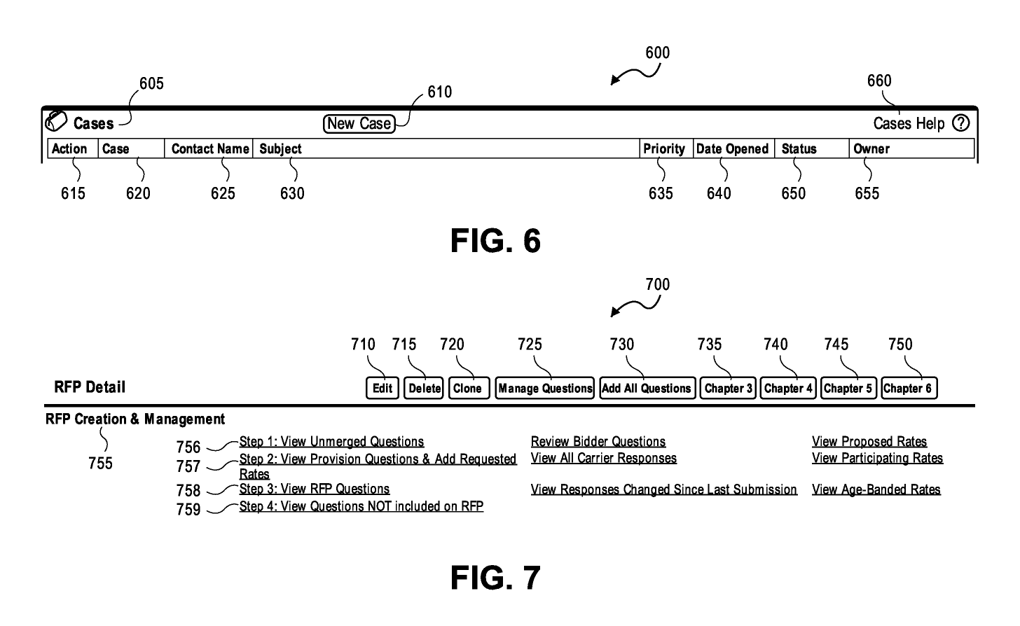

Turning to FIGS. 6-12, example user interfaces for creating requests for proposals (RFPs) and/or requests for information (RFIs) 600, 700, 800, 900, 1000, 1100, 1200 are depicted. The user interface 600 may, for example, represent a beginning point to create a new RFP and/or a new RFI using, for example, a RFP/RFI portal (e.g., Salesforce, etc.), and may include a cases selection icon 605, a new case icon 610, an action column 615, a case column 620, a contact name column 625, a subject column 630, a priority column 635, a date opened column 640, a status column 650, an owner column 655, and a cases help selection icon 660. RFP/RFI case naming conventions for an RFP/RFI portal may be, for example: account name_effective date_coverage(s), e.g., companyseekinginsurance_01.01.14_Life, Accident & BTA RFP. Because the RFP/RFI Tool may not store emails associated with the RFP, all emails regarding the RFP/RFI (gathering data, preparing materials, etc.) may be tied to the RFP/RFI case. RFP/RFI email and associated document naming conventions may be renamed according to an established file naming conventions such the emails and associated documents are searchable in the RFP/RFI portal. The user interface 700 of FIG. 7 may include a RFP/RFI detail title 705, an edit selection icon 710, a delete selection icon 715, a clone selection icon 720, a manage questions selection icon 725, an add all questions icon 730, a chapter 3 selection icon 735, a chapter 4 selection icon 740, a chapter 5 selection icon 745, a chapter 6 selection icon 750, an RFP/RFI creation and management title 755, a step one selection icon 756, a step two selection icon 757, a step three selection icon 758, and a step four selection icon 759. There may be four main steps to be completed before releasing a RFP/RFI to associated insurance carriers for providing responses as depicted in FIG. 7 along with the steps one-four.

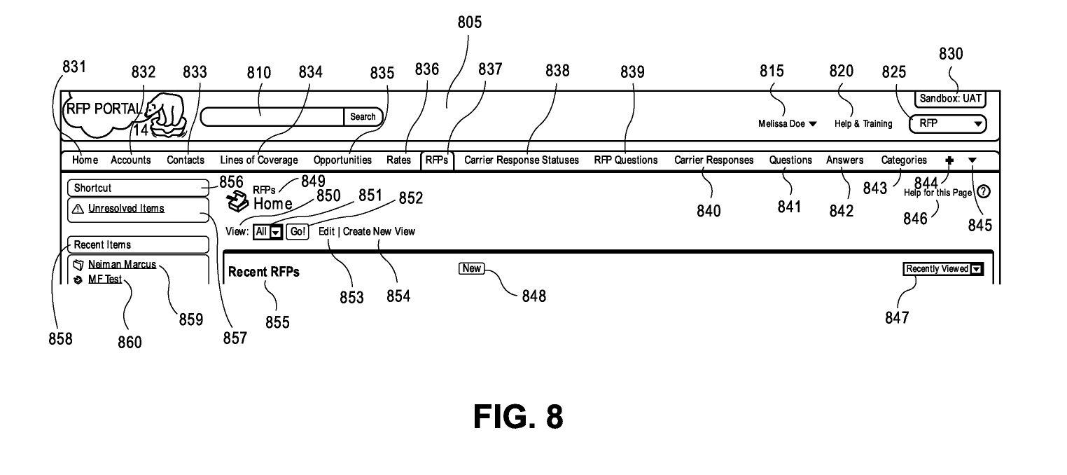

As depicted in FIG. 8, the user interface 800 may include a RFP/RFI portal header 805, a search entry field 810, a creator identification/selection 815, a help and training selection icon 820, an RFP/RFI selection pull-down menu 825, a sandbox UAT selection icon 830, a home selection icon 831, an accounts selection icon 832, a contacts selection icon 833, a lines of coverage selection icon 834, an opportunities selection icon 835, a rates selection icon 836, a RFPs selection icon 837, a carrier response statuses selection icon 838, a RFP questions selection icon 839, a carrier responses selection icon 840, a questions selection icon 841, an answers selection icon 842, a categories selection icon 843, a +selection icon 844, a pull-down menu icon 845, and a help for this page selection icon 846. The user interface 800 may also include a shortcut selection tab 856 including an unresolved items selection icon 857, a view icon 850, a view pull-down menu 851, a go selection icon 852, an edit icon 853, and a create new view selection icon 854. The user interface 800 may further include a recent items tab 858 including a user name selection icon 859, a mf test selection icon 860, a recent RFPs column 855, a new selection icon 848 and a recently viewed pull-down selection menu 847. A user may click on the RFPs tab (e.g., a green file folder tab) and click new to create a new RFP. The user may be in the RFP/RFI menu to access the RFP/RFI Tool.

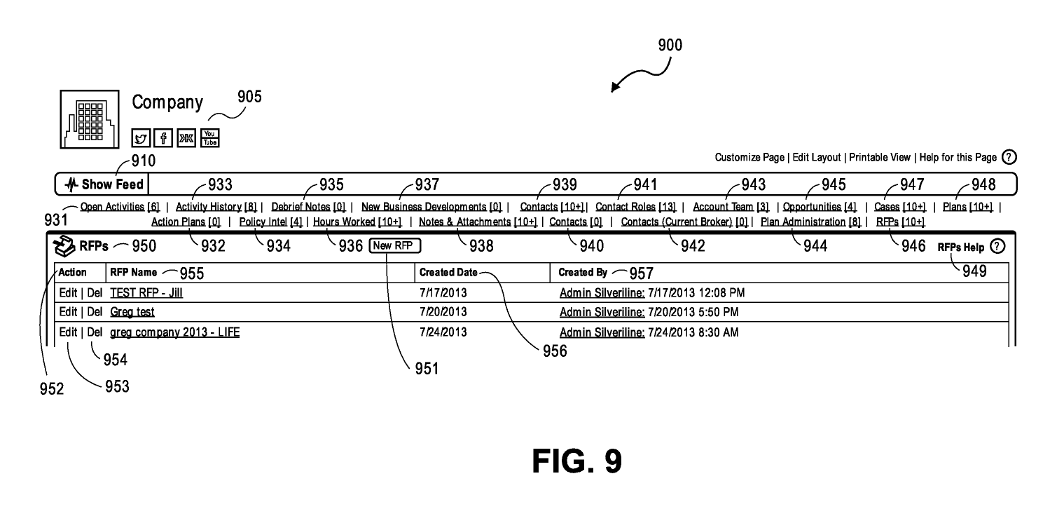

The user interface 900 of FIG. 9 may include a company seeking insurance indicator 905, a show feed selection icon 910, a customize page selection icon 915, an edit layout selection icon 920, a printable view selection icon 925, a help for this page icon 930, an open activities selection icon 931, an action plans selection icon 932, an activity history selection icon 933, a policy intel selection icon 934, a debrief notes selection icon 935, a hours worked selection icon 936, a new business developments selection icon 937, a notes and attachments selection icon 938, a first contacts selection icon 939, a second contacts selection icon 940, a contact roles selection icon 941, a contacts (current broker) selection icon 942, an account team selection icon 943, a plan administration selection icon 944, an opportunities selection icon 945, a RFPs selection icon 946, a cases selection icon 947 and a plans selection icon 948. The user interface 900 may also include a RFPs/RFIs area 950 including, for example, a new RFP pull down menu selection icon 951, an action column 952 having an edit selection icon 953 and a delete selection icon 954, an RFP/RFI name column 955, a created date column 956, and a created by column 957. The RFP/RFI may be created from the account record. A user may hover over a RFP/RFI quicklink, that may be included, for example, near a top of the user interface 900, to see any existing RFPs for an associated account, or may scroll down to view the RFP/RFI section on an account page. A user may click on the new RFP/RFI to get started creating a RFP and/or a RFI.

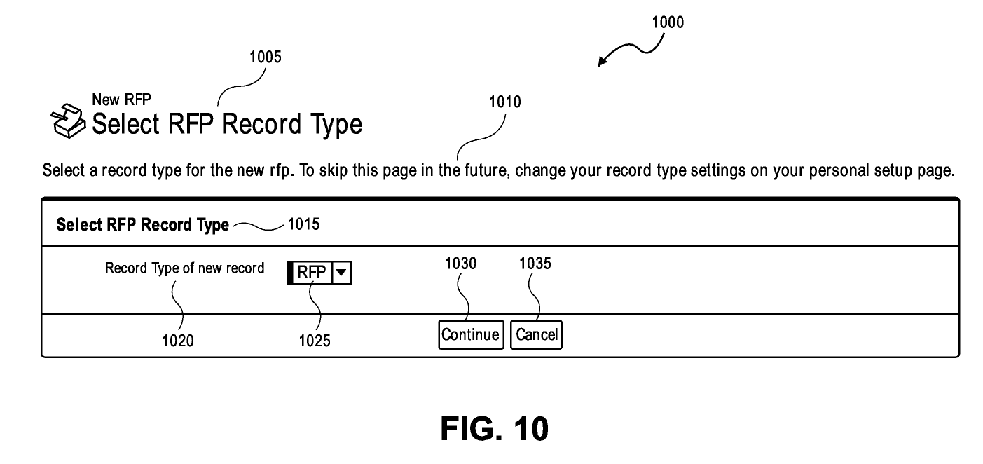

A user may initiate the user interface 1000 of FIG. 10, for example, to begin a RFP/RFI creation process. The RFP/RFI portal may prompt a requestor to first select a record type. As shown in FIG. 1000, the only option available may be RFP. However, RFI may also be included. Thereby, an RFI may also be generated via user interface 1000. The option to select RFI may be disabled, for example, for users without RFP/RFI portal Administration rights. The user interface 1000 may include a new RFP select RFP record type title 1005, an information banner 1010, a select RFP record type title 1015, a record type of new record 1020 pull-down selection menu 1025, a continue selection icon 1030, and a cancel selection icon 1035.

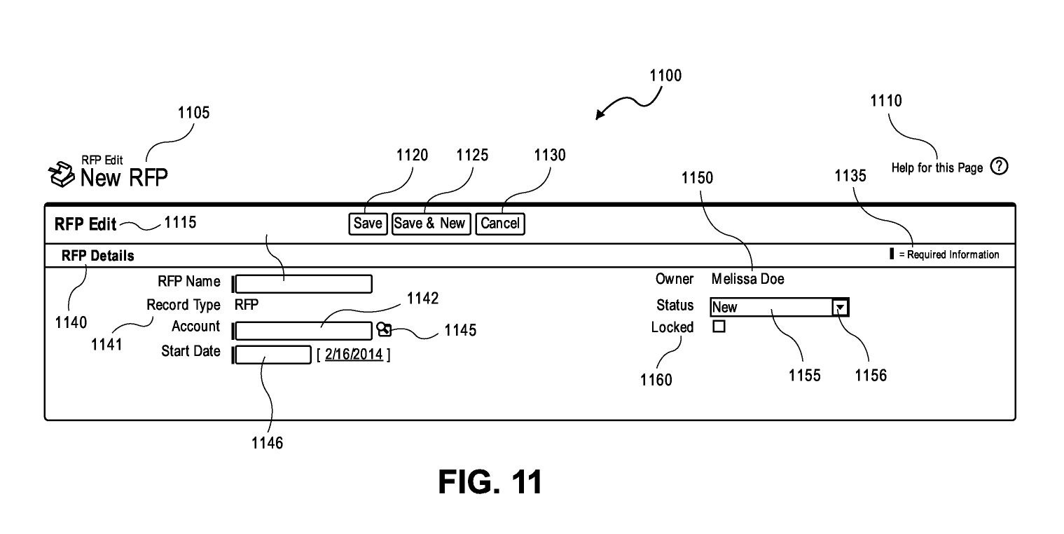

When the continue selection icon 1030 of FIG. 10 is selected, the user interface 1100 of FIG. 11 may, for example, be displayed. The user interface 1100 may include a RFP edit new RFP title 1105 a help for this page selection icon 1110, a RFP edit title 1115, a save selection icon 1120, a save and new selection icon 1125, a cancel selection icon 1130, a required information banner 1135, a RFP detail title 1140, a RFP name entry field 1136, a record type indicator 1141, an account entry field 1142 and search selection icon 1145, a start date entry field 1146, an owner identifier 1150, a status 1155 pull-down menu selection field 1156, and a locked selection icon/indicator 1160. A user may fill out all RFP/RFI details via the user interface 1100 and may set the status to “New.” RFP/RFI naming conventions for the RFP/RFI portal may be, for example: Account Name_Effective Date_Coverage(s), e.g., companyseekinginsurance_01.01.14_Life, Accident & BTA RFP. This naming convention minors the naming convention used for your RFP/RFI case. The RFP/RFI portal may be configured such that a user may not save and move forward from user interface 1100 without filling out the required information.

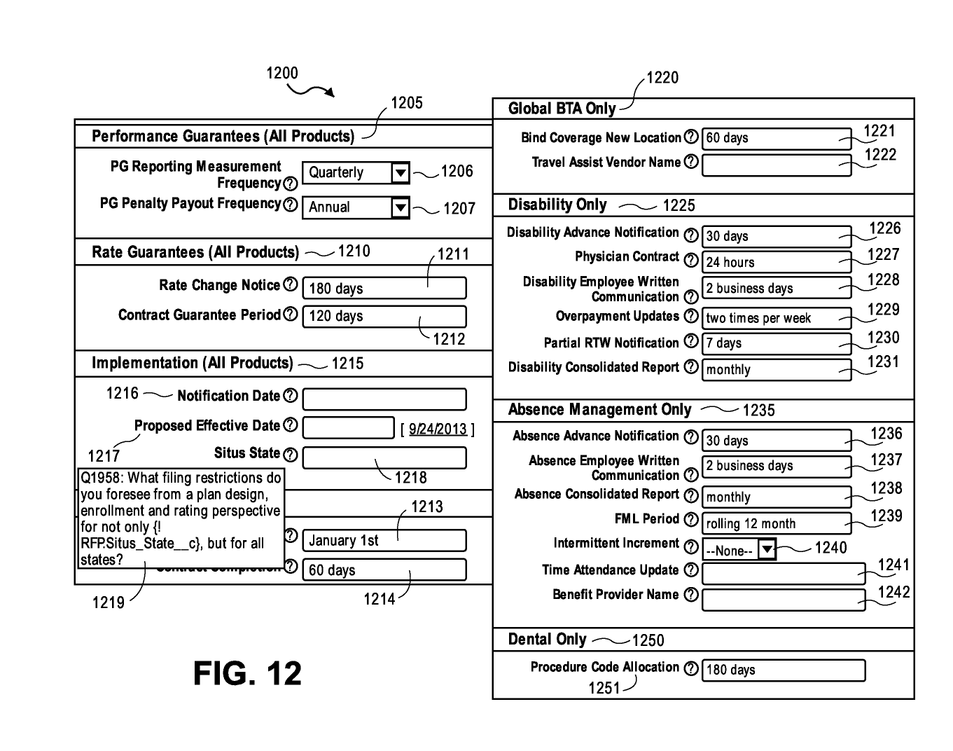

The user interface 1200 of FIG. 12 may include a performance guarantees (all products) title 1205, a reporting measurement frequency selection pull-down menu 1206, a penalty payout frequency selection pull-down menu 1207, a rate guarantees (all products) identifier 1210, a rate change notice entry field 1211, and a contract guarantee period entry field 1212. The user interface 1200 may also include an implementation (all products) identifier 1215, a notification date entry field 1216, a proposed effective date entry field 1217, a situs state entry field 1218, a RFP/RFI question banner 1219, a date entry field 1213, and a time period entry field 1214. The user interface 1200 may further include a global BTA only identifier 1220 having a bind coverage new location entry field 1221 a travel assist vendor name entry field 1222, a disability only identifier 1225, a disability advance notification entry field 1226, a physician contact entry field 1227, a disability employee written communication entry field 1228, an overpayment updates entry field 1229, a partial RTW notification entry field 1230, a disability consolidated report entry field 1231. The user interface 1200 may further include an absence management only identifier 1235 having an absence advance notification entry field 1236, an absence employee written communication entry field 1237, an absence consolidated report entry field 1238, a FML period entry field 1239, an intermittent increment pull-down menu selection 1240, a time attendance update entry field 1241, and a benefit provider name entry field 1242. The user interface 1200 may yet further include a dental only identifier 1250 having a procedure code allocation entry field 1251. A user may, for example, complete the Chapter 3 mergefields based on minor lines of coverage (LOC's) included in an associated RFP. Each mergefield may tied to specific RFP/RFI questions in the RFP and/or the RFI, as noted, for example, in the “help” for each field. Standard entries may be defaulted into certain responses. Once the entries of user interface 1200 are complete, a user may click save to continue.

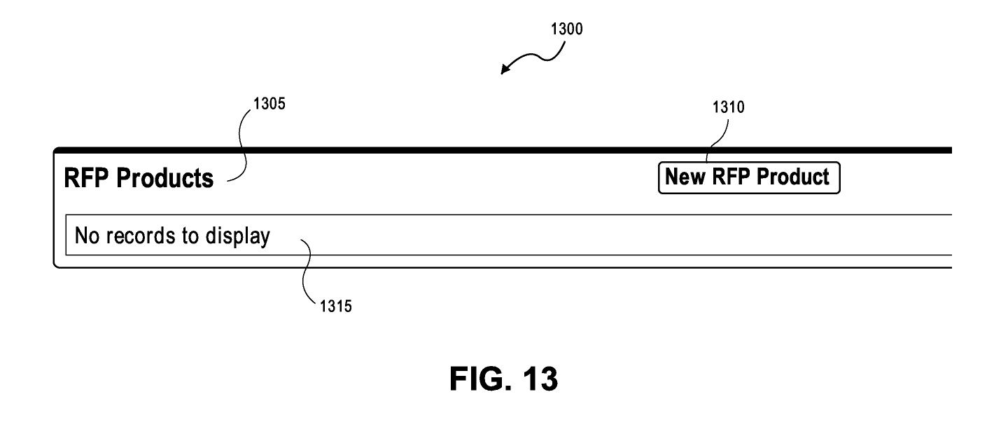

With reference to FIGS. 13-17, example user interfaces for adding lines of coverage when creating requests for proposals (RFPs) and/or requests for information (RFIs) 1300, 1400, 1500, 1600, 1700 are depicted. User interface 1300 may include a RFP products identifier 1305, a new RFP selection icon 1310, and a records display area 1315. After filling out basic details about the RFP, a user may add all minor lines of coverage (LOC's) that will be part of the RFP/RFI process, even if certain insurance carriers will not be bidding on all LOC's. Later in the RFP/RFI creation process, a user may have the opportunity to identify LOC's that should not be displayed for any given insurance carrier, e.g., Carrier A to bid on Life & Disability, Carrier B to bid on Disability only.

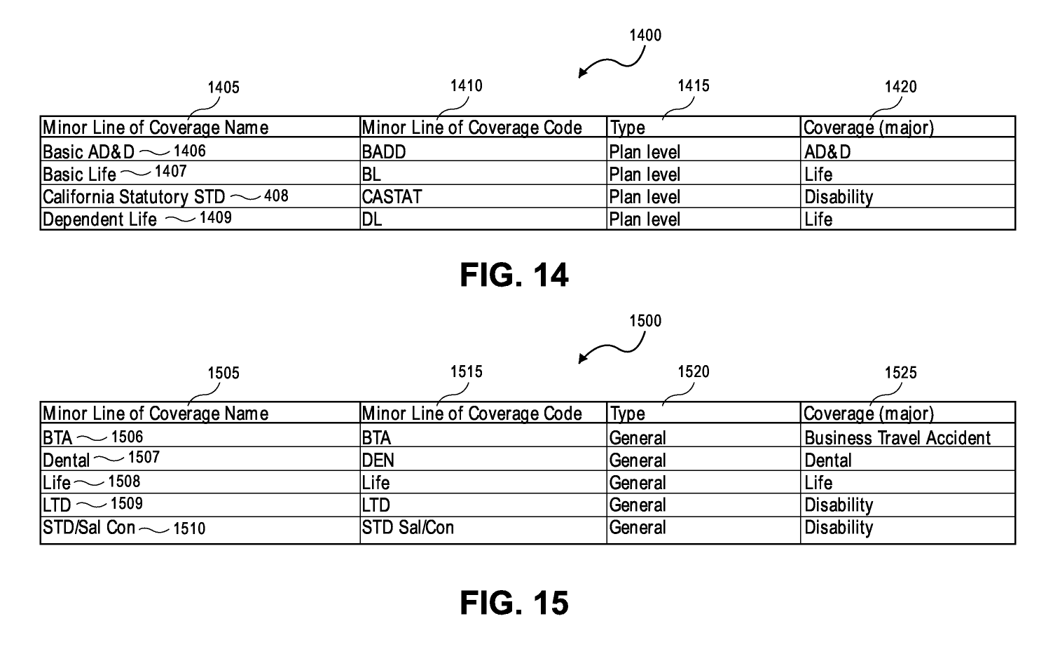

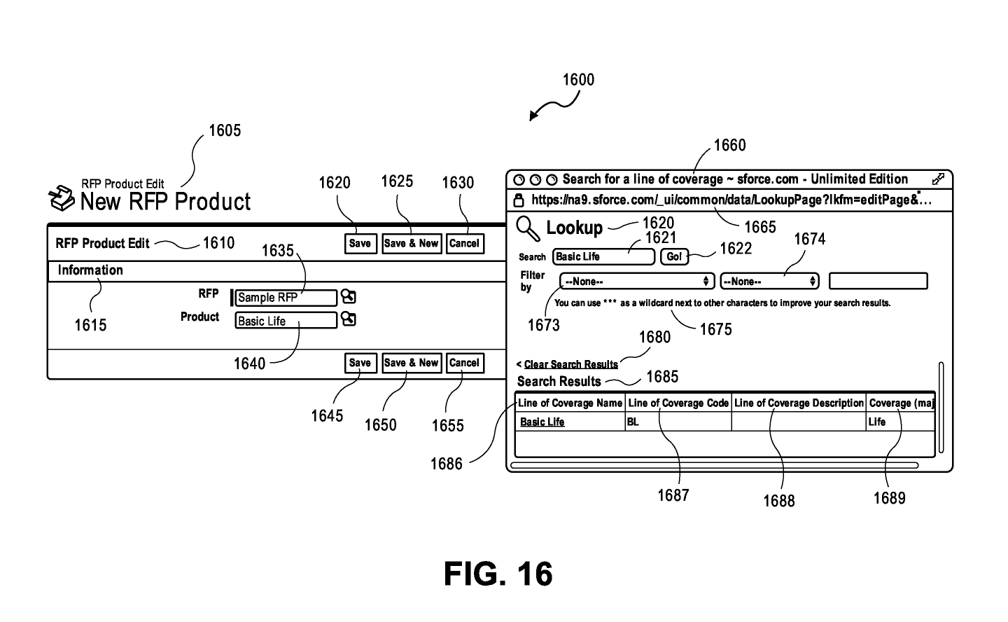

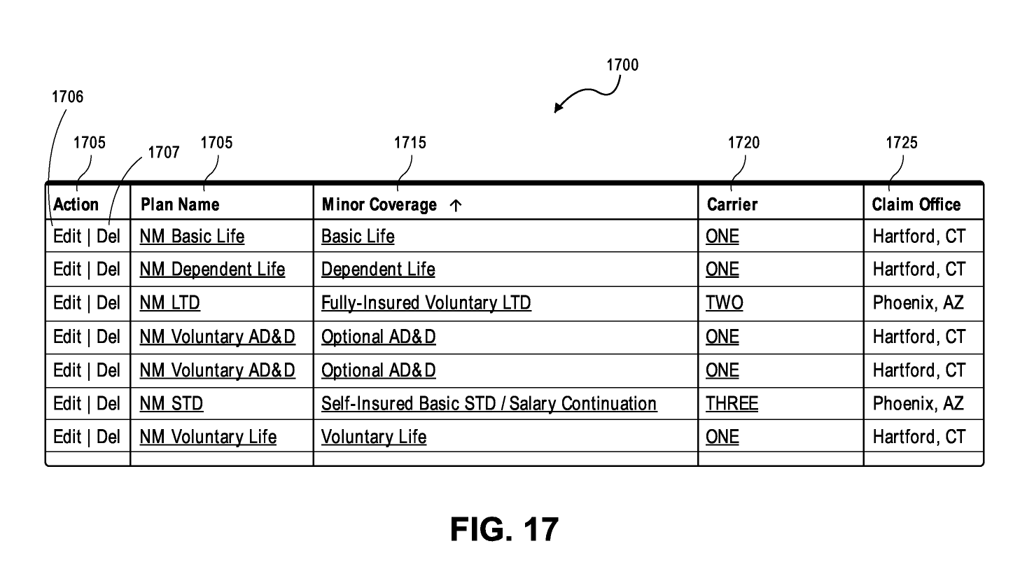

The user interfaces 1400 of FIG. 14, the user interface 1500 of FIG. 15, the user interface 1600 of FIG. 16, and the user interface 1700 of FIG. 17 may be used for adding a line of coverage. The user interface 1400 may include a minor line of coverage name column 1405 having, for example, basic accident, disability and disablement entry 1406, basic life entry 1407, California statutory short term disability 1408, and dependent life 1409. The user interface 1400 may also include a minor line of coverage code column 1410, a type column 1415, and a coverage (major) column 1420. The user interface 1500 may include a major line of coverage name column 1505 having, for example, business travel accident 1506, dental 1507, life 1508, long term disability 1509, and short term disability/sal con 1510. The user interface 1500 may also include a major line of coverage code column 1510, a type column 1515, and a coverage (major) column 1520. The RFP/RFI portal may identify, for example, two types of coverage: major (Life, Disability), and minor (Basic Life, Self-Insured STD, Fully-Insured LTD). Each RFP/RFI question may tied to a specific minor coverage; a user may choose the minor lines of coverage (LOC's) associated with the Account when building your RFP.

The user interface 1600 of FIG. 16 may include a RFP product new RFP product identifier 1605, a RFP product edit identifier 1610, a save selection icon 1620, a save and new selection icon 1625, a cancel selection icon 1630, an information identifier 1615, a RFP entry field 1635, a product entry field 1640, a save selection icon 1645, a save and new selection icon 1650 and a cancel selection icon 1655. The user interface 1600 may also include a search for line of coverage option 1660, a URL locator 1665, a lookup selection icon 1670, a search entry field 1671, a go selection icon 1672, filter by selection pull-down menus 1673 and 1674, an instruction banner 1675, a clear search results selection icon 1680, and a search results area 1685 having a line of coverage name column 1686, a line of coverage code column 1687, a line of coverage description column 1688, and a coverage (major) column 1689. A requestor may, for example, also use lookup to access the entire available library of minor lines of coverage (LOC's). Once the entries of the user interface 1600 are complete, a requestor may click save 1645 to add the LOC to your RFP. A requestor may click save and new 1650 to add multiple LOC's to a RFP. After having added all LOC's and have clicked save 1620, the RFP/RFI creation process may return to, for example, user interface 1100. A requestor may click on the name of your RFP/RFI to return to the main RFP/RFI user interface 1000. Any items with an underline in the RFP/RFI portal may be a hyperlink.

The user interface 1700 of FIG. 17 may include an action column 1705 having an edit selection icon 1706 and a delete selection icon 1707, a plan name column 1710, a minor coverage column 1715, a carrier column 1720 and a claim office column 1725. All minor lines of coverage (LOC's), associated with an account may be listed under the plan section on the main account page. If a user is not sure which LOC to select, the user may refer to an account for details.

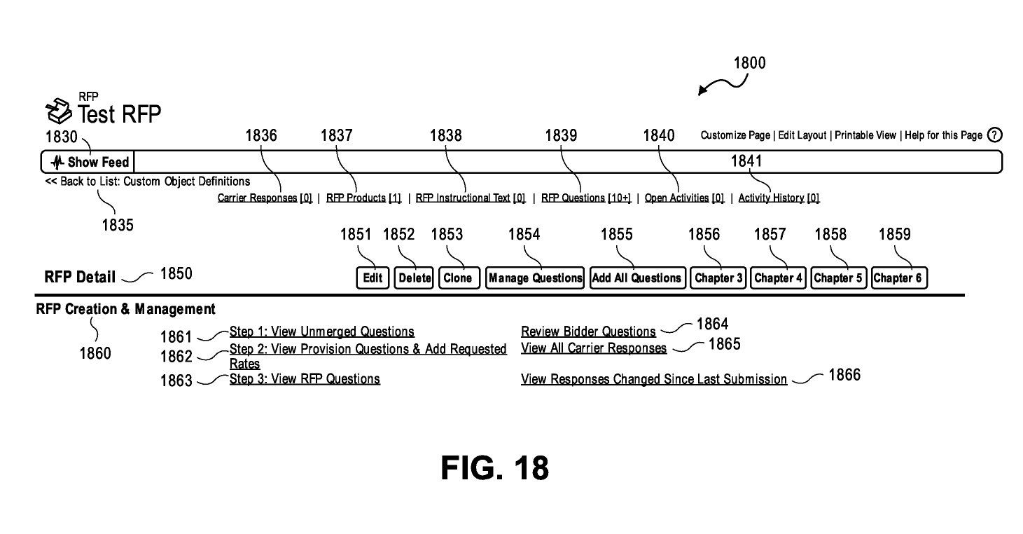

Turning to FIGS. 18-26, example user interfaces related to adding questions when creating requests for proposals (RFPs) and/or requests for information (RFIs) 1800, 1900, 2000, 2100, 2200, 2300, 2400, 2500, 2600 are depicted. The user interface 1800 may include a RFP test RFP identifier 1805, a customize page selection icon 1810, an edit layout selection icon 1815, a printable view selection icon 1820, a help for this page selection icon 1825, a show feed selection icon 1830, a back to list: custom object definitions selection icon 1835, a carrier responses selection icon 1836, a RFP products selection icon 1837, a RFP instructional text selection icon 1838, a RFP questions selection icon 1839, an open activities selection icon 1840, and an activity history selection icon 1841. The user interface 1800 may also include a RFP detail area 1850 having an edit selection icon 1851, a delete selection icon 1852, a clone selection icon 1853, a manage questions selection icon 1854, an add all questions selection icon 1855, a chapter three selection icon 1856, a chapter four selection icon 1857, a chapter five selection icon 1858, and a chapter six selection icon 1859. The user interface 1800 may further include a RFP creation and Management section 1860, a step one selection icon 1861, a step two selection icon 1862, a step three selection icon 1863, a review bidder intent responses selection icon 1864, a view all carrier responses selection icon 1865, and a view responses changed since last submission selection icon 1866. Once a user has added the desired LOC's to the RFP, questions may be added via, for example, the Add All Questions button 1855 to add all identified questions related to each LOC in the RFP. This may, for example, build a RFP/RFI question library. A question wizard, which may be used to populate the question library, may return a pre-ordered list of questions based on the account, LOC's, and other RFP/RFI details selected thus far. Some questions may contain merge fields that will auto-populate when the RFP/RFI records are added to the RFP, e.g., {!PRODUCT.NAME}=the Minor Line(s) of Coverage (LOC's) in your RFP/RFI that will merge with the RFP/RFI question; and {!ACCOUNT.NAME}—Client/Account Name as listed in The RFP/RFI portal. RFP specific merge fields may be filled out on the RFP/RFI user interface 1200, for example, such as contract anniversary dates, absence management timeframes 1235 and Data Warehouse vendor names. All merge fields may populate based on the text entered, taking into account spelling, grammar and punctuation.

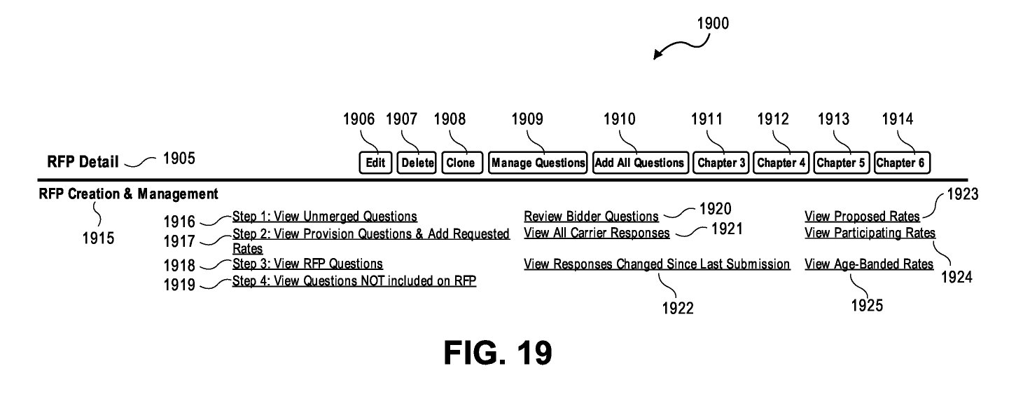

The user interface 1900 of FIG. 19 may include a RFP detail identifier 1905, an edit selection icon 1906, a delete selection icon 1907, a clone selection icon 1908, a manage questions selection icon 1909, an add all questions selection icon 1910, a chapter 3 selection icon 1911, a chapter 4 selection icon 1912, a chapter 5 selection icon 1913 and a chapter 6 selection icon 1914. The user interface 1900 may also include a RFP creation and management area 1915 having a step one selection icon 1916, a step two selection icon 1917, a step three selection icon 1918, a step four selection icon 1919, a review bidder questions selection icon 1920, a view all carrier responses selection icon 1921, a view responses changed since last submission selection icon 1922, a view proposed rates selection icon 1923, a view participating rates selection icon 1924, and a view age-banded rates selection icon 1925. The custom links 915, for example, on the main RFP/RFI user interface 900, for example, may present details of the four main steps needed to prepare the RFP/RFI data for release to the insurance carriers: Step 1: View Unmerged Questions: Displays a report of all related questions that may have experienced formatting issues due to missing plan data; Step 2: View Provision Questions & Add Requested Rates*: Displays the Chapter 4 & 5 questions that may require Proposed Changes; Step 3: View RFP/RFI Questions: Displays a report of all RFP/RFI questions (including merged question text) that will be included in the RFP; and Step 4: View RFP/RFI Questions NOT Included on RFP: Identifies questions that are not included in the RFP, such as Opt-In Questions that were not selected AND questions that were manually deleted by the user.

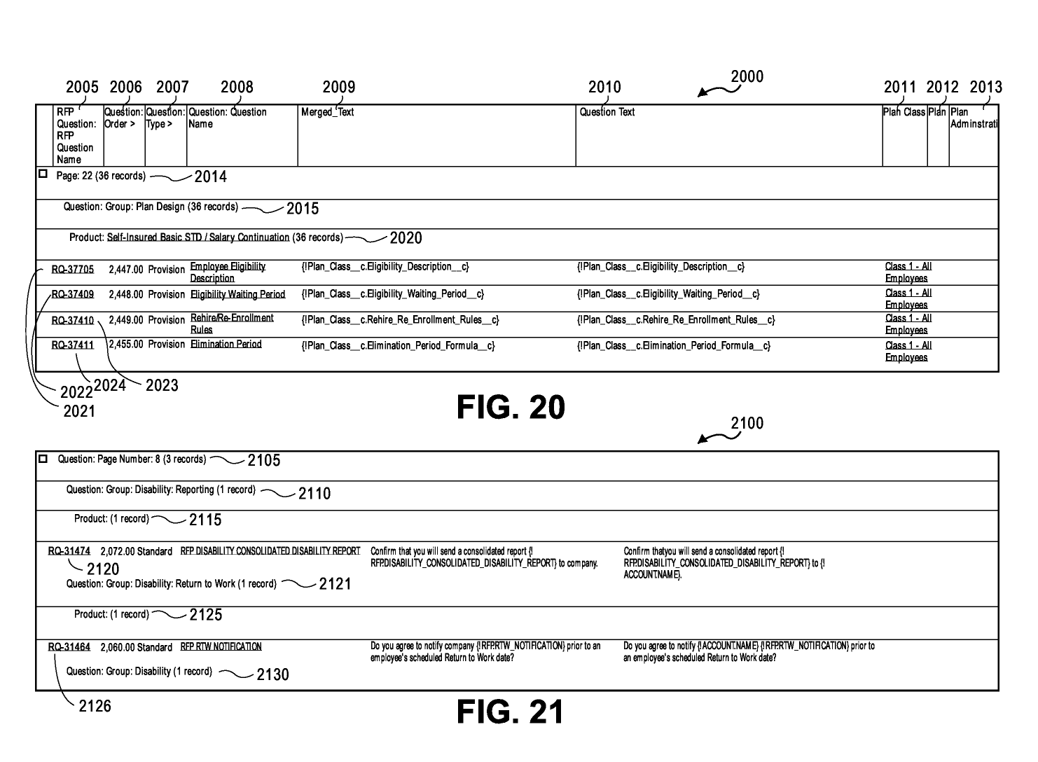

The user interface 2000 FIG. 20 may include a RFP question identifier 2005 having a question order 2006, a question type 2007, a question name 2008, and a manage text 2009. The user interface 2000 may also include a page identifier 2014, a question group plan design identifier 2015, a product identifier 2020, and individual question links 2021-2024.

The user interface 2100 of FIG. 21 may include, for example, a question page identifier 2105, a first question group identifier 2110, a first product identifier 2115, a first question link 2120, a second question group identifier 2121, a second product identifier 2125, a second question link 2126 and a third question group identifier 2130. Step 1: View Unmerged Questions—Questions that display on this report include missing data and/or merge field data issues. User interface 2100 may identify where to correct missing data. For example, the Plan Class, Plan or Plan Administration column may be populated with the name of the applicable area where the merge issue occurred. Questions that do not have an applicable Plan Class, Plan or Plan Administration reference may be located on a RFP/RFI detail screen.

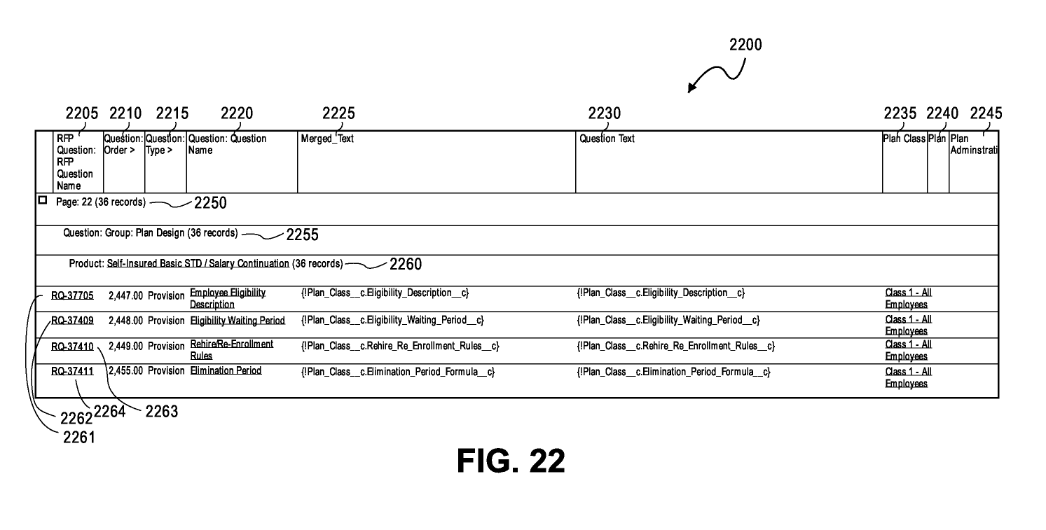

The user interface 2200 of FIG. 22 may include a RFP question identifier 2205, a question order 2210, a question type 2215, a question name 2220, a merged_text identifier 2225, a product identifier 2260 and question links 2262-2264. Step 1: View Unmerged Questions, hyperlinks included under the Plan, Plan Class & Plan Administration columns, may return directly to the page that contains the merge issue. Alternatively, the view unmerged questions hyperlinkgs directly to the field that is missing data. The RFP/RFI portal session may remain open and a user may toggle between both screens. By keeping the unmerged questions user interface 2200 open in one session/window and use the other session/window to correct the merge issue on the Plan, Plan Class or Plan Admin page. Some unmerge questions may identify questions that are not applicable to a particular RFP and should be deleted in Step 3.

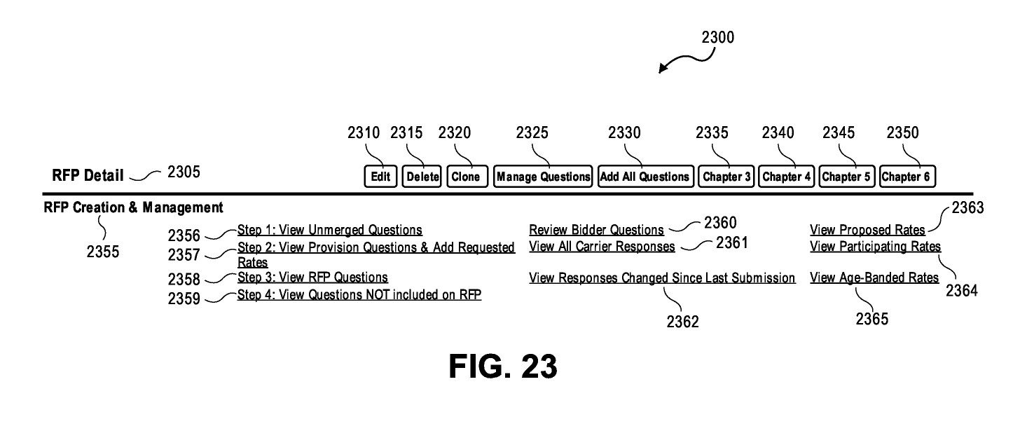

The user interface 2300 of FIG. 23 may include a RFP detail title 2305, an edit selection icon 2310, a delete selection icon 2315, a clone selection icon 2320, a manage questions selection icon 2325, an add all questions selection icon 2330, a chapter 3 selection icon 2335, a chapter 4 selection icon 2340, a chapter 5 selection icon 2345 and a chapter 6 selection icon 2350. The user interface 2300 may also include a RFP creation and management information area 2355 having a step 1 selection link 2356, a step 2 selection link 2357, a step 3 selection link 2358, a step 4 selection link 2359, a review bidder questions selection link 2360, a view all carrier responses selection link 2361, a view responses changed since last submission selection link 2362, a view proposed rates selection link 2363, view participating rates 2364 and view age-banded rates 2365. Once all unmerge issues are resolved, an associated RFP/RFI may be re-merge/regenerate to connect the updated fields to the RFP/RFI questions by, for example, returning to the main RFP/RFI page, selecting the Add All Questions selection icon 2330 at the top of the page. Steps 1 and 2 may be completed prior to deleting any questions from the question set. Unmerged questions remaining on a report that are there because, for example, the questions are not applicable to the given RFP, the unmerged questions may be deleted in Step 3 after all unmerged issues are resolved.

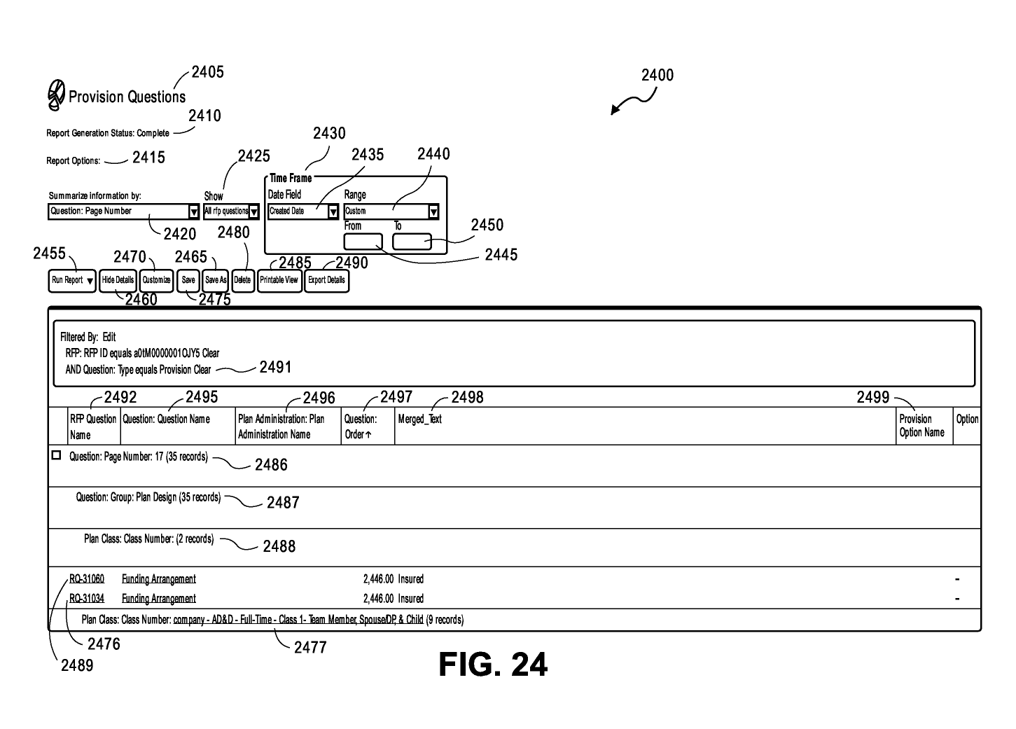

Turning to FIG. 24, a provision questions user interface 2400 may include a provision questions title 2405, a report generation status area (e.g., compiled) 2410, and a report options information area 2415. The report options information area 2415 may include a summarize information by selection pull-down menu 2420, a show selection pull-down menu 2425, a time frame title 2430, a date field selection pull-down menu 2435, and a range selection pull-down menu 2440 having from entry field 2445 and a to entry field 2450. The report options information area 2415 may also include a run report selection pull-down menu 2455, a hide details selection icon 2460, a customers selection icon 2470, a save selection icon 2475, a save as selection icon 2465, a details selection icon 2480, a printable view selection icon 2485, an export details selection icon 2490, and a filtered by information area 2491. The filtered by information area 2491 may include an RFP question column 2492, a questions: questions name column 2495, a plan administration column administration name 2496, a questions: order 1 column 2497, a merged text column 2498, a question: page number identification 2486, a question: group identification 2487, a plan class: class number identification 2488, a first question selection link 2489, a second question selection link 2476, and a plan class: class number selection link 2477. Selecting the Step 2: View Provision Questions & Add Requested Rates 2357 of FIG. 23 may generate a report of all the Plan Design (CH 4) and Plan Administration (CH 5) questions in the RFP/RFI that could potentially require proposed changes. Provision questions may allow an insurance carrier to, for example, note any deviations, concerns or rate impacts to a current and proposed plan design and plan administration provisions.

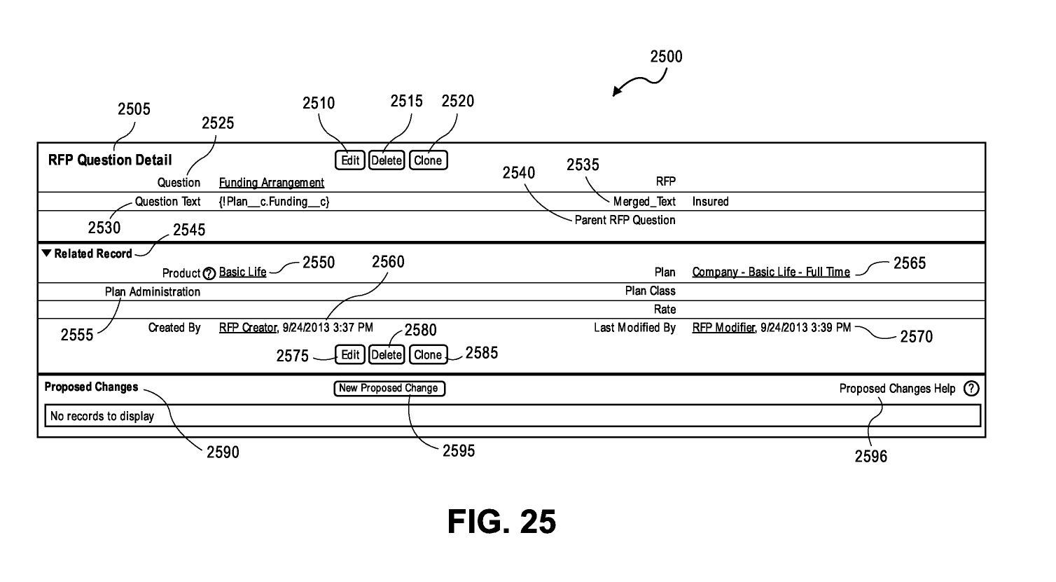

With reference to FIG. 25, a user interface for provision questions 2500 may include a RFP question detail information area 2505, a related record information area 2545, and a proposed changes information area 2590. The RFP question detail information area 2505 may include an edit selection icon 2510, a delete selection icon 2515, a close selection icon 2520, a question selection link 2525, a question text field 2530, a merged_text entry 2535 a parent rfp question entry 2540. The related record information area 2545 may include a product selection link (e.g., basic life) 2550, a plan administration area 2555, a created by selection link 2560, a plan/plan class selection link 2565, a rate/last modified by selection link 2570, an edit selection icon 2575, a delete selection icon 2580, and a clone selection icon 2585. The proposed changes area 2590 may include a new proposed change selection icon 2595 and a proposed changes help ? selection icon 2596. A proposed change may be initiated by, for example, selecting the RFP/RFI question name 2525 (NOT the provision).

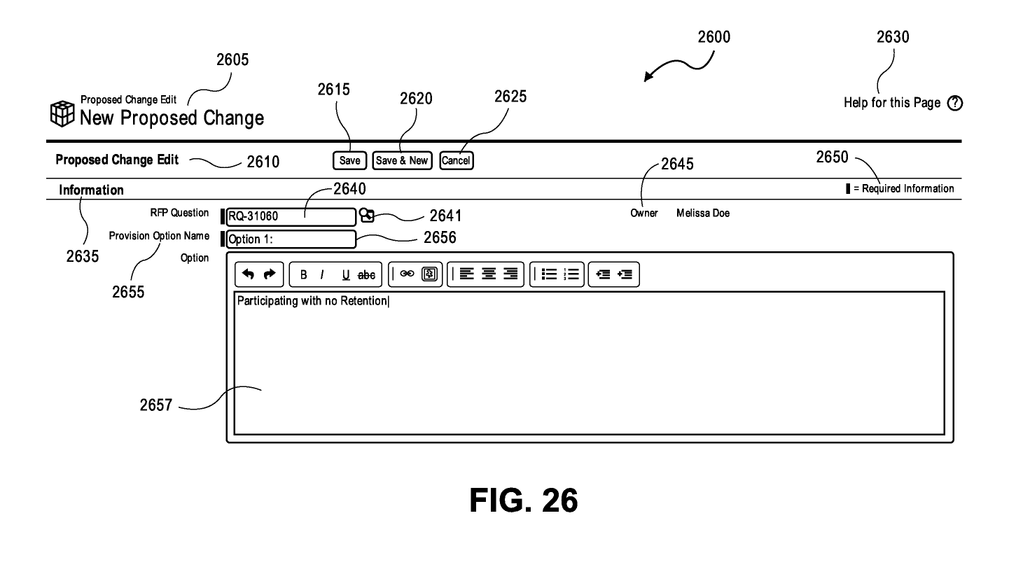

Turning to FIG. 26, a provision question addition user interface 2600 may include a new proposed change information title 2605, a help for this page selection icon 2630, and a proposed change edit information area 2610. The proposed change edit information area 2610 may include a save selection icon 2615, a save and new selection icon 2620, a cancel selection icon 2625, an information title 2635, an RFP question data entry area 2640 with a magnifier selection icon 2641, an owner ID 2645, a required information identification 2650, provision option name data entry area 2656, and an option data entry area 2657. When a Step 2: view provision questions selection link 2357 is selected, or add provision options 2655 is directly entered from user interface 2600, each proposed change may be entered separately so an insurance carrier can respond directly to each option, e.g., enter Option 1, then click Save & New and enter Option 2, then Save. Alternatively, all options may be lumped together in one box. Each proposed change may have a deviations/comments option for an associated insurance carrier to respond. The option data entry area 2657 may be, for example, a rich text field. Entries may be case sensitive, abbreviated, unique spelling, capitalized and/or punctuated. Text entered in area 2657 may appear to the insurance carriers EXACTLY as entered (i.e., Option 1 vs option 1). The save selection icon 2651 may be selected to return to the RFP/RFI screen 2300 or the save and new selection icon 2620 may be selected to enter additional proposed changes for a particular provision.

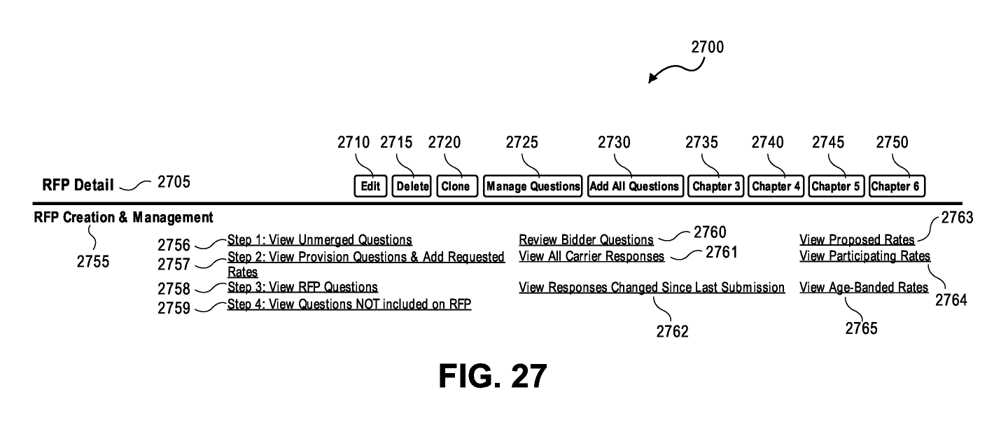

With reference to FIGS. 27-29, example user interfaces for adding rates when creating requests for proposals (RFPs) and/or requests for information (RFIs) 2700, 2800, 2900 are depicted. Turning to FIG. 27 a user interface for adding requested rates 2700 may include a RFP detail area 2705 having an edit selection icon 2710, a delete selection icon 2715, a clone selection icon 2720, a manage questions selection icon 2725, an add all questions selection icon 2730, a chapter 3 selection icon 2735, a chapter 4 selection icon 2740, a chapter 5 selection icon 2745, and chapter 6 selection icon 2750. The user interface 2700 may also include a RFP creation and management area 2755 having a step 1 selection link 2756, a step 2 selection link 2757, a step 3 selection link 2758, a step 4 selection link 2759, a review bidder question selection link 2760, a view all carrier responses selection link 2761, a view responses changed since last submission selection link 2762, a view proposed rates selection link 2763, a view participating rates selection icon 2764, and a view age-banded rates selection icon 2765. The step 2 selection icon 2757 may include a “View Provision Questions & Add Requested Rates” as a reminder that requested rates may be entered at this step of the RFP/RFI creation process. Rates may not actually reside within an RFP/RFI Tool. Like plan and plan class data elements, the rates may be pulled from a rate section at a plan level, and may be merged into a RFP/RFI question library. For example, all requested rates may be entered at the plan level. There may be, for example, four types of rates stored in a RFP/RFI portal: 1) current: the current in force rates for an active account; 2) requested: the rate type or rate structure you are requesting the insurance carrier to quote, e.g., Option 1: Current, Option 2: Participating; 3) proposed: the rate type/structure provided by the Carrier, based on the “Requested” rate tables created; and 4) historical: rates from a prior period that are no longer current but are needed for historical data provided in a RFP.

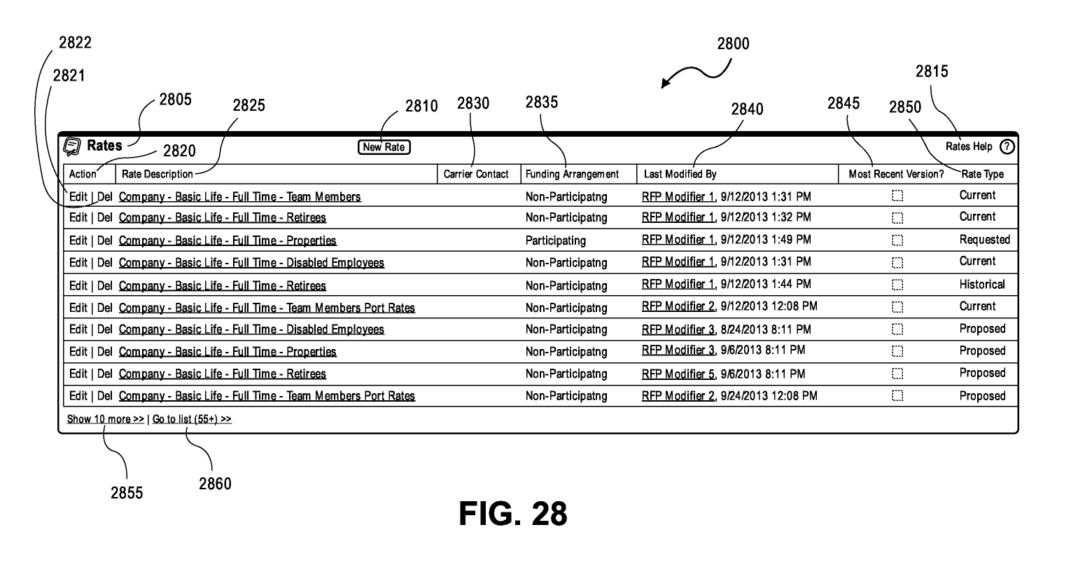

With reference to FIG. 28, a user interface for adding requested rates 2900 may include a rates area 2805 having a new rate selection icon 2810, a rates help ? selection icon 2815, an action column 2820 with an edit selection icon 2821 and a delete selection icon 2822, a rate description selection link column 2825, an insurance carrier contact column 2830, a funding arrangement column 2835, a last modified by selection link column 2840, a most recent version? Column 2845, a rate type column 2850, a shown 10 more selection link 2855 and a go to list (55+) selection link 2890. From the user interface 2800, the new rate selection icon 2810 may be selected to add a new requested rate to an RFP. The requested rate details may be filled out by, for example, changing the rate type 2850 to requested.

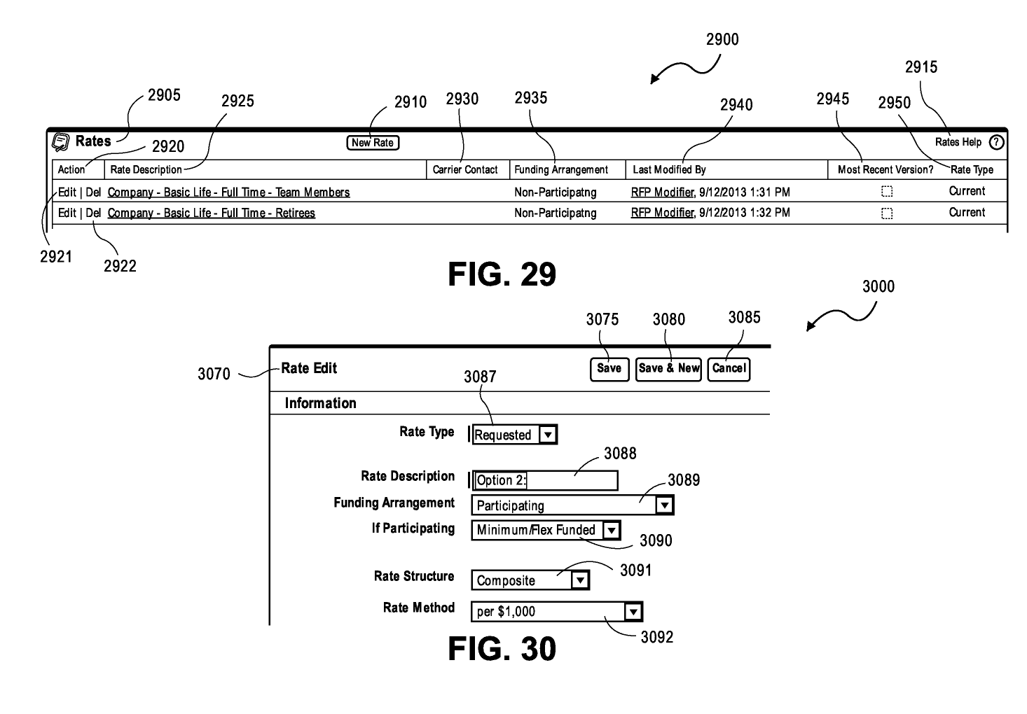

Turning to FIG. 29, a rate entry user interface 2900 may include a rates area 2905 having a new rate selection icon 2910, a rates help ? selection icon 2915, an action column 2920 with an edit selection icon 2910 and a delete selection icon 2922, a rate description selection link column 2925, an insurance carrier contact column 2930, a funding arrangement column 2935, a last modified by selection link column 2940, a most recent version ? column 2945 and a rate type column 2950.

With reference to FIG. 30, a rates user interface 3000 may include a rate edit area 3070 having a save selection icon 3075, a save and new selection icon 3080, a cancel selection icon 3085, a rate type selection pull-down menu 3087, a rate description data entry field 3088, a funding arrangement data entry selection pull-down menu 3089, an if participating selection pull-down menu 3090, a rate structure selection pull-down menu 3091, and a rate method selection pull-down menu 3092. The save selection icon 3075 may be selected, or if more than one requested rate option, the save and new selection icon 3080 may be selected. If there are only minor differences between proposed options, the requested rate may be saved 3075 and then cloned by selecting, for example, the clone selection icon 2720.

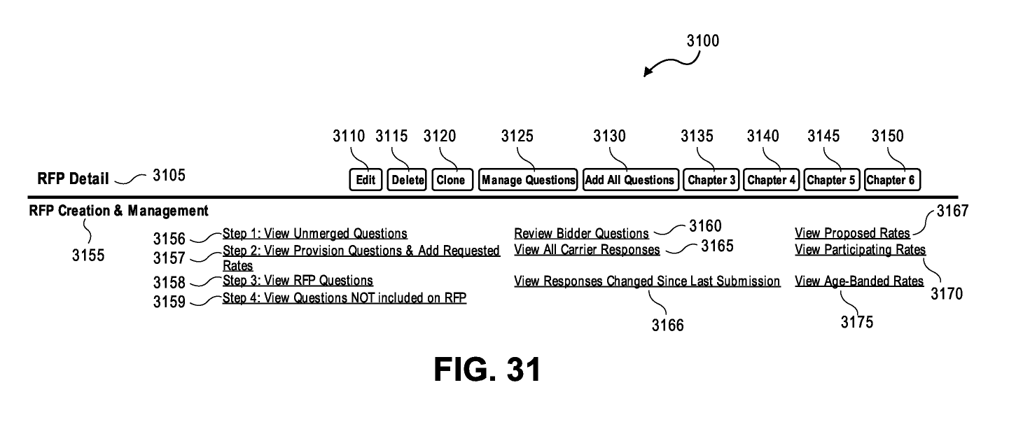

Turning to FIGS. 31-43, example user interfaces for viewing and modifying questions when creating requests for proposals (RFPs) and/or requests for information (RFIs) 3000, 3100, 3200, 3300, 3400, 3500, 3600, 3700, 3800, 3900, 4000, 4100, 4200, 4300 are depicted. With reference to FIG. 31, a questions viewing and modifying user interface 3100 may include a RFP detail area 3105 having an edit selection icon 3110, a delete selection icon 3115, a clone selection icon 3120, a manage questions selection icon 3125, an add all questions selection icon 3130, a chapter 3 selection icon 3135, a chapter 4 selection icon 3140, a chapter 5 selection icon 3145, and chapter 6 selection icon 3150. The user interface 3100 may also include a RFP creation and management area 3155 having a step 1 selection link 3156, a step 2 selection link 3157, a step 3 selection link 3158, a step 4 selection link 3159, a review bidder question selection link 3160, a view all carrier responses selection link 3165, a view responses changed since last submission selection link 3166, a view proposed rates selection link 3167, a view participating rates selection icon 3170, and a view age-banded rates selection icon 3175. Selecting the step 3: view RFP/RFI questions selection link 3158 may allow review of all questions that are generated to ensure the questions are applicable to the RFP, and to ensure that all data has merged successfully. There may be two ways to review a question library: 1) export all questions to a spreadsheet (e.g., Excel); and 2) review all questions in a RFP/RFI user interface 3100. When the questions are reviewed in Excel, question data can be sorted, manipulated, searched and/or reviewed offline. The Step 3: View RFP/RFI Questions selection link 3158 may be selected from the RFP/RFI user interface 3100 to launch a report of all questions included in the RFP.

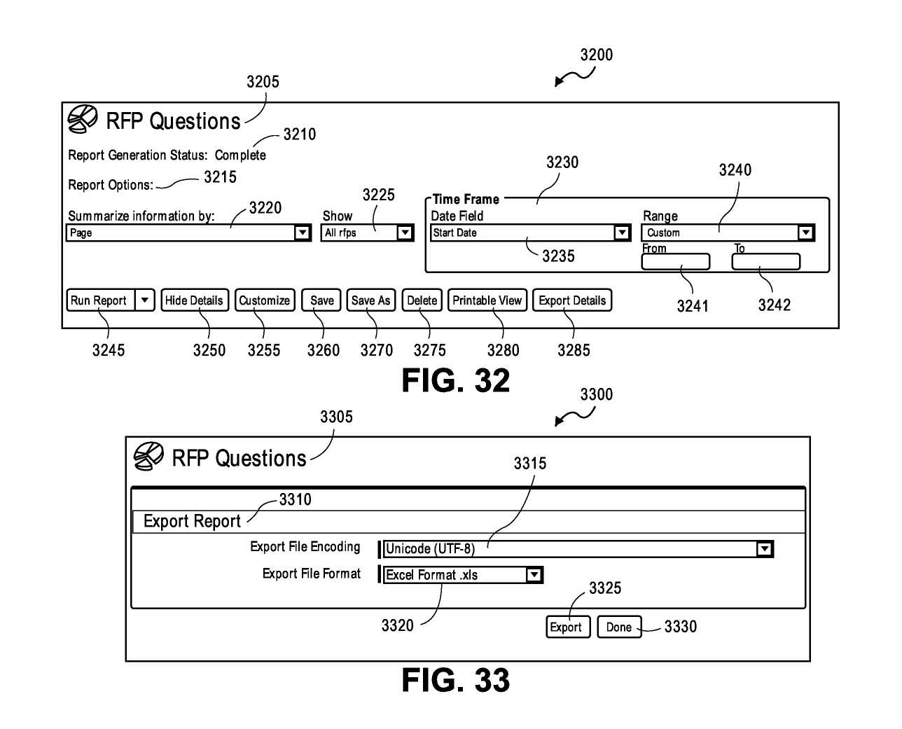

Turning to FIGS. 32 and 33, all RFP/RFI questions may be viewed by selecting the step 3: view RFP/RFI questions selection icon 3158. The user interface 3200 may include a RFP questions title 3205, a report generation status indicator 3210, and a report options area 3215. The report options area 3215 may include a summarize information by selection pull-down menu 3220, a show selection pull-down menu 3225, a range selection pull-down menu 3240 with a from data entry area 3241 and a to data entry area 3242, a run report selection icon 3245, a hide details selection icon 3250, a customize selection icon 3260, a save selection icon 3260, a save as selection icon 3270, a delete selection icon 3275, a printable view selection icon 3280 and an export details selection icon 3285. The user interface 3300 may include an RFP questions title 3305 and an export report area 3310 having an export file encoding selection pull-down menu 3315, an export file formal selection pull-down menu 3320, an export selection icon 3325, and a done selection icon 3330. To export the data to Excel, the export details selection icon 3285 may be selected (do not modify the pre-populated formatting options), the export selection icon 3325 may be selected, then the Excel file may be opened when prompted. The report may then be saved in Excel by, for example, changing the file type from a Web Page to an Excel document. Once exported to Excel, the question data may be sorted, columns may be modified, etc.

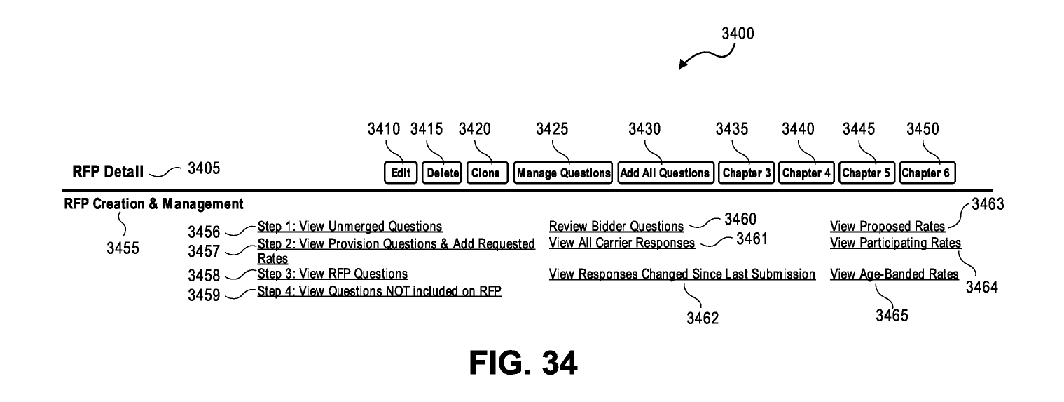

With reference to FIG. 34, a user interface for viewing all RFP/RFI questions 3400 may include a RFP detail area 3405 having an edit selection icon 3410, a delete selection icon 3415, a clone selection icon 3420, a manage questions selection icon 3425, an add all questions selection icon 3430, a chapter 3 selection icon 3435, a chapter 4 selection icon 3440, a chapter 5 selection icon 3445, and chapter 6 selection icon 3450. The user interface 3400 may also include a RFP creation and management area 3455 having a step 1 selection link 3456, a step 2 selection link 3457, a step 3 selection link 3458, a step 4 selection link 3459, a review bidder question selection link 3460, a view all carrier responses selection link 3461, a view responses changed since last submission selection link 3462, a view proposed rates selection link 3463, a view participating rates selection icon 3464, and a view age-banded rates selection icon 3465. Selection of the step 3: view RFP/RFI questions selection link 3458 may be selected to view the questions in the RFP/RFI user interface 3400, and the manage questions selection icon 3425 to access the question wizard.

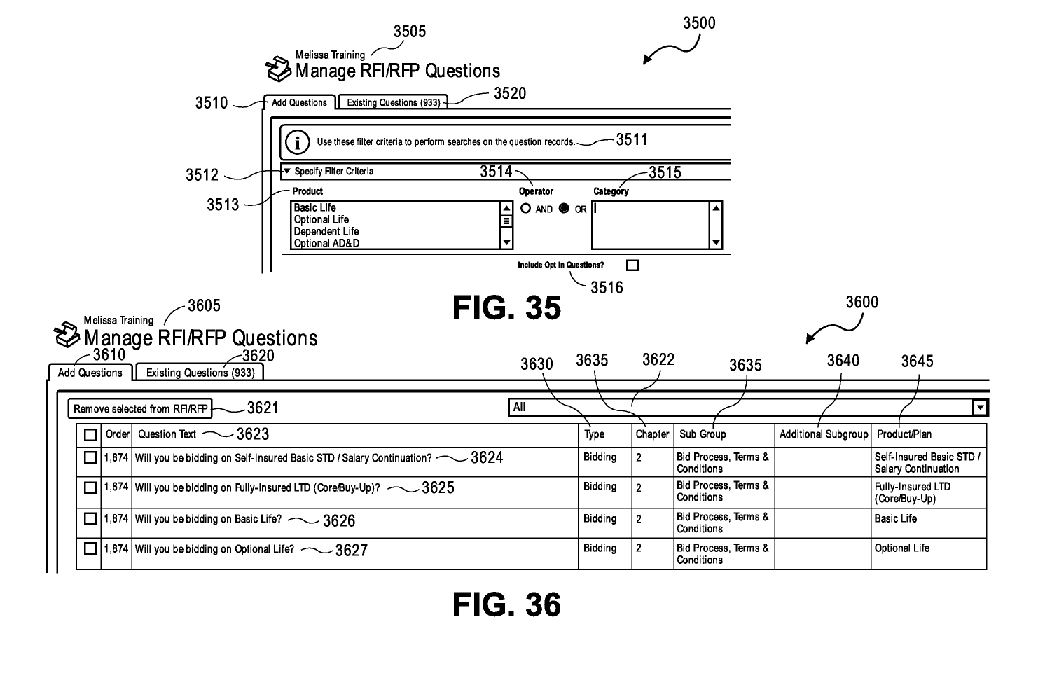

Turning to FIGS. 35 and 36, the manage RFP/RFI questions user interface 3500 may include a manage RFI/RFP questions title 3520, an information area 3511, a specify filter criteria selection pull-down menu 3512, a product selection area 3513, an operator selection 3514 and/or a category data entry area 3515, and an include opt in questions selection check box 3516. The manage RFI/RFP questions user interface 3600 may include a manage RFI/RFP questions title 3605, an add questions selection icon 3610, an existing questions indicator tab 3620, a remove selected from RFI/RFP selection icon 3621 pull-down selection menu 3622, an order question text check box column 3623 having a first question 3624, a second question 3625, a third question 3626, and a fourth question 3627, a type column 3630, a chapter column 3635, an additional subgroup column 3640, and a product/Plan column 3645. Selection of the step 3: view RFP/RFI questions selection icon 3457 may be selected to see all questions in the RFP/RFI user interface 3600, and the existing questions tab 3520 to display a full list of questions.

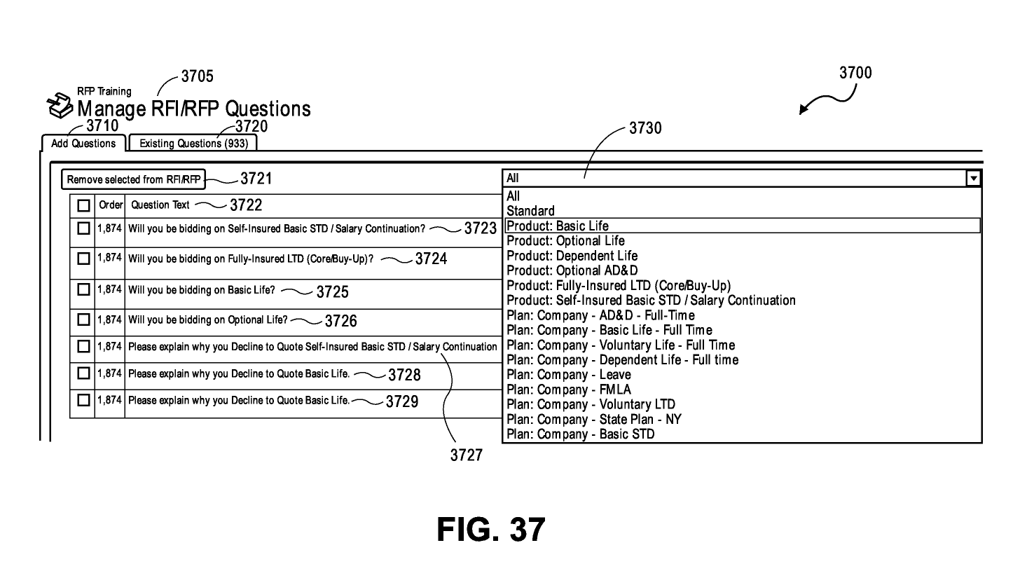

With reference to FIG. 37, a user interface for view all RFP/RFI questions 3700 may include a manage RFI/RFP questions title 3705, an add questions selection tab 3710, and an existing questions selection tab 3720 having a remove selected from RFI/RFP title 3721 pull-down menu 3730, and an order questions selection box column 3722 with a first question 3723, a second question 3724, a third question 3725, fourth question 3726, a fifth question 3727, a sixth question 3728, and an eighth question 3729. Selection of the step 3: view RFP/RFI questions selection icon 3458 may, if multiple lines of coverage (LOCs) or plan classes are included in an RFP/RFI, filter down questions to view only questions related to a specific LOC or plan class. For Example, the pull-down menu 3723 may be selected to query questions related to a specific item.

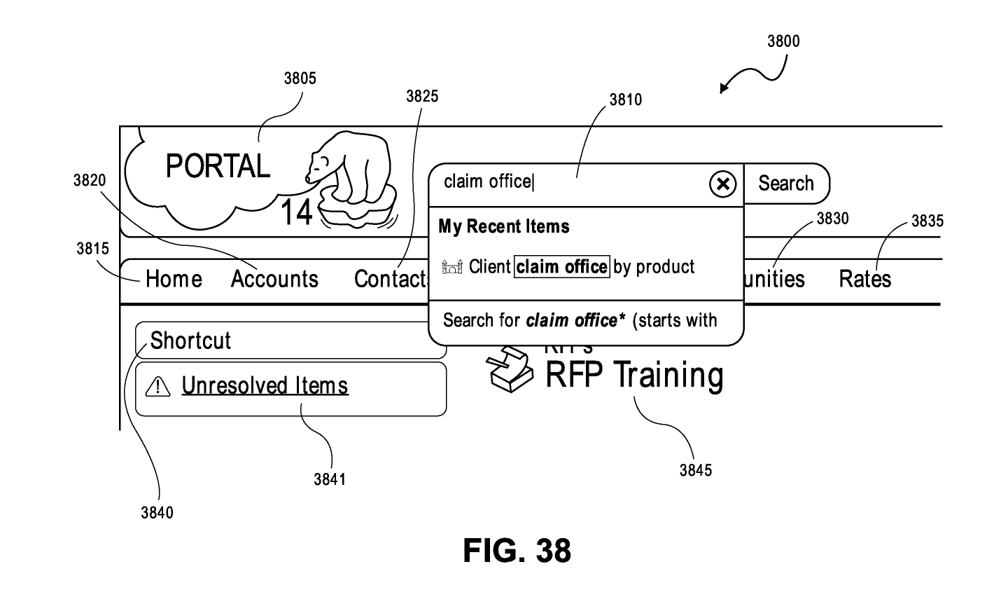

Turning to FIG. 38, a RFP/RFI portal user interface 3800 may include a portal title 3805, a claim office data entry search field 3810, a home selection icon 3815, an accounts selection icon 3820, a contact selection icon 3825, an opportunities selection icon 3830, a rates selection icon 3835, a short cut selection tab icon 3840, an unresolved items selection link 3841, and an RFP/RFI creator identification 3845. Selection of the step 3: view RFP/RFI questions selection icon 3458 may, as with an alternate RFP/RFI creation process, include some Accounts and/or RFPs that may require additional customization of corresponding RFP/RFI questions. A RFP/RFI portal administrator may modify existing questions to fit those needs, or additional/new questions may be added to the RFP. A provision or keyword on the view questions page may be found by using, for example, a Ctrl+F combination on a keyboard instead of selection of a SF search selection icon. Ctrl+F may allow search of a page instead of scrolling through all the provisions.

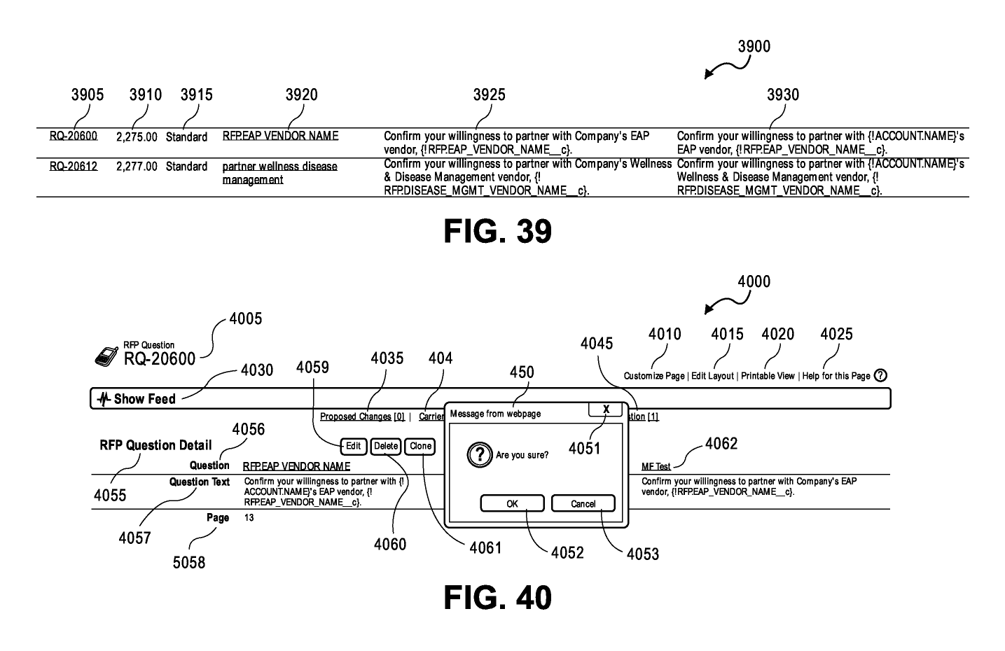

With reference to FIG. 39 a user interface for modifying/deleting RFP/RFI questions 3900 may include a question ID link column 3905, a question number column 3910, a question link 3920, a question content data column 3925, and an alternate question content column 3930. Selection of the step 3: modifying existing or adding new RFP/RFI questions 3458 may be used, for example, after determining that a question is not addressed elsewhere, and a user is sure the question is not already in the RFP/RFI or phrased differently by searching for keywords. A request may, for example, be sent to a RFP/RFI portal administrator with the following information: 1a) an order number and question text of the question to be modified, and 2a) a modification requested; OR 1b) the new question to be added to the RFP, and 2b) an order the question is to be inserted into the RFP. Because original questions may be created in order (1989.00, 1990.00, 1991.00), another whole number question (1989.00, for example) may not be created. As an alternative, new questions may be fit in between existing questions (e.g., 1989.01, 1989.02).

Turning to FIG. 40, a user interface for modifying/deleting RFP/RFI questions 4000 may include a RFP/RFI question ID 4005, a customize page selection icon 4010, an edit layout selection icon 4015, a printable view selection icon 4020, a help for this page selection icon 4025, a show feed selection icon 403, a proposed changes selection link 4035, an insurance carrier selection link 4040, a question selection icon 4045, a message pop-up window 4050 with an exist selection icon 4051, an OK selection icon 4052, and a Cancel selection icon 4053, a RFP question detail title 4055, a question identification selection link 4056, question text data 4057, a page identifier 5058, edit selection icon 4059, a delete selection icon 4060, a close selection icon 4061, a MF test selection link 4062. There may be instances when a question may be deleted from an RFP/RFI because it does not apply (i.e., Data Warehousing or Benefit Outsourcing to a TPA, or per the client's request) by deleting questions individually by selecting the RFP/RFI question ID 3905 from an unmerged or a view questions report.

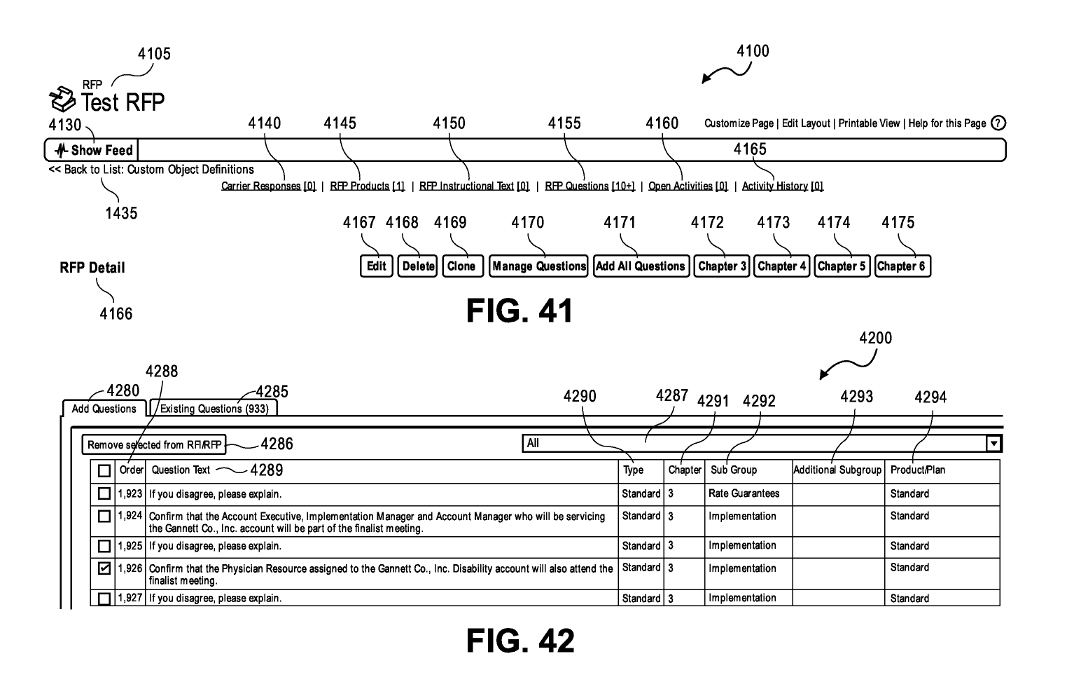

With reference to FIG. 41, a user interface for modifying/deleting RFP/RFI questions 4100 may include a RFP/RFI identification 4105, a customize page selection icon 4110, an edit layout selection icon 4115, a printable view selection icon 4120, a help for this page selection icon 4125, a show feed selection icon 4130, a back to list: custom object definitions selection icon 4135, an insurance carrier responses selection link 4140, a RFP products selection link 4145, a RFP instructions text selection link 4150, a RFP questions selection link 4155, an open activities selection link 4160, an activity history selection link 4165, and an RFP detail area having an edit selection icon 4167, a delete selection icon 4168, a close selection icon 4169, a manage questions selection icon 4170, an add all questions selection icon 4171, a chapter 3 selection icon 4172, a chapter 4 selection icon 4173, a chapter 5 selection icon 4174, and a chapter 6 selection icon 4175.

With reference to FIG. 42, a user interface for modifying/deleting RFP/RFI questions 3900 may include an add questions selection tab 4280, an existing questions selection tab 4285, a remove selected from RFI/RFP selection icon 4286 pull-down menu 4287, a question order selection box column 4288, a question text column 4289, a question type column 4290, a chapter column 4291, a sub group column 4292, an additional subgroup column 4293, and a product/plan column 4294. Multiple questions may be deleted at once by selecting the manage questions selection icon 4170 from the RFP/RFI user interface 4100, the existing questions selection tab 4285 may be selected, the questions to be deleted are selected, and the remove selection icon 4286 is selected. Alternatively, the questions to be deleted from each page may be selected and the remove selection icon 4286 selected before proceeding to the next page.

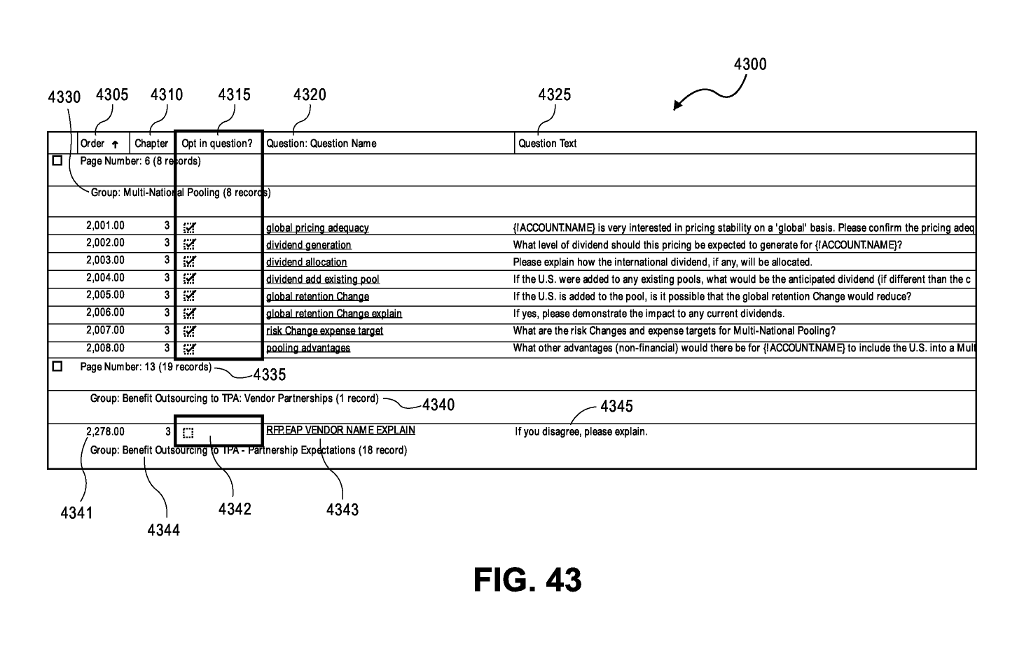

Turning to FIG. 43, a user interface for modifying/deleting RFP/RFI questions 3900 may include a question order column 4305, a chapter column 4310, an opt in question column 4315, a questions: question name column 4320, a question text column 4325, a group: multi-national pooling identification 4330, a page number identifier 4335, a group: benefit outsourcing to TPA: Vendor partnerships identification 4340, a question number 4341 entry box 4342, a RFP: EAP vendor name explain selection link 4343, a Group: benefit outsourcing to TPA partnership expectations identification 4344, and an if you disagree, please explain data entry area 4345. Selection of the step 4: View Questions NOT included on RFP selection link 3459 may be used as a final Q&A to review the questions that will not be included in the RFP to ensure that the questions were not accidentally deleted or overlooked when reviewing and modifying the question set. This report may include questions that did not pull into the RFP, such as Opt-In Questions that were NOT selected, i.e., Multi-National Pooling or TPA's. The report may also include questions that were physically deleted in Step 3 (i.e., no checkbox indicates a manual deleted question).

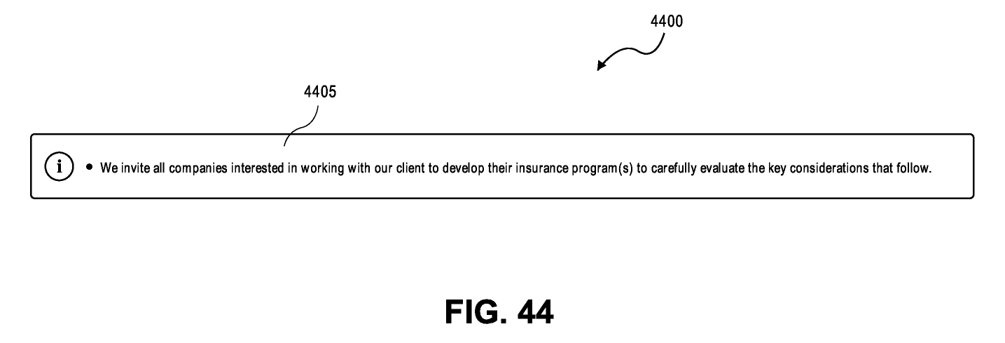

With reference to FIG. 44, an example user interface for adding special instructions when creating requests for proposals (RFPs) and/or requests for information (RFIs) 4400 may include an information banner 4405. For example, some RFPs may require additional information to be shared with an insurance carrier regarding plan design or other data included in the RFP. Customized instructional text may be added to address these items, such as client-specific terminology, for example: “Please note that any references to ‘STD’ used in the RFP/RFI tool are specific to the company Illness Recovery Time (IRT) plan.” A request to add an information banner 4405 may be submitted to a RFP/RFI portal administrator with, for example, the following information: the text to be included in the RFP/RFI (verbatim), and where the text should be inserted into the RFP/RFI (page number). The RFP/RFI portal may limit where this text may be inserted. Most often the text can be included at the top or bottom of any given page. Before the final QA of an RFP: all proposed plan design options and requested rates, that are entered should be confirmed; all questions in the question set may be reviewed; an unmerged question report may be run, no issues should be left on this report if all missing data is correctly entered and deleted questions that do not apply to the RFP are confirmed. If any data remains on the report, the report will display that way in an insurance carrier portal.

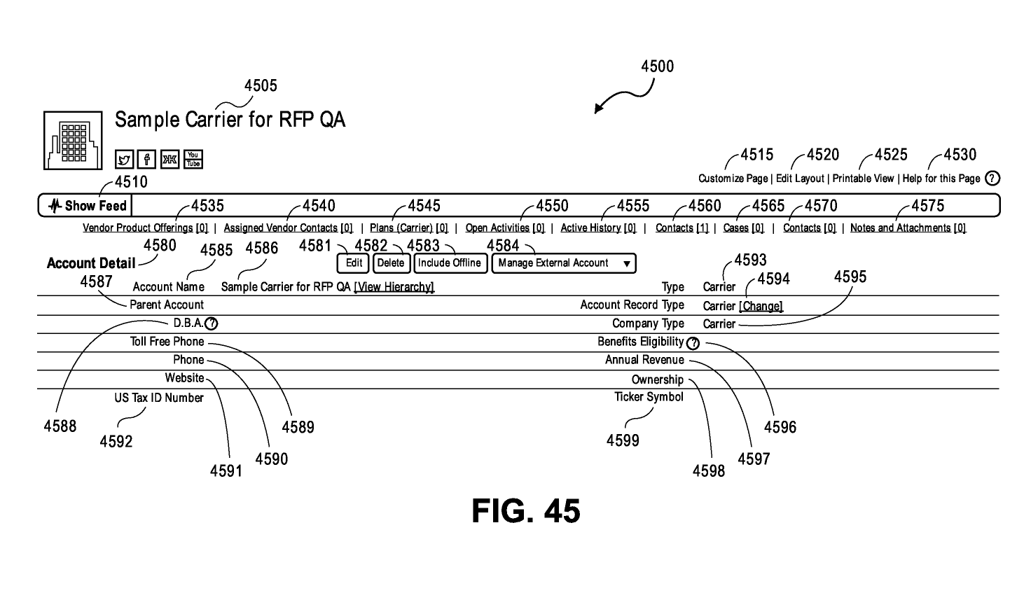

Turning to FIG. 45, an example user interface for reviewing an RFP and/or RFI from an insurance carrier's perspective when creating requests for proposals (RFPs) and/or requests for information (RFIs) 4500 may include a sample carrier for RFP quality assurance (QA) title 4505, a show feed selection icon 4510, a customize page selection icon 4515, an edit layout selection icon 4520, a printable view selection icon 4525, a help for this page selection icon 4530, a vendor product offerings selection link 4535, an assigned vendor contacts selection link 4540, a plans carrier selection link 4545, an open activities selection link 4550, an activity history selection link 4555, a contacts selection link 4560, a cases selection link 4565, a contacts selection link 4570, a notes and attachments selection link 4575, and an account detail information area 4580. The account detail information area 4580 may include an edit selection icon 4581, a delete selection icon 4582, an include offline selection icon 4583, a manage external account selection icon 4584, an account name 4585 sample carrier for RFP QA selection link 4586, a parent account ID 4587, a D.E.A. ID 4588, a toll free phone ID 4589, a phone ID 4590, a website ID 4591, a us tax ID number 4592, a type (e.g., carrier) 4593, an account record type (e.g., carrier—change link) 4594, a company type (e.g., carrier) 4595, a benefits eligible ID 4596, an annual revenue ID 4597, an ownership ID 4598, and a ticker symbol ID 4599. Before opening the RFP/RFI to the insurance carriers, the RFP/RFI may be reviewed from the carrier's perspective to ensure that all RFP/RFI questions and materials are displayed and referenced properly in the RFP/RFI portal. Seeing the RFP/RFI from the carrier's perspective may prompt addition of information to the RFP and may allow for a final QA of your RFP/RFI data. A sample insurance carrier contact may be created in the RFP/RFI portal to be used in the QA process.

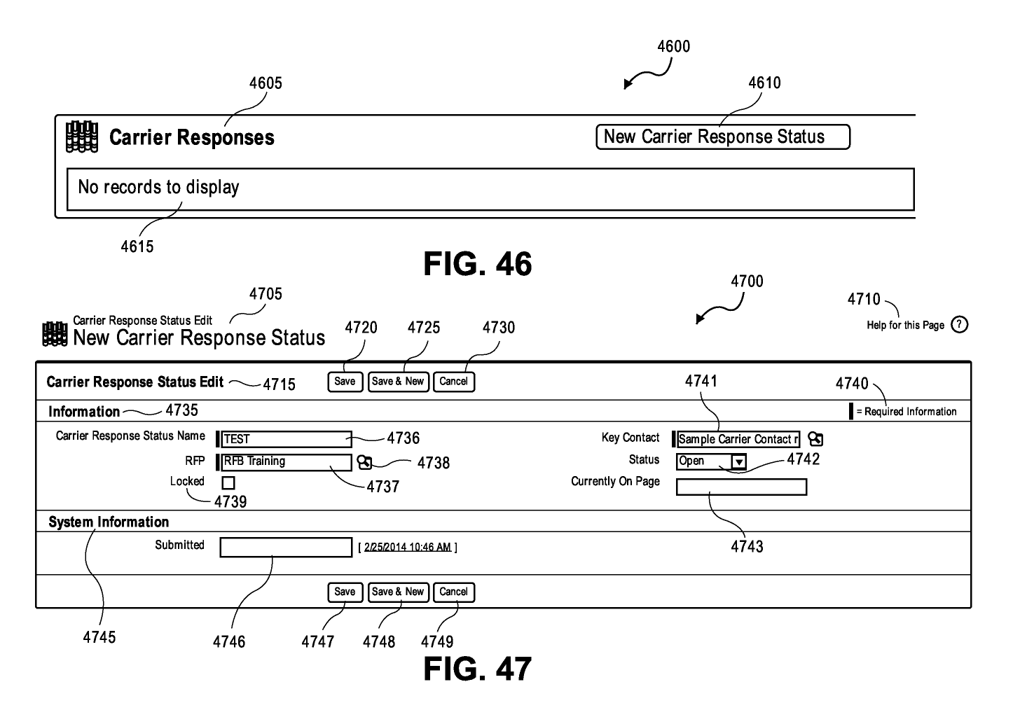

With reference to FIGS. 46-51, example user interfaces, for adding carriers when creating requests for proposals (RFPs) and/or requests for information (RFIs), 4600, 4700, 4800, 4900, 5000, 5100 are depicted. The user interface 4600 may include a carrier responses title 4605, a new carrier response status selection icon 4610, and a records list 4615. The carrier addition process may begin by navigating back to a RFP/RFI record 4600, finding the carrier response section 4615, and selecting the new carrier response status selection icon 4610.

Turning to FIG. 47, the user interface for adding a sample carrier contact 4700 may include a new carrier response status title 4705, a help for this page selection icon 4710, a carrier response status edit area 4715, and a system information area 4745. The carrier response status edit area 4715 may include a save selection icon 4720, a save and new selection icon 4725, a cancel selection icon 4730, an information identification 4735, a require information designation 4740, a carrier response status name data entry field 4736, a RFP data entry field 4737 with search selection icon 4738, a locked selection box 4739, a key contact data entry field 4741 with search selection icon, a status selection pull-down menu 4742, and a currently on page indication 4743. The system information area 4745 may include a submitted date data entry field 4746 with date/time selection icon, a save selection icon 4747, a save and new selection icon 4748, and a cancel selection icon 4749. TEST may be entered as the carrier response status name 4736. The key contact name for QA 4741 may be sample carrier contact name for RFP/RFI QA. These entries may be typed this in, or use the search icon to find the entry in a RFP/RFI portal contacts. The status may be left as “Open” and the save selection icon 4720 may be selected.

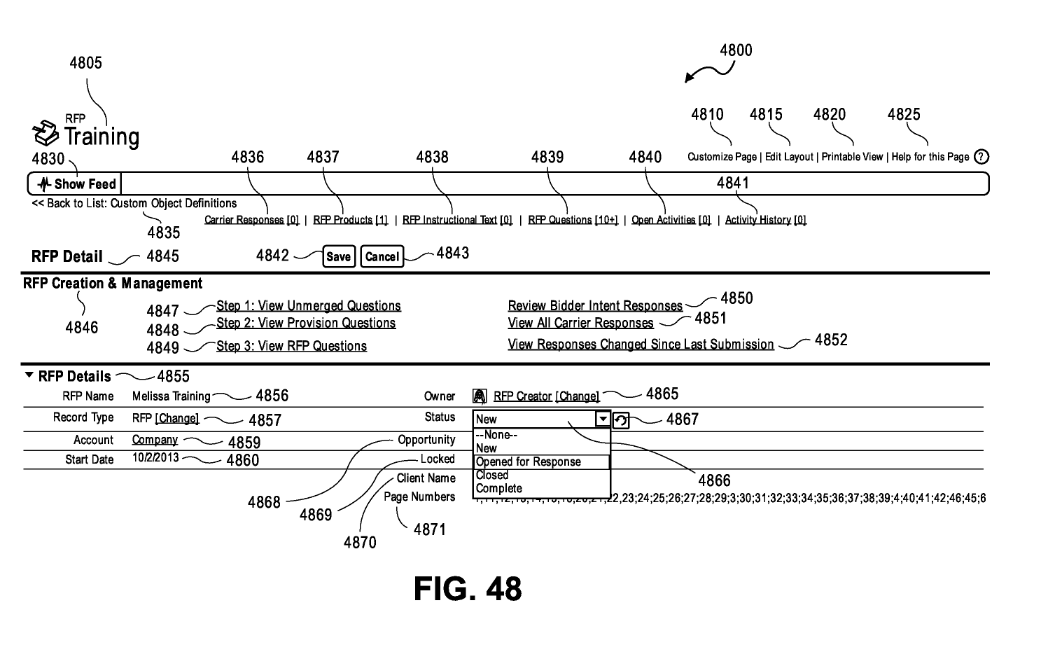

With reference to FIG. 48, a user interface for granting sample carrier access 4800 may include an RFP training title 4805, a customize page selection icon 4810, an edit layout selection icon 4815, a printable view selection icon 4820, a help for this page selection icon 4825, a shown feed selection icon 4830, a back to list: custom object definitions selection icon 4835, a carrier responses selection link 4836, a RFP products selection link 4837, a RFP instructional text selection link 4838, a RFP questions selection link 4839, an open activities selection link 4840, an activity history selection link 4841, a save selection icon 4842, a cancel selection icon 4843, an RFP detail area 4845, and a RFP details pull-down menu 4855. The RFP detail area 4845 may include a step 1 selection link 4847, a step 2 selection link 4848, a step 3 selection link 4849, a review bidder intent responses selection link 4850, a view all carrier responses selection link 4851, a view responses changed since last submission selection link 4852, a RFP name ID 4856, a record type 4857, an account ID 4859, a start date 4860, an owner ID selection link 4865, a status selection pull-sown menu 4866 with search selection icon 4867, an opportunity ID 4868, a locked selection box 4869, a client name ID 4870, and a page numbers indication 4871. Before the carrier portal may be logged into, to review the RFP/RFI, a sample carrier contact access to the RFP may be granted. This may be the same process used to open the RFP/RFI to actual insurance carriers once the remaining steps in the RFP/RFI process are completed. To open the RFP/RFI to the sample carrier contact, the RFP/RFI record may be opened, the status to may be changed to opened for response, and the save selection icon 4842 may be selected to save the RFP. This may make the RFP/RFI available for review. Insurance carriers will not be able to access the RFP/RFI the carrier(s) are added as a new carrier response status, as discussed elsewhere herein.

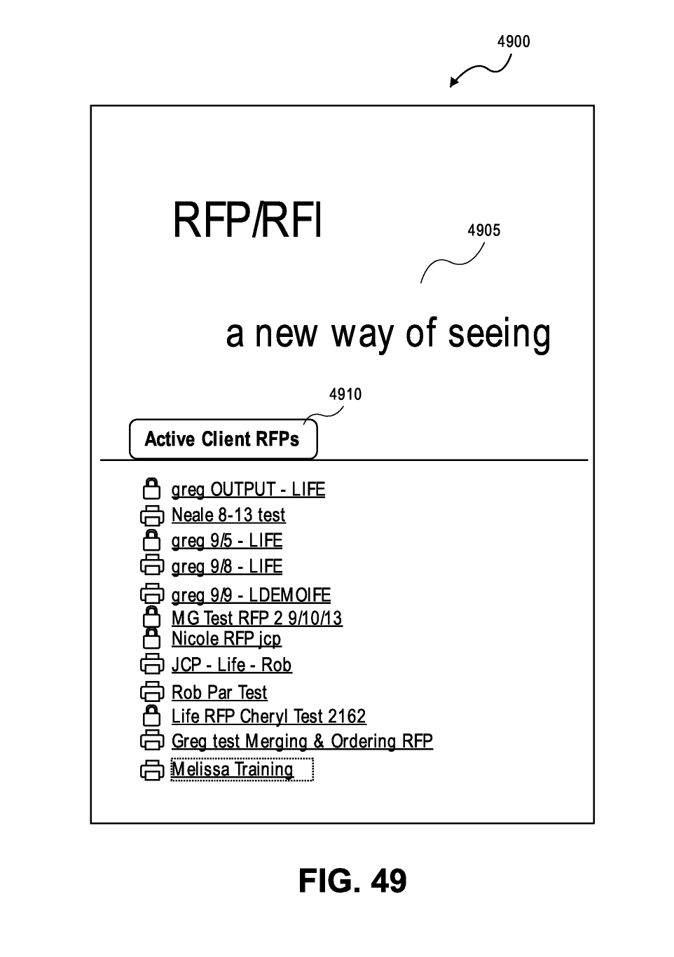

Turning to FIG. 49 a user interface for logging into a carrier portal 4900 may include a RFP/RFI title 4905 and a list of active client RFP(s)/RFI(s) 4910. Log into the carrier portal to view a RFP may include: navigating to a Website (e.g., http://pacresbenefits.force.com/); entering a username: (e.g., my.name@pacresbenefits.com); entering a password: (e.g., pacres01 (case sensitive)). After logging into the carrier portal, the name of a corresponding RFP may be displayed. Additionally, all open RFPs/RFIs may be displayed 4910. The RFP/RFI that was created for QA may be selected, the RFP/RFI may be reviewed, and any additional changes needed may be noted. For example, questions to be updated or additional instructional text needed may be noted. A RFP/RFI portal Administrator may be contacted on updates needed. Before opening the RFP/RFI to the insurance carriers: all proposed plan design options may be confirmed and requested rates may be entered. All questions in the question set may be reviewed. An unmerged question report may be re-run. No issues should be left on this report if all missing data is filled in, and all questions, that do not apply to the RFP/RFI, are deleted. If any data remains on the report, the data may be displayed in the insurance carrier portal. The quality assurance (QA), in the carrier portal may be completed, and adjustments to the RFP/RFI may be made as desired. The RFP/RFI should be in a final shape and ready for the insurance carriers to respond.

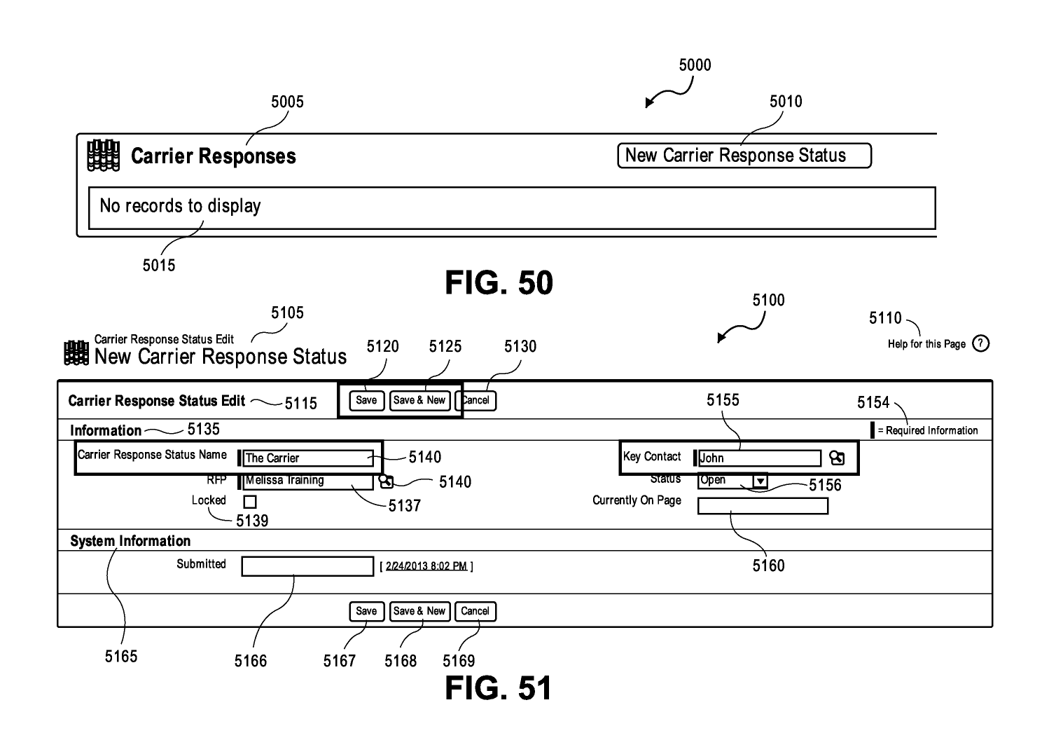

With reference to FIG. 50, a user interface for adding carriers 5000 may include a carrier responses title 5005, a new carrier response status selection icon 5010, and a records display area 5015. Insurance carriers, that should respond to the RFP, may be added by navigating back to the RFP/RFI record 5000, finding the carrier response section, and selecting the new carrier response status selection icon 5010. The user interface 5100 may be generated in response to the new carrier response status selection icon 5010 being selected.

Turning to FIG. 51, a user interface for adding carriers 5100 may include a new carrier response status title 5105, a help for this page selection icon 5110, a carrier response status edit area 5115, and a system information are 5165. The carrier response status edit area 5115 may include a save selection icon 5120, a save and new selection icon 5125, a cancel selection icon 5130, an information area 5135 with a carrier response status name 5136 and carrier name, a carrier search icon 5140, a key contact name and search icon 5155, a status selection pull-down menu 5156, a locked check box 5139, and a current page indication 5160. The system information area 5165 may include a submitted date/time data entry field with link 5166, a save selection icon 5167, a save and new selection icon 5168, and a cancel selection icon 5169. Details may be filled out, such as the insurance carrier response status name 5136, using the formal carrier name, e.g., “MetLife”, not “met”; “Prudential”, not “pru.” This field may be displayed on associated chapter output documents. The status may be left as “Open” and the save selection icon 5120, or the save and new selection icon 5125, may be selected to enter additional carrier responses. The key contact 5155 may be a person who has been granted RFP/RFI access. A list of key contacts, by carrier, may be provided as a look-up table.

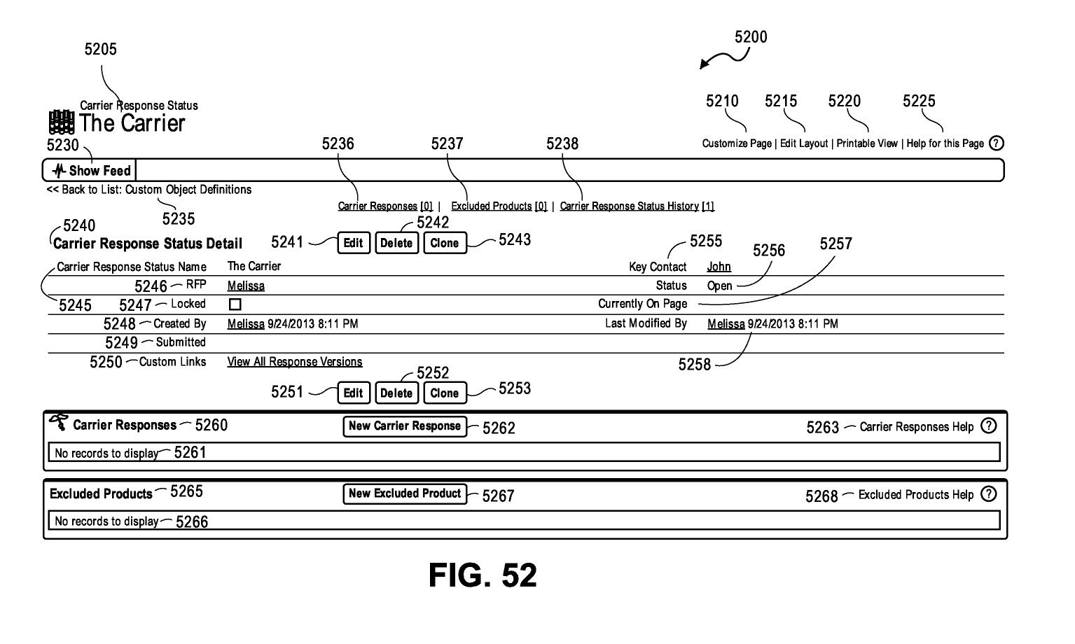

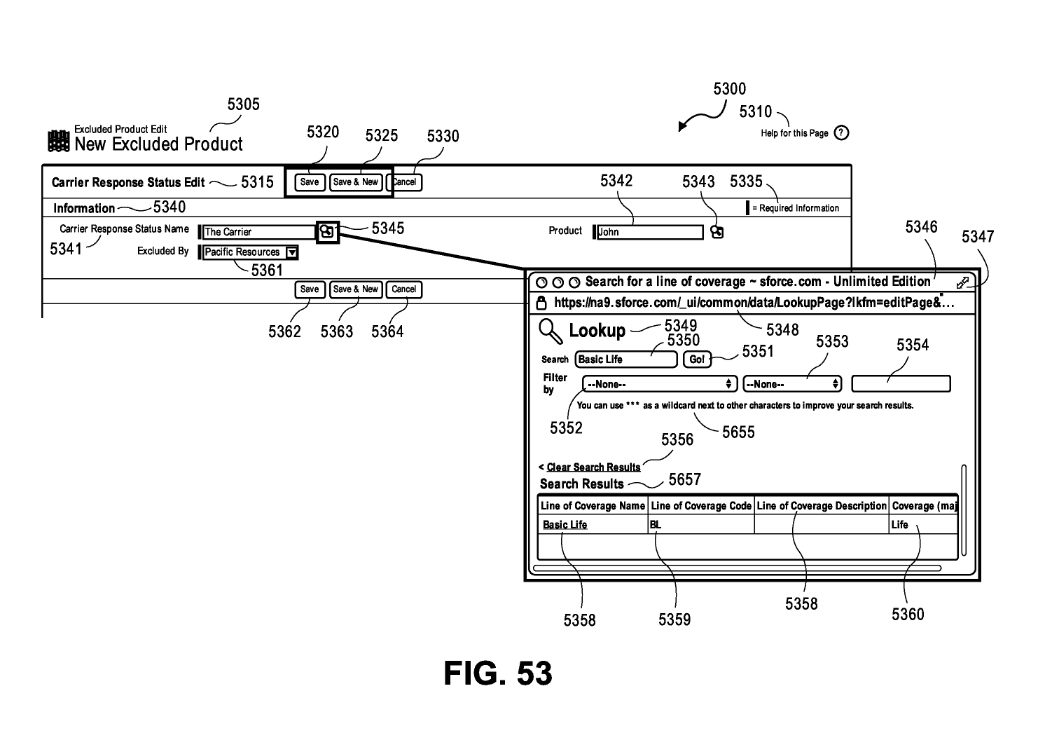

Turning to FIGS. 52 and 53, example user interfaces for adding exceptions when creating requests for proposals (RFPs) and/or requests for information (RFIs) 5200, 5300 are depicted. After adding the Carrier, you may choose to exclude products from their individual RFP. The user interface 5200 may include a carrier ID 5205, a customize page selection icon 5210, an edit layout selection icon 5215, a printable view selection icon 5220, a help for this page selection icon 5225, a shown feed selection icon 5230, a back to list: custom object definitions selection icon 5235, a carrier responses selection link 5236, an excluded products selection link 5237, a carrier response status history selection link 5238, a carrier response status detail area 5240, a carrier responses area 5260, and an excluded products area 5265. The carrier response status detail 5240 may include an edit selection icon 5241, a delete selection icon 5242, a close selection icon 5243, a carrier response status name 5245, a RFP ID 5246, a locked indicator 5247, a created by indication 5248, a submitted date/time 5249, a custom links selection 5250, a key contact ID 5255, a status indication 5256, a currently on page indication 5257, and a last modified by indication 5258. The carrier responses area 5260 may include an edit selection icon 5251, a delete selection icon 5252, a close selection icon 5253, records display area 5261, a new carrier response selection icon 5262, and a carrier responses help selection icon 5263. The excluded products area 5265 may include a records display area 5261, a new excluded product selection icon 5267, and an excluded products help selection icon 5268. Excluded Products are only selected when Pacific Resources has decided the Carrier should not respond to a specific coverage. Minor lines of coverage (LOCs) (products) may automatically be excluded from the RFP/RFI when a carrier DTQ's that coverage. Based on the carrier bidder question responses, an RFP/RFI generator may know to remove the questions associated with the minor LOC that the bidder declined to quote on.

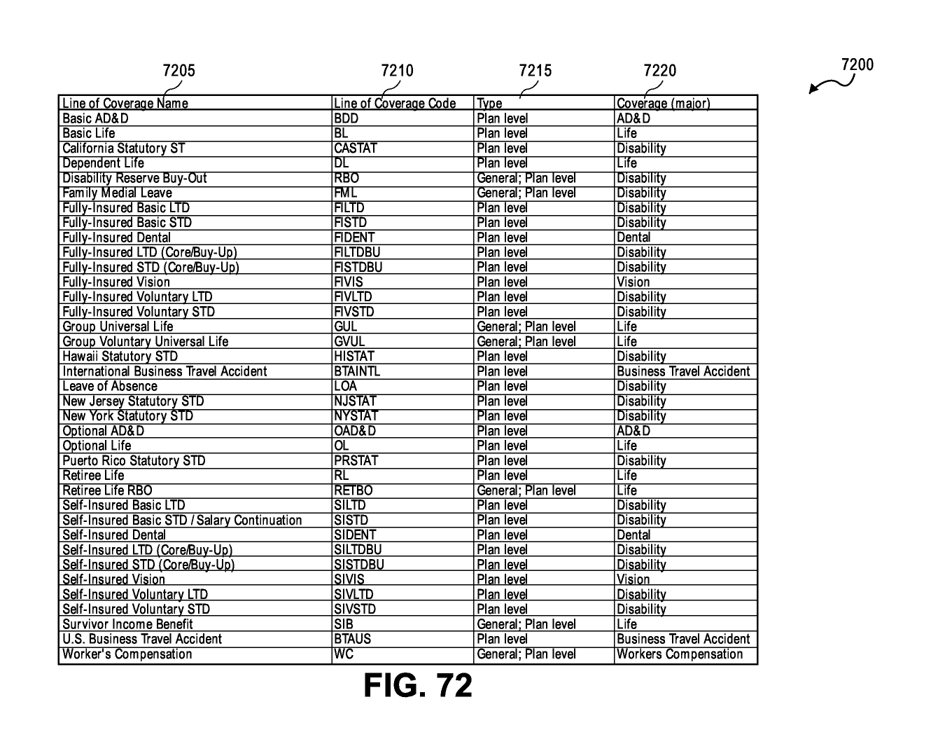

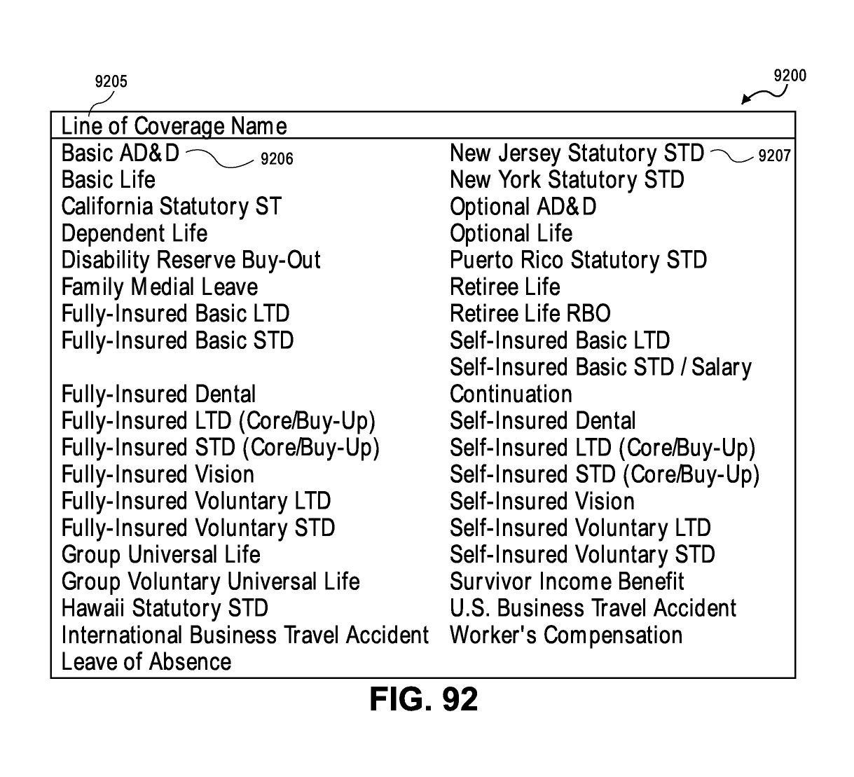

With reference to FIG. 53, a user interface for adding exceptions 5300 may include a new excluded product title 5305, a help for this page selection icon 5310, an excluded product edit area 5315, a save selection icon 5320, a save and new selection icon 5325, a cancel selection icon 5330, a required information indication 5335, and an information area 5340. The information area 5340 may include a carrier response status 5341 with a search (or lookup) selection icon 5345, a product entry area 5342 with a search (or lookup) selection icon 5343, an excluded by selection pull-down menu 5361, a save selection icon 5362, a save and new selection icon 5363, and a cancel selection icon 5364. When a user selects the carrier response status search selection icon 5345 a pop-up window may be generated, and may include a search for line of coverage selection 5346 with search icon 5347, a URL address indication 5348, a lookup selection icon 5349, a search entry field 5350 with go selection icon 5351, filter by entry fields 5352, 5353, 5354, a filter instruction 5355, a clear search results selection link 5356, and a search results area 5357. The search results area 5757 may include column headers (e.g., line of coverage name, line of coverage code, line of coverage description, and coverage (major)) 5358 with, for example, a basic life link 5359 (or any other line of coverage link) with corresponding a code 5359 and major coverage indicator 5360. Minor lines of coverage (LOC's) may be selected that an insurance carrier should not have access to (i.e., are excluded) as part of the RFP/RFI process, the save selection icon 5362 may be selected, or the save and new selection icon 5363 may be selected to add more than one excluded product. The lookup 5349 may be selected to access an entire available library of LOC's. The LOC selected may match a LOC used when creating the RFP. FIGS. 72 and 92 contain lists of core minor lines of coverages (LOC's).

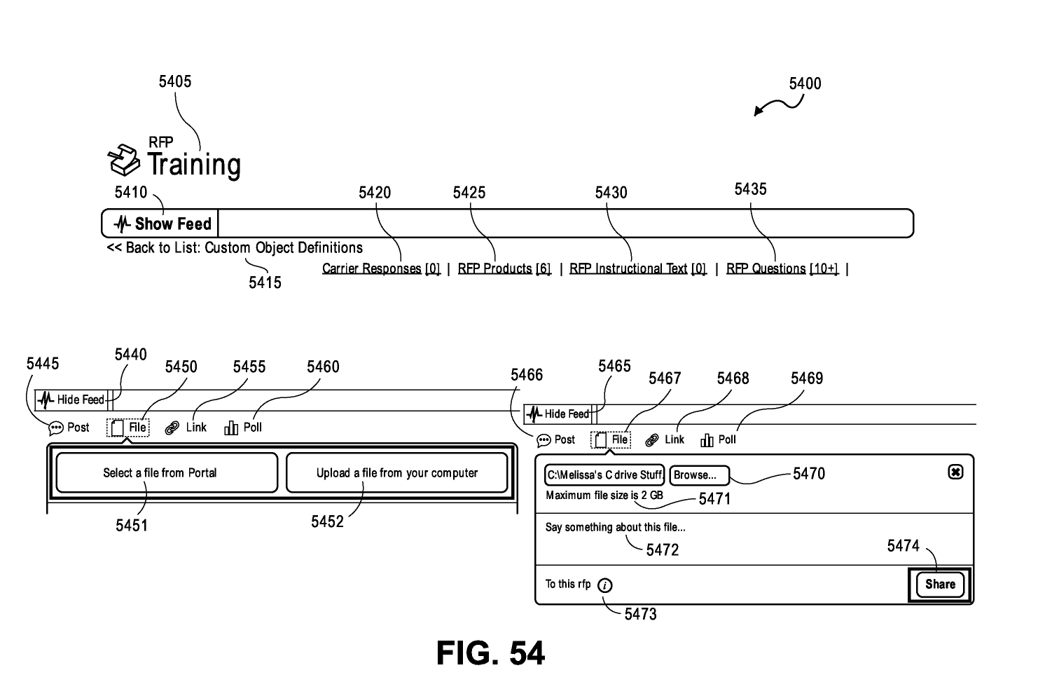

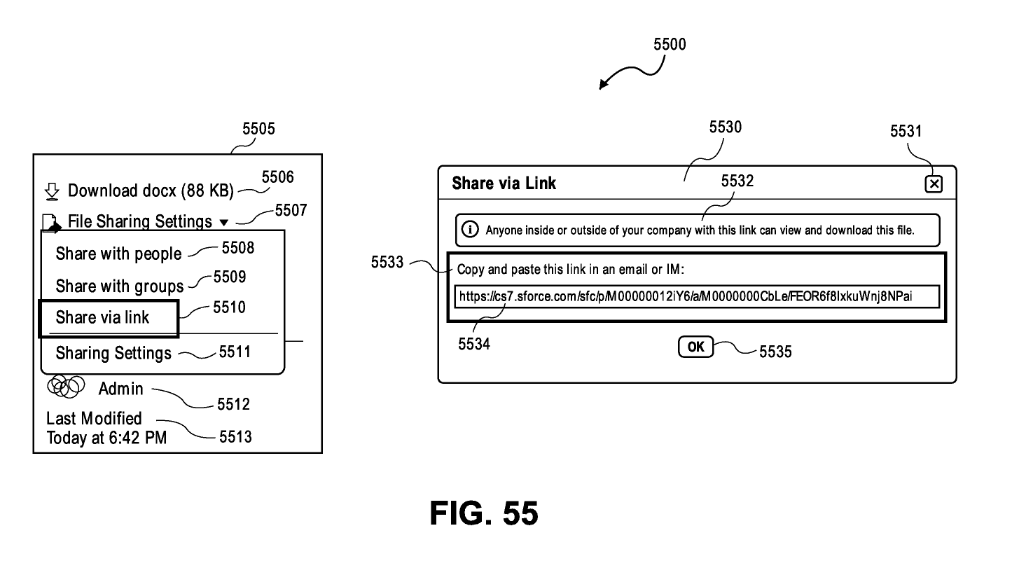

With reference to FIGS. 54 and 55, example user interfaces for sharing documents related to requests for proposals (RFPs) and/or requests for information (RFIs) 5400, 5500 are depicted. The user interface 5400 may include a RFP/RFI title 5405, a show feed indication 5410, a back to list custom object definitions indication 5415, a carrier responses selection link 5420, a RFP/RFI products link 5425, a RFP/RFI instructional text selection link 5430, a RFP/RFI questions selection link 5435, a hide feed selection icon 5440, a post selection icon 5445, a file selection icon 5450, a link selection icon 5455, a poll selection icon 5460, a select a file from portal selection link 5451, an upload a file from your computer selection link 5452, a hide feed selection icon 5465, a post selection icon 5466, a file selection icon 5467, a link selection icon 5468, a poll selection icon 5469, a file entry field with browse selection icon 5470, a maximum file size indicator 5471, a say something about this file entry field 5472, a to this rfp/rfi selection icon 5473 and a share selection icon 5474. When a RFP/RFI is created, a chatter feed for that RFP/RFI may be automatically created. Users may automatically have access to this feed, but sharing it with other individuals may require an additional secure step. The sharing process may happen at the same time that the RFP/RFI is open for response (via the RFP/RFI Portal Email user interface included in, for example, FIG. 55). The user interface 5500 may include a first sub-window 5505 having a download docx selection link 5506, a file sharing settings selection link 5507, a share with people selection link 5508, a share with groups selection link 5509, a share via link selection link 5510, a sharing settings selection link 5511, an admin selection link 5512 and a last modified indication 5513. The user interface 5500 may further include a second sub-window 5530 having an exit selection icon 5531, an information banner 5532, a copy and paste this link in an email or IM instruction 5533, a URL entry field 5534, and an OK selection icon 5535. Only one file may be attached per link, however, all RFP/RFI documents may be combined into, for example, one ZIP file before uploading the attachment to the chatter feed. The maximum size for file attachments may be, for example, 2 GB, so all RFP/RFI related documents will easily fit into this parameter. If the RFP/RFI has any excluded products: multiple chatter feeds and links may be created to share documents with the individual carrier(s). Individual emails may be sent to insurance carriers based on the products they are bidding on; each email may contain a custom chatter feed link that contains only the product-specific materials for that carrier. RFP/RFI files may be securely shared by: 1) Accessing the chatter feed by clicking the show feed link 5410 at the top of the user interface 5400; 2) selecting the file selection icon 5450, 5467 and upload, for example, on ZIP file that contains all related RFP/RFI material from the RFP/RFI portal and/or the associated user computer; 3) share the zip file in this RFP/RFI chatter feed by selecting the share selection icon 5474; 4) selecting the file and select to share it with a private link—Share via link 5530; 5) copy the link and paste it into the RFP/RFI portal email 5534 user interface as described elsewhere herein; 6) carriers can access and download all of the RFP/RFI files as needed; and 7) separate zip files and links may be created for carriers with excluded products.

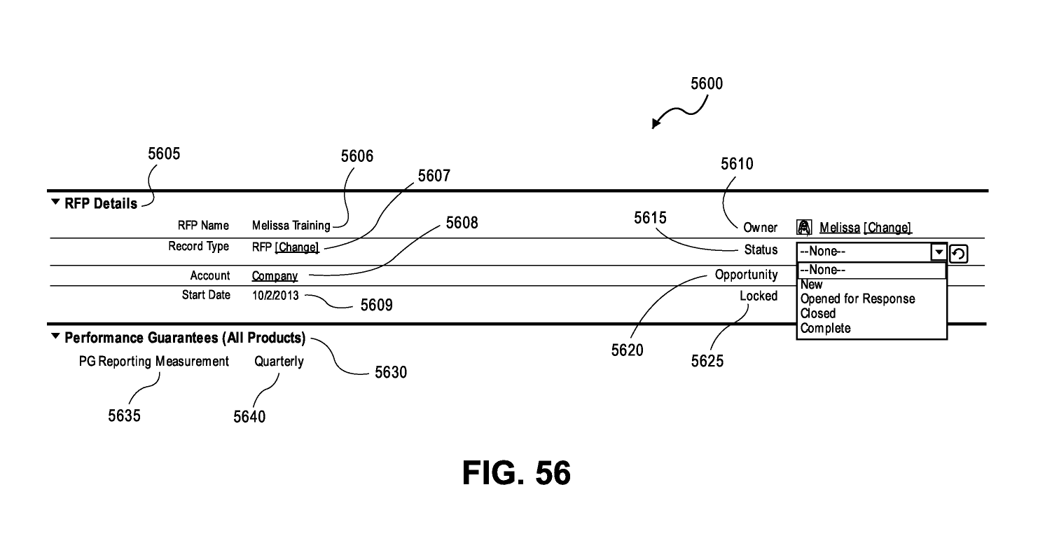

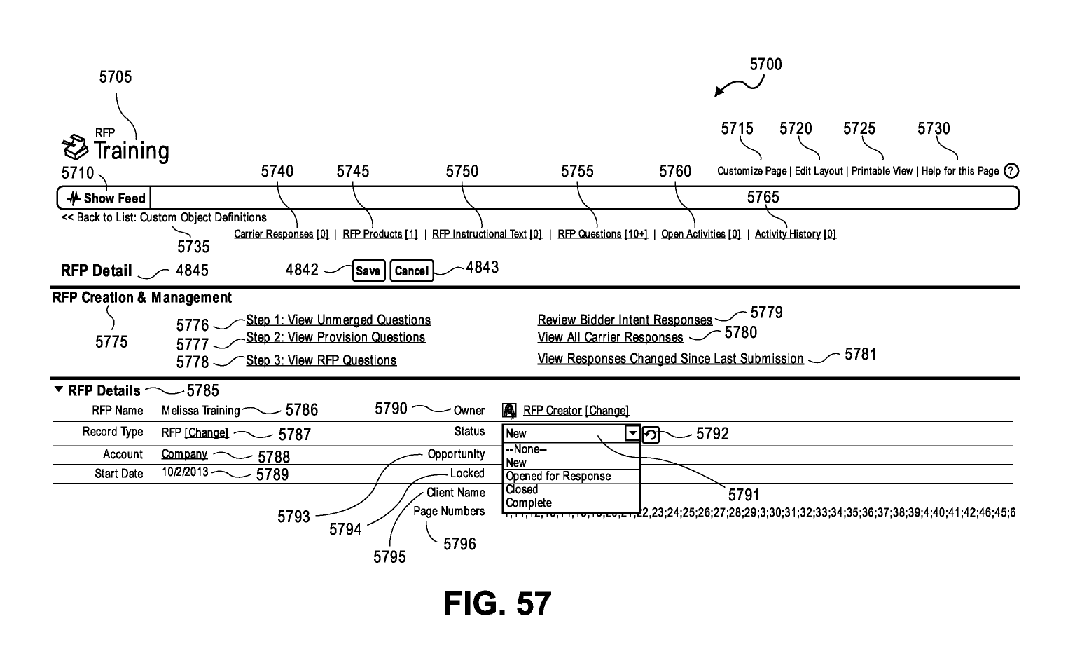

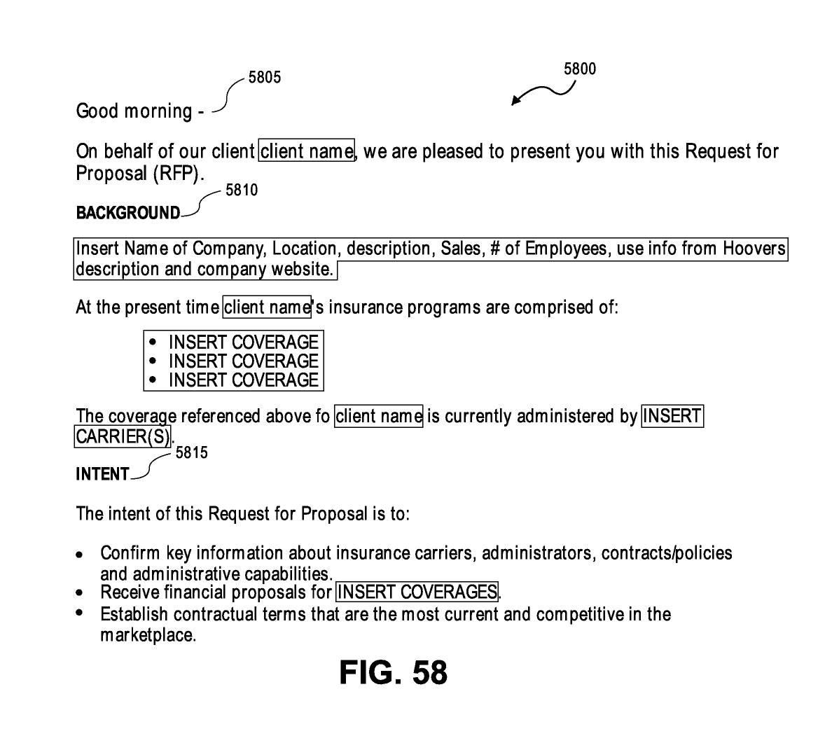

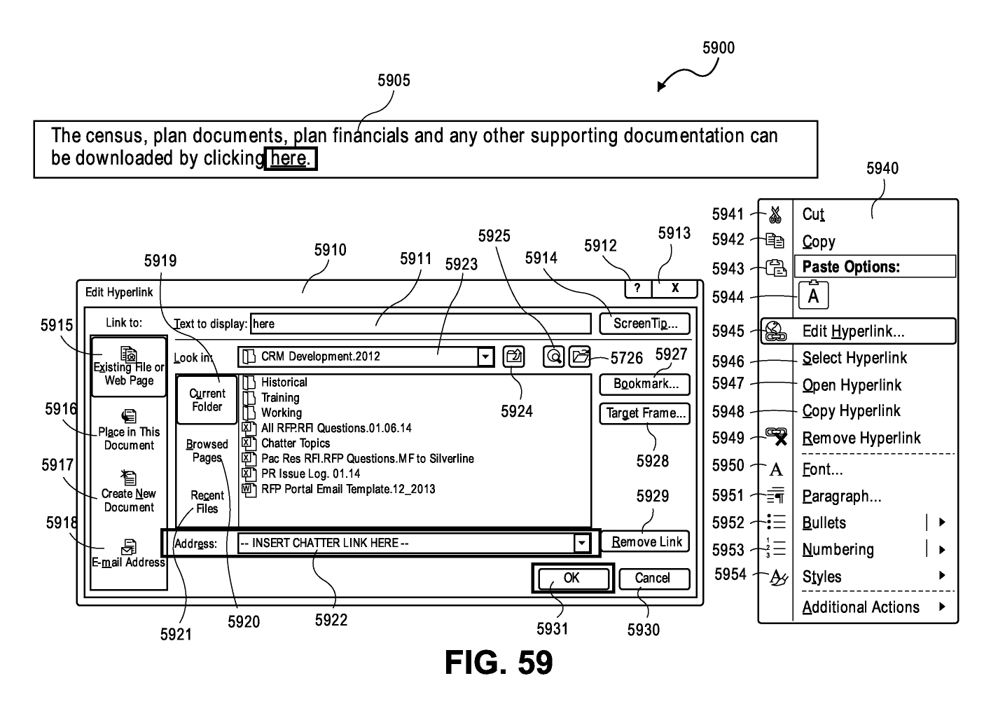

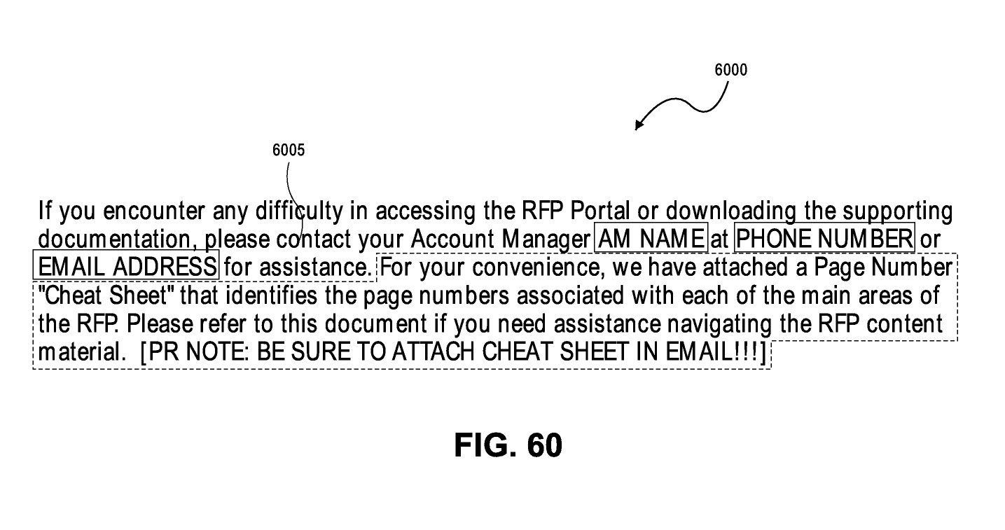

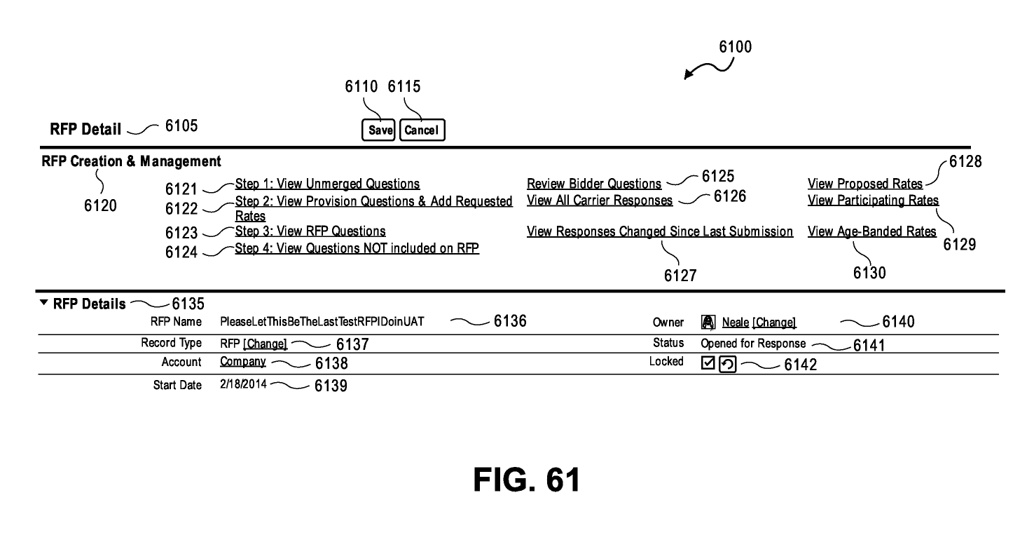

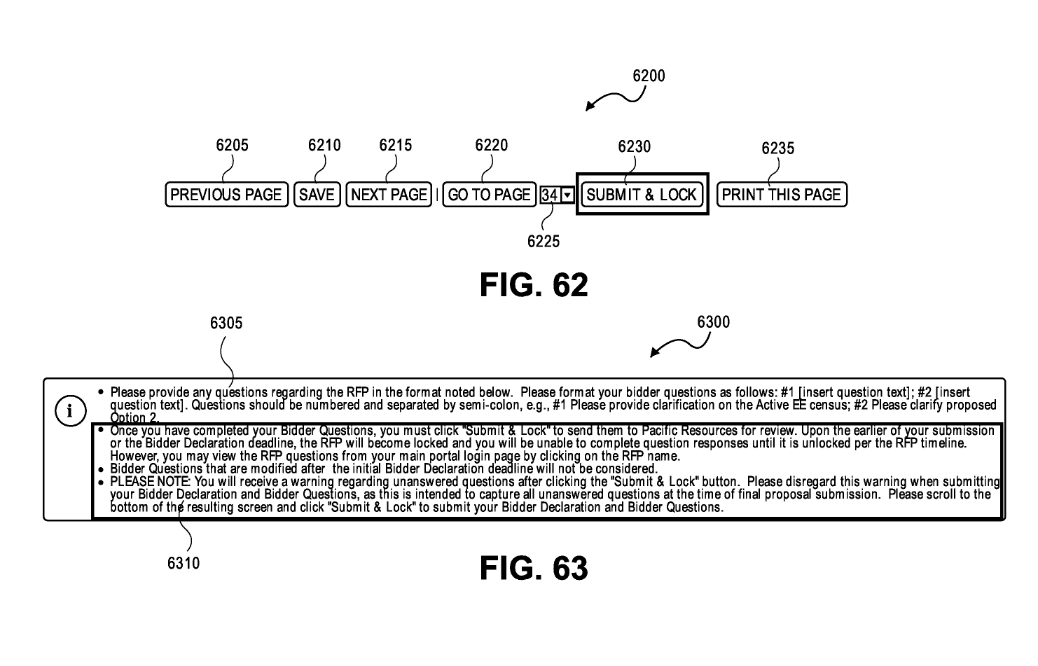

Turning to FIGS. 56-63, example user interfaces for locking, submitting and opening requests for proposals (RFPs) and/or requests for information (RFIs) for carrier response 5600, 5700, 5800, 5900, 6000, 6100, 6200, 6300 are depicted. The user interface 5600 may include a RFP/RFI details information area 5605 and a performance guarantees (all products) information area 5630. The RFP/RFI details information area 5605 may include a RFP name 5606, a record type 5607, an account 5608, a start date 5609, an owner 5610, a status 5615, an opportunity 5620, and a locked indication 5625. The performance guarantees (all products) information area 5630 may include a PG reporting measurement column, and a quarterly column 5640.

The user interface 5700 may include a RFP/RFI title 5705, a show feed selection icon 5710, a customize page selection link 5715, an edit layout selection link 5720, a printable view selection link 5725, a help for this page selection link 5730, a back to list: custom object definitions selection link 5735, a carrier responses selection link 5740, a RFP products selection link 5745, a RFP instructional text selection link 5750, a RFP questions selection link 5755, an open activities selection link 5760, an activity history selection link 5765, a save selection icon 5736, a cancel selection icon 5737, a RFP/RFI details information area 5770, and an RFP/RFI details area 5785. The RFP/RFI details information area 5770 may include a step 1 selection link 5776, a step 2 selection link 5777, a step 3 selection link 5778, a review bidder intent responses selection link 5779, a view all carrier responses selection link 5780, and a view responses changed since last submission selection link 5781. The RFP/RFI details area 5785 may include a RFP/RFI name 5786, a record type 5787, an account 5788, a start date 5789, an owner selection link 5790, a status pull-down selection menu 5791 with refresh selection icon 5792, an opportunity selection 5793, a locked selection 5794, a client name entry field 5795, and a page numbers indication 5796. To open the RFP/RFI to the Carriers, open the RFP/RFI record and change the Status to Opened for Response and Save the RFP. This may make the RFP/RFI immediately available in the portal for view and response. However, insurance carriers may not know to access the portal until the portal instructions and chatter feed are delivered via the RFP/RFI Portal Email user interface of, for example, FIG. 55.

The user interface 5800 may include an opening comment 5805, a background section 5810, and an intent 5815. The user interface 5900 may include an information selection banner 5905, an edit hyperlink sub-window 5910, and a file management sub-window 5940. The edit hyperlink sub-window 5910 may include a test to display entry field 5911, a help selection icon 5912, an exit selection icon 5913, a screen tip selection icon 5914, an existing file or web page selection icon 5915, a place in this document selection icon 5916, a create new document selection icon 5917, an e-mail address selection icon 5918, a current folder selection icon 5919, a browsed pages selection icon 5920, a recent files selection icon 5921, an address entry field 5922, a look in: entry field 5923 with a file open selection icon 5924, a search selection icon 5925, and a file open selection icon 5926, a bookmark selection icon 5927, a target frame selection icon 5929, a cancel selection icon 5930, and an OK selection icon 5931. The file management sub-window 5940 may include a cut selection icon 5941, a copy selection icon 5942, a paste selection icon 5943, an A selection icon 5944, an edit hyperlink selection icon 5945, a select hyperlink selection icon 5946, an open hyperlink selection icon 5947, a copy hyperlink selection icon 5948, a remove hyperlink selection icon 5949, a font selection icon 5950, a paragraph selection icon 5951, a bullets selection icon 5952, a numbering selection icon 5953, a styles selection icon 5954, and an additional actions selection icon 5955. Update the Chatter Feed hyperlink in the document based on the link you created earlier: From the template, right click the word “here” in the third paragraph under the timeline table, Edit the existing “dummy” hyperlink; Replace the Chatter Feed Hyperlink in the Address field as noted below, then click OK.

The user interface 6000 may include an information banner 6005. After all updates to the RFP/RFI template have been made, the template may be saved within an RFP/RFI subfolder on the shared drive. Copy and paste the text from the template into email and deliver as needed, making sure to include the Page Number Cheat Sheet and deleting the reference to the Cheat Sheet in the template as noted below. Continue to copy and paste the email template as needed based on Excluded Products and the different Chatter Feed Links created for the RFP/RFI. Send RFP/RFI emails to the Carriers. In the old RFP/RFI process, additional work began immediately after the RFP/RFI was released to the Carrier, such as preparation of the chapter documents to allow for combined Carrier responses. Because the RFP/RFI portal may generate those chapter documents with the push of a button, there is more time available to actively manage the RFP/RFI process and prepare for the Executive Summary and Finalist Meetings. Generally, the next few immediate steps include: Gathering & distributing Bidder Questions; Initial preparation of the Executive Summary Powerpoint presentation; Refer to the Service Process Checklist for an itemized list of tasks.

The user interface 6100 may include an RFP/RFI detail area 6105, a save selection icon 6110, a cancel selection icon 6115, a RFP/RFI creation and management area 6120, and a RFP/RFI details area 6135. The RFP/RFI creation and management area 6120 may include a step 1 selection link 6121, a step 2 selection link 6122, a step 3 selection link 6123, a step 4 selection link 6124, a review bidder questions selection link 6125, a view all carrier responses selection link 6126, a view responses changed since last submission selection link 6127, a view proposed rates selection icon 6128, a view participating rates selection link 6129, and a view age-banded rates selection link 6130.

The RFP/RFI will remain viewable in the Carrier portal, but no changes can be made by the Carrier until you manually unlock the RFP/RFI the following morning. This allows the Carrier the opportunity to continue researching answers to the RFP/RFI questions being asked, but limits their ability to submit additional Bidder Questions after the deadline has passed.

Once the deadline has passed, be sure to unlock the RFP/RFI the following morning, by double clicking the Locked checkbox (so it is blank) and clicking Save.

The user interface 6200 may include a previous page selection icon 6205, a save selection icon 6210, a next page selection icon 6215, a go to page selection icon 6220, a page pull-down selection menu 6225, a submit and lock selection icon 6230, and a print this page selection icon 6235. The user interface 6300 may include a first information area 6305 and a second information area 6310. When the above steps have been completed, the RFP/RFI may be open for response within an insurance carrier portal. A service process checklist may be updated to show the following tasks needed to prepare for, create and release a RFP/RFI: RFP/RFI Data Loaded (Plan Design, Admin, Rates); RFP/RFI Created; RFP/RFI Details Completed; RFP/RFI Minor Lines of Coverage (LOC's) Added; RFP/RFI Questions Added; RFP/RFI Questions Reviewed for Mergefield Issues; RFP/RFI Question Provisions Reviewed and Added; Requested Rates Added; ALL RFP/RFI Questions Reviewed & Modified; Carrier Portal Review of RFP/RFI using Sample Carrier Login; Carrier Responses Created; Carrier Product Exceptions Added; and RFP/RFI Chatter Feed Updated. The following status' may be available for a RFP/RFI: New: Used during RFP/RFI creation, only visible to Pac Res users; Opened for Response: Available for viewing by Carriers who were granted access to this RFP; Closed: A RFP/RFI whose final deadline has passed; and Complete: A RFP/RFI with a final decision. In some RFP/RFI processes, additional work may begin immediately after the RFP/RFI is released to the carrier, such as preparation of the chapter documents to allow for combined carrier responses. Because the RFP/RFI portal may generate those chapter documents with the push of a button, there is more time available to actively manage the RFP/RFI process and prepare for an executive summary and finalist meetings. Generally, the next few steps may include: Gathering & distributing Bidder Questions; Initial preparation of the Executive Summary Powerpoint presentation; and Refer to the Service Process Checklist for an itemized list of tasks. For each phase of the RFP/RFI timeline, insurance carriers may review and submit their responses to meet established deadlines as outlined in the RFP/RFI timeline herein. Examples of these rounds include: Intent to Bid/Bidder Declarations; Final RFP/RFI Submission; The RFP/RFI may be manually locked at a bidder declaration deadline (e.g., 4:00 CST on date provided in timeline). For example, all insurance carriers may be locked out until the following morning when the RFP/RFI is released for completion. The RFP/RFI may lock on the earlier of: a final submission deadline (manual lock by RFP/RFI Manager), or a date the insurance carrier clicks a submit and lock selection icon. Additional instructions may included at the top of the insurance carrier portal regarding a warning that will be displayed after clicking, for example, a submit and lock selection icon for bidder declaration and bidder question submission, as outlined on the next slide. Compiling bidder questions is easier in the RFP/RFI tool, as individual question categories may be established and a report may be available to compile the questions. From a main RFP/RFI user interface, a review bidder questions report selection icon may be selected. Similar to an unmerged and view all questions reports selection icon, these questions can be exported to Excel for review and completion. An Excel file may be sorted by question type, remove duplicates and use it to gather all additional information from the incumbent Carrier and/or the client. After the bidder questions are completed, the document (minus Carrier Response Name) may be saved and redistribute via the RFP/RFI chatter feed.

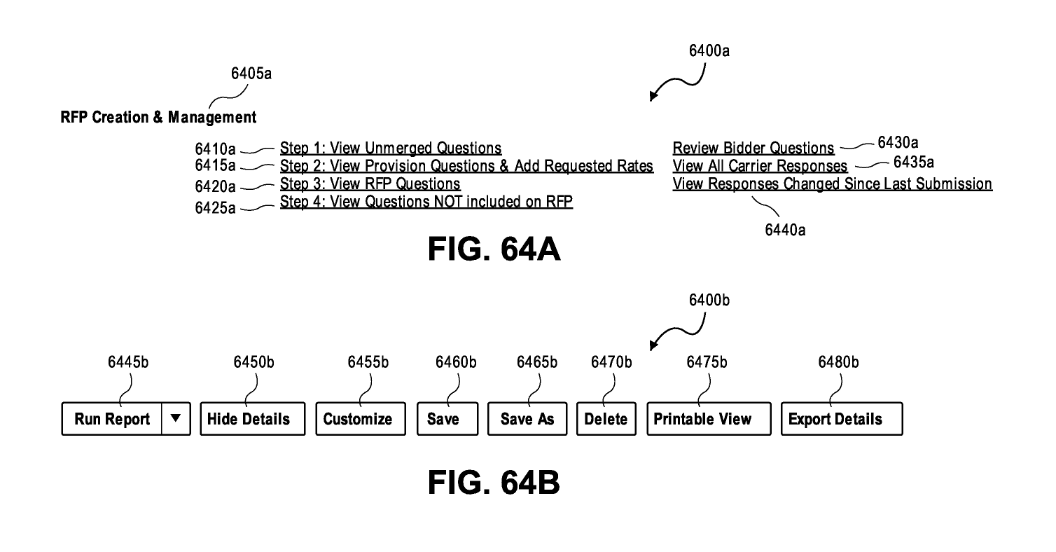

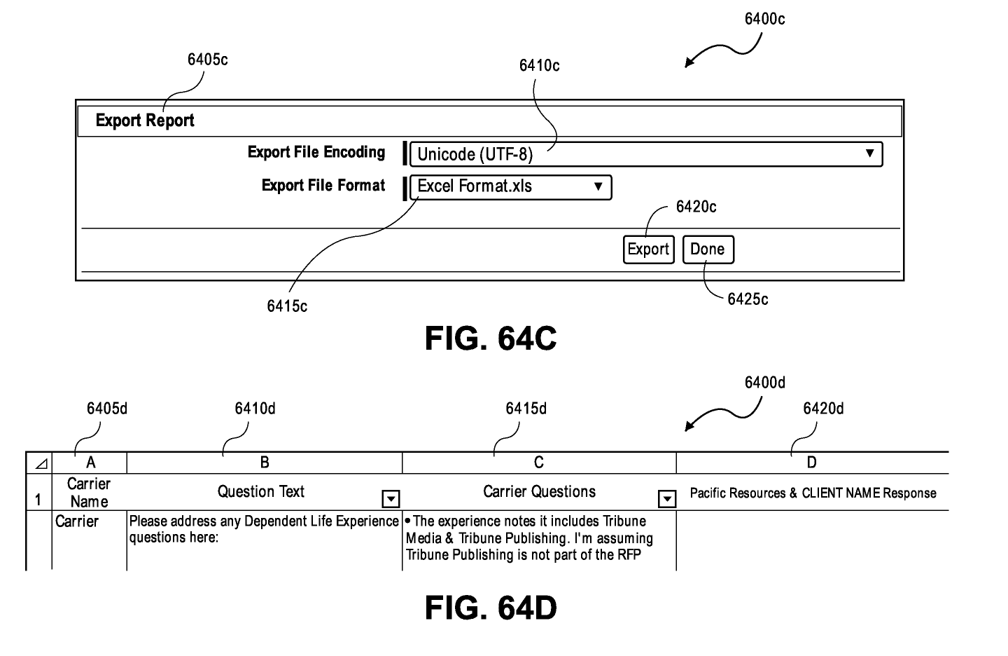

With reference to FIGS. 64A-D, example user interfaces for generating carrier questions when creating and responding to requests for proposals (RFPs) and/or requests for information (RFIs) 6400A-D are depicted. The user interface 6400a may include an RFP/RFI creation and management area 6405a, a step 1 selection link 6410a, a step 2 selection link 6415a, a step 3 selection link 6420a, a step 4 selection link 6425a, a review bidder question selection link 6430a, a view all carrier responses selection link 6435a, and a view responses changed since last submission selection icon 6440a. The user interface 6400b may include a run report selection pull-down selection menu 6445b, a hide details selection icon 6450b, a customize selection icon 6455b a save selection icon 6460b, a save as selection icon 6465b, a delete selection icon 6470b, a printable view selection icon 6475b, and an export details selection icon 6480b.

The user interface 6400c may include an export report title 6405c, an export file encoding selection pull-down menu 6410c, an export file formal selection pull-down menu 6415c an export selection icon 6420c, and a done selection icon 6425c. The user interface 6400d (e.g., an Excel file) may include a carrier name column 6405d, a question text column 6410d, a carrier question column 6415d, and a RFP portal host and client name response column 6420d. To generate Bidder Questions: 1) a user may select the review bidder questions selection link 6430a; 2) the user may select the export details selection icon 6480b; 3) the user may select the export selection icon 6420c (without changing any of the default settings); 4) the exported Excel file 6415c may require some formatting adjustments, suggested formatting changes may include: change the headers as follows: Merged Text->Topic, Response Text->Carrier Question, Response Status: Key Contact: Account Name->Carrier Name, Move the Carrier Name column to the first column on the spreadsheet and adjust column width as needed, Add a column at the end for your question response, Show Gridlines (from the View tab) or add Borders, Adjust formatting of entire spreadsheet to Left Top Justified & Landscape Orientation; add page numbers to footer, Format the header row: Center justified, PacRes Blue (R:120, G:124, B:187) with BOLD white font, Freeze Top Row & Repeat Top row on each page; 5) the user may remove carrier responses that do not apply, e.g., We have no questions at this time, None, No additional Questions, etc.; 6) if carriers have provided multiple questions within their response, separate them into their own row by copying the row, pasting and removing questions as needed so there is only one question per row. Be sure to keep the Carrier name associated with each individual question; 7) the user may sort questions by topic and may remove any duplicate questions; 8) the user may research questions as addressed in the service process checklist; 9) the user may remove the carrier name from the spreadsheet (save a new version without names) and provide a response via the chatter feed associated with the RFP/RFI.

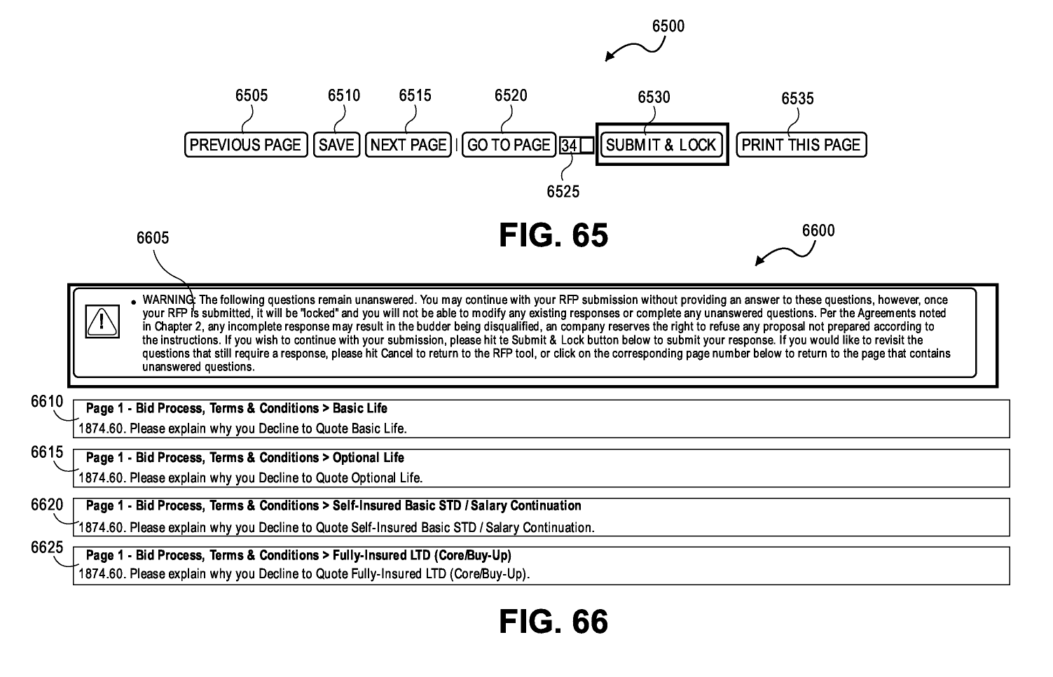

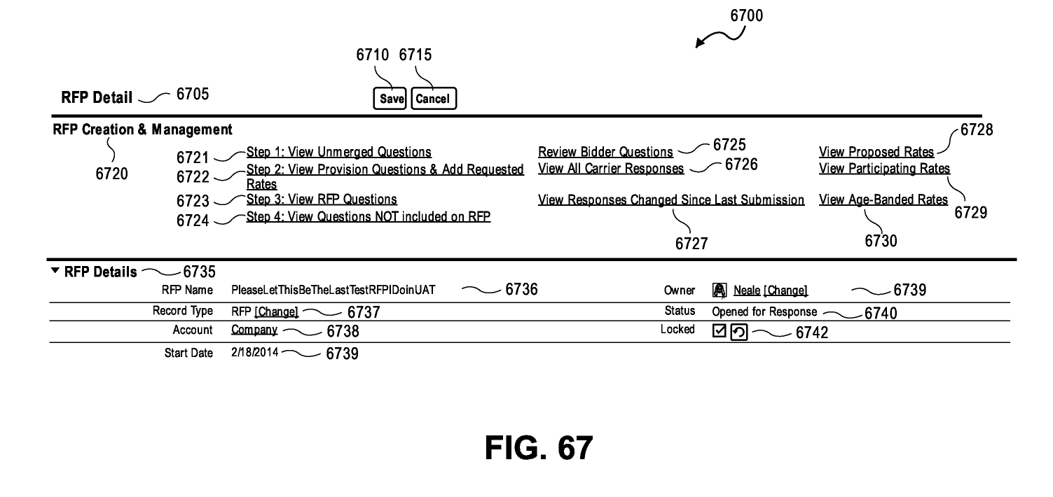

Turning to FIGS. 65-67, example user interfaces submitting requests for proposals (RFPs) and/or requests for information (RFIs) 6500, 6600, 6700 are depicted. The user interface 6500 may include a pervious page selection icon 6505, a save selection icon 6510, a next page selection icon 6515, a go to page selection icon 6520 with page selection pull-down menu 6525, a submit and lock selection icon 6530, and a print this page selection icon 6535. The user interface 6600 may include an information banner 6605, a page 1—bid process, terms and conditions, basic life information area 6610, a page 1—bid process, terms and conditions, optional life information area 6615, a page 1—bid process, terms and conditions, self-insured basic std/salary continuation information area 6620, and a page 1—bid process, terms and conditions, fully-insured LTD (core/buy-ups) information area 6625. The user interface 6700 may include a RFP/RFI detail area 6705 having a RFP/RFI creation and management area 6720, a save selection icon 6710, a cancel selection icon 6715, and a RFP/RFI details area 6735. The RFP/RFI creation and management area 6720 may include a step 1 selection link 6721, a step 2 selection link 6722, a step 3 selection link 6721, a step 4 selection link 6724, a review bidder questions selection link 6725, a view all carrier responses selection link 6726, a view responses changed since last submission selection link 6727, a view proposed rates selection link 6728, a view participating rates selection link 6729, and a view age-banded rates selection link 6730. The RFP/RFI details area 6735 may include a RFP/RFI name 6736, a record type 6737, an account identification 6742, a start date 6738, an owner selection link 6739, a status indication 6740, and a locked selection check box 6741 with undo. To submit a final RFP/RFI response, an insurance carrier may: 1) select the submit and lock selection icon 6530, 2) review all questions that were not filled out; and 3) select the submit and lock selection icon 6530 to submit the RFP/RFI to the requestor. As part of the Submit & Lock process, the RFP/RFI portal may identify which questions have not been filled out by the carrier and display the questions for review. The carrier may click into each page to complete the questions before the final submit and lock, or submit without providing additional information. To manually lock the RFP/RFI per a RFP/RFI timeline, the locked checkbox may be double selected and the save selection icon 6710 may be selected when done. The RFP/RFI status may not be changed. Carriers may provide an updated response to certain provisions or rates. As noted in the RFP/RFI Portal Email Template: “All correspondence regarding your proposal may be submitted to the RFP/RFI requestor via the RFP/RFI Portal. Any additional documentation supplied outside of the portal will not be considered in the bidder evaluation process.” As long as the RFP/RFI remains in open status, limited access may be granted to individual carriers to allow the carrier(s) to modify their initial RFP/RFI response.

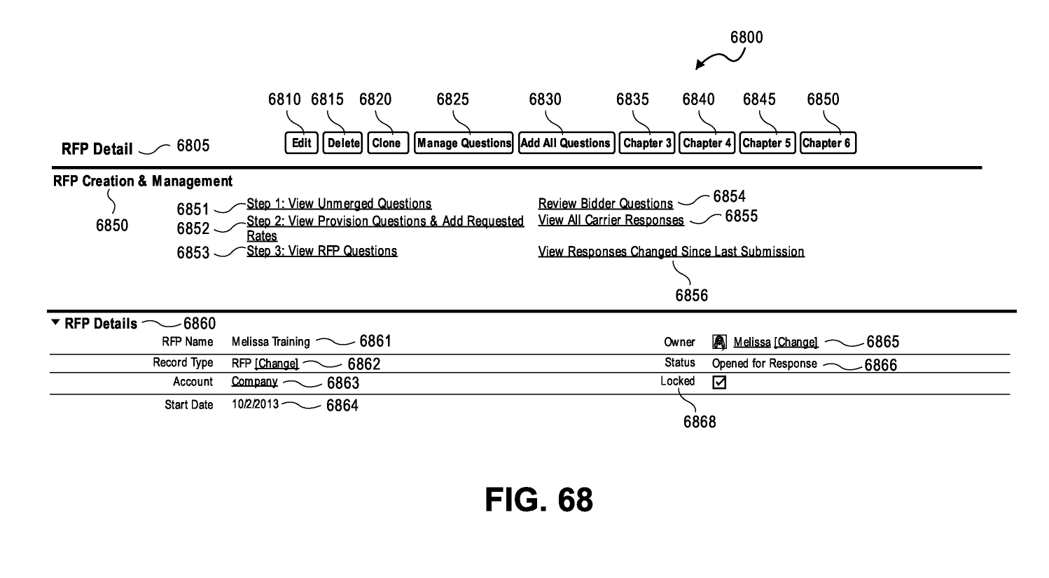

With reference to FIG. 68, an example user interface for locking/unlocking requests for proposals (RFPs) and/or requests for information (RFIs) 6800 may include a RFP/RFI detail area 6805, an edit selection icon 6810, a delete selection icon 6815, a clone selection icon 6820, a manage questions selection icon 6825, an add all question selection icon 6830, a chapter 3 selection icon 6835, a chapter 4 selection icon 6840, a chapter 5 selection icon 6845, a chapter 6 selection icon 6850, a RFP/RFI creation and management area 6850 and a RFP/RFI details area 6860. The RFP/RFI creation and management area 6850 may include a step 1 selection link 6851, a step 2 selection link 6852, a step 3 selection link 6853, a review bidder intent responses selection link 6854, a view all carrier responses selection link 6855, and a view responses changed since last submission selection link 6856. The RFP/RFI details area 6860 may include a RFP/RFI name 6861, a record type 6862, an account identification 6863, a start date 6864, an owner selection link 6865, a status indication 6866, an opportunity identification 6867, and a locked indication 6868. For an “Open” RFP, once a carrier submits and locks, the carrier may update their carrier response status record to locked. To unlock the RFP/RFI for that carrier, the RFP/RFI creator may uncheck the box on the record and the RFP/RFI will be available for editing in the portal. Carriers may contact the RFP/RFI manager to have the RFP/RFI manually unlocked. Once unlocked, the carrier can make the appropriate changes within a set timeframe/deadline established by the RFP/RFI manager. Once the deadline is passed, the RFP/RFI record may be unlocked again by the RFP/RFI manager.

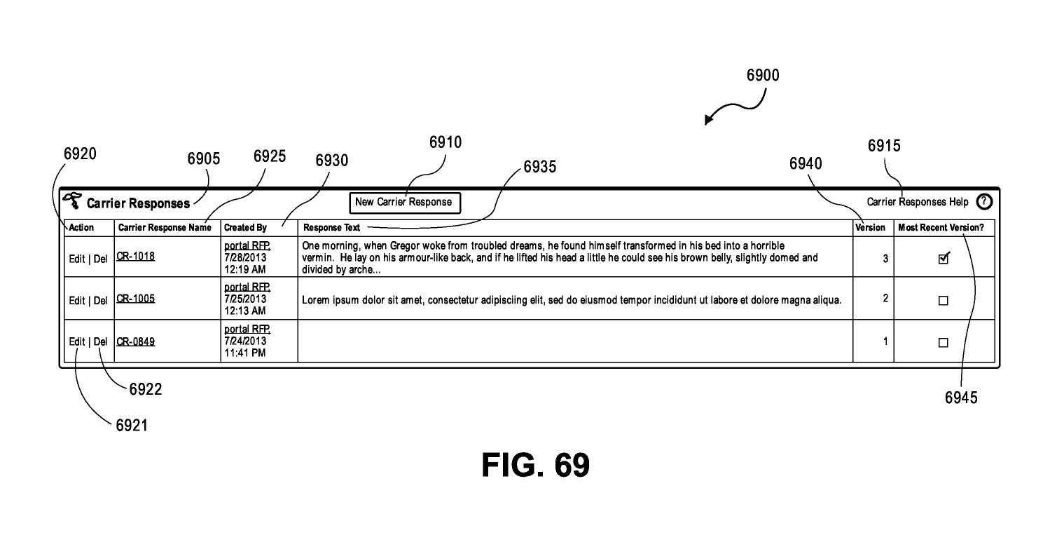

Turning to FIG. 69, an example user interface for version requests for proposals (RFPs) and/or requests for information (RFIs) 6900 may include a carrier response area 6905 having a new carrier response selection icon 6910, a carrier responses help selection link 6915, an action column 6920 with an edit selection link 6921 and a delete selection link 6922, a carrier response name column 6925, a created by selection link column 6930, a response text column 6935, a version identification column 6940, and a most recent version column 6945. Each time a carrier submits and locks the RFP, the RFP/RFI portal may create a ‘version’ of the carrier's answers such that any future answers may be tracked. This may eliminate a need to create an email trail and manual updates of the RFP/RFI chapters based on carrier revisions. By default, each new set of responses may become the ‘most recent version’ such that a user may drill into a question and see a history of responses by the carrier.

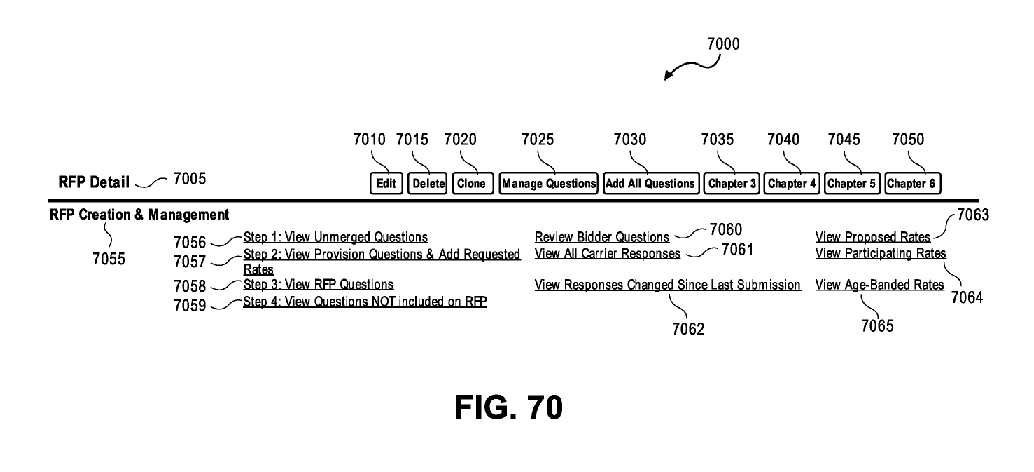

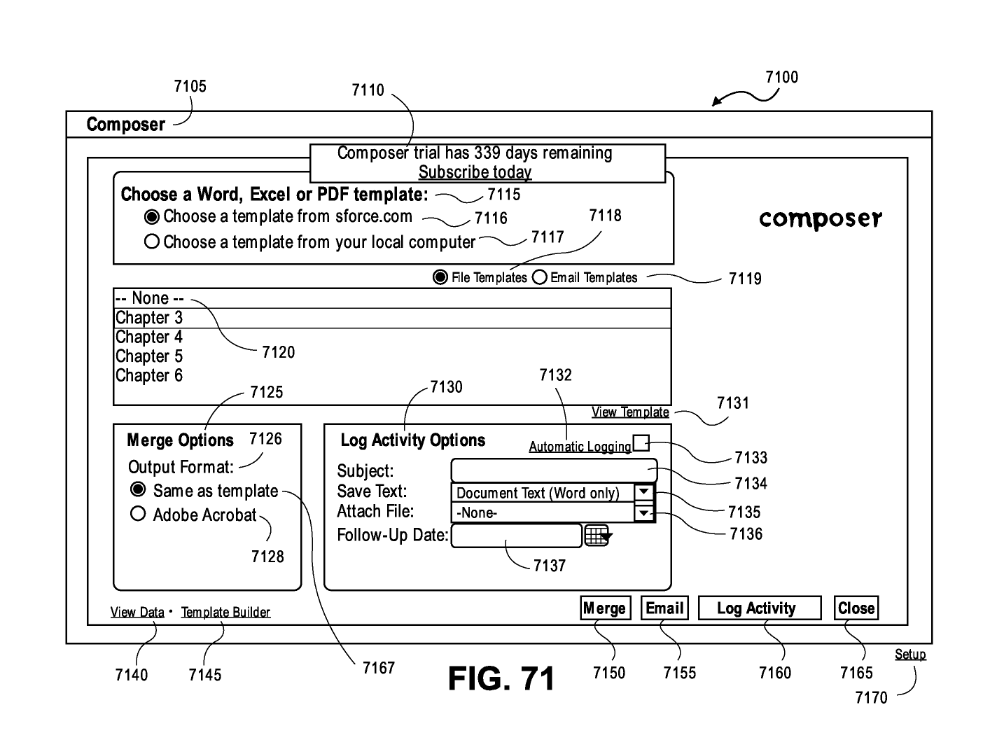

With reference to FIGS. 70 and 71, example user interfaces for generating chapters when creating requests for proposals (RFPs) and/or requests for information (RFIs) 7000, 7100 are depicted. Within the RFP/RFI portal, a user may have the ability to run reports to aggregate carrier responses, carrier response versions, and responses changed since the last submission via the custom links section on the RFP/RFI. Similar to the question library reports, selection of the view responses changed since last submission report selection link 6727 may only provide carrier responses which have been modified since the carrier's initial submission. The user interface 7000 may include an edit selection icon 7010, a delete selection icon 7015, a clone selection icon 7020, a manage questions selection icon 7025, an add all question selection icon 7030, a chapter 3 selection icon 7035, a chapter 4 selection icon 7040, a chapter 5 selection icon 7045, a chapter 6 selection icon 7050, and a RFP/RFI creation and management area 7055 having a step 1 selection link 7056, a step 2 selection link 7057, a step 3 selection link 7058, a step 4 selection link 7059, a review bidder questions selection link 7060, a view all carrier responses selection link 7061, a view responses changed since last submission selection link 706, a view proposed rates selection link 7063, a view participating rates selection link 7064, and a view age-banded rates selection link 7065. Once the RFP/RFI data is provided in the RFP/RFI portal, the ability to generate supporting documentation needed to create an executive summary presentation may be provided. The RFP/RFI portal may not have the ability to output data in a user friendly “Chapter” format, therefore, a Conga Composer may be utilized to translate the data in the RFP/RFI portal to regular chapter format in, for example, a Word, Excel or PDF file format. For example, a chapter 3, 4, 5 or 6 may be created from the main RFP/RFI detail page. From the main RFP/RFI page, a chapter selection icon 7035, 7040, 7045, 7050 may be selected to generate the respective chapter document. Selection of a chapter selection icon 7035, 7040, 7045, 7050 may, for example, launch the Conga Composer in a new window.

The user interface 7100 (e.g., a Conga composer user interface) may include a title 7105, an information banner 7110, an instruction banner 7115, a first selection circle 7116, a second selection circle 7117, file templates selection circle 7118, an email templates selection circle 7119, a chapters pull-down menu selection 7120, a view template selection link 7131, a merge options area having an output format identification 7126, a same as template selection circle 7127, and an adobe acrobat selection circle 7128, a log activity options area 7130, having an automatic logging 7132 selection check box 7133, a subject entry field 7134, a save text pull-down selection menu 7135, an attaché file pull-down selection menu 7136, a follow-up date entry field 7137 with calendar selection, a view data selection link 7140, a template builder selection link 7145, a merge selection icon 7150, an email selection icon 7155, a log activity selection icon 7160, a close selection icon 7165, and a set up selection link 7170. The chapter selected in Conga Composer may match the chapter selected in the RFP/RFI portal. Each chapter may be generated individually by saving the document and returning to the main RFP/RFI detail page 7000. An insurance client logo may be added to the RFP/RFI chapter document header(s).

Turning to FIG. 72, an example list of minor lines of coverage for requests for proposals (RFPs) and/or requests for information (RFIs) 7200 may include a line of coverage name column 7205, a line of coverage code column 7210, a type column 7215, and a coverage (major) column 7220. Separate rate class may be created for retirees; a new plan does not need to be created just for retiree rates if all plan design features are the same as the active plan (only difference is rates). If the retiree benefit is just a flat amount, the retiree's “live” on the active class (under Retiree Benefit Amount). However, a separate rate record may be created for the retirees. While working in the RFP/RFI tool, if a page is open for more than 15 minutes without taking any action, the page may time out and work completed on that page without saving may be lost. A history of plan design changes format may be (mm/dd/yy-mm/dd/yy: INSERT CHANGE—most recent first). EXAMPLE: 1/1/14: 60 day E.P.; 1/1/12-12/21/13: 30 Day E.P. (bulleted list). The history may match the years of experience provided in the RFP/RFI (e.g., 3 years of experience=3 years of historical plan changes). A situs State (QXXXX) may be located on the plan class page under plan detail, above the plan classes section. A contract guarantee period (QXXXX) may be used for contract generation only. The period may be different from the rate change notice (QXXXX), which may be indicative of the timeframe that advance notification of a change in rates that would occur. Funding arrangement may be determined at the plan level rate volumes: the RFP/RFI may not push volumes—the carriers may provide volume to allow evaluation of the carriers quote methodology. Policy Year: performance guarantees may be adjusted if the insurance client utilizes a policy year and not a 1/1 Calendar Year (Q2,746.00 & 2,750.00). Provisions: a user may identify not only what a provision is, but what the provision should be. Any overlapping benefits should be checked, such as EAP overlapping with travel assistance. A “Best In Class” Plan Design may be identified by: add Motorcycle Helmet benefit. A child may be included from birth and not from 14/15 days or have a reduced benefit should be full benefit from birth, include stillbirth in dependent life plan, remove terrorism from all exclusions, pilots and crew to be included if client considers them eligible EEs, intoxication—may be removed from exclusions (e.g., someone intoxicated falls down, hits head and dies—not the same as DUI). Navigation: Ctrl+F allows you to search the text on any given page within The RFP/RFI portal. It is different than the The RFP/RFI portal Search feature, which will pull up individual references containing your search query. Ctrl+F is a great way to find certain provisions on a page or keywords within the question library.

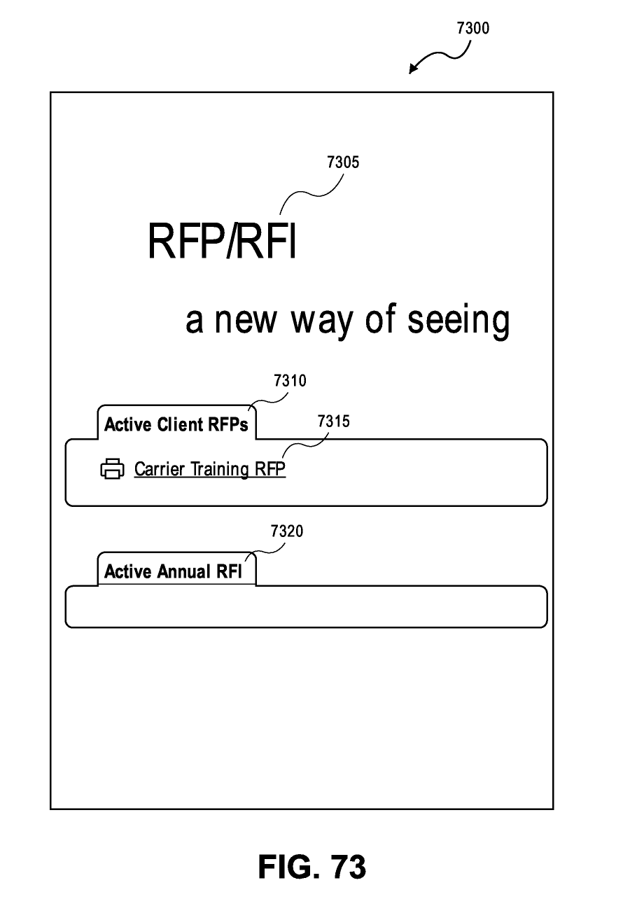

With reference to FIG. 73, an example user interface for displaying requests for proposals (RFPs) and/or requests for information (RFIs) may include a RFP/RFI requestor identification 7305, an active client RFPs selection link 7310, a carrier training RFP/RFI selection link 7315, and an active annual RFI selection link 7320. Upon login, carriers may see all of the active RFPs the carrier has access to. A “locked” icon may appear for RFPs that are no longer Open for Response. A “print” icon may allow the carrier to print an Open RFP, including the Order Number, Question Text & Carrier Response.

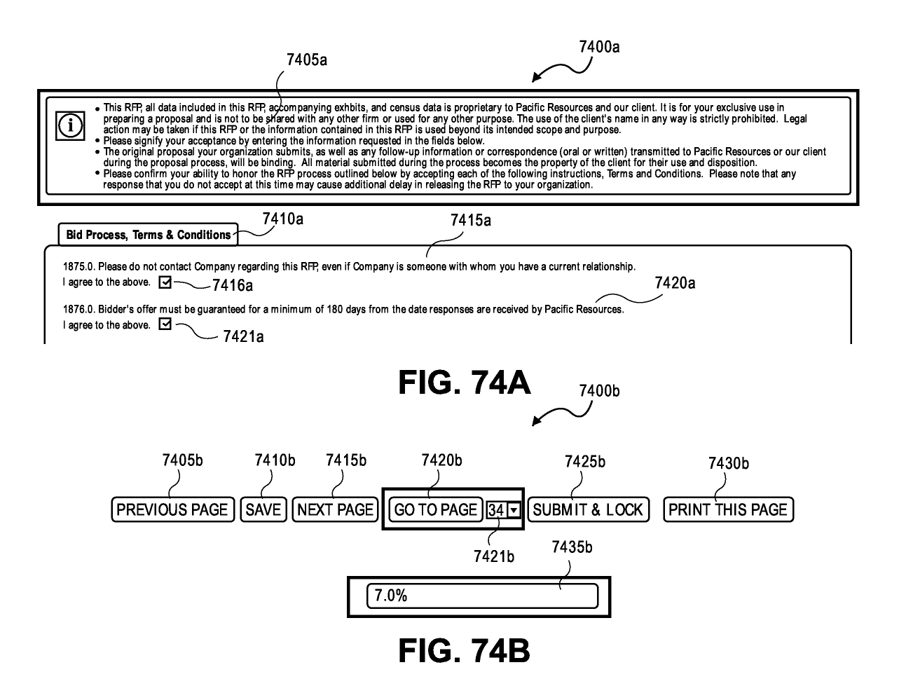

Turning to FIGS. 74A and 74B, example user interfaces for navigating a carrier portal when responding to requests for proposals (RFPs) and/or requests for information (RFIs) 7400A, 7400B are depicted. The user interface 7400a may include an information banner 7405a, a bid process, terms and conditions selection icon 7410a, a first option 7415a having a first option selection check box 7416a, and a second option 7420a having a second option selection check box 7421a. For a new RFP, the portal may automatically open to “Page 1”, which may include instructions and the details 7405a. For RFPs that have already been opened, the portal may automatically open to the last page accessed.

The user interface 7400b may include a previous page selection icon 7405b, a save selection icon 7410b, a next page selection icon 7415b, a go to page selection icon 7420 with a page pull-down selection menu 7421b, a submit and lock selection icon 7425b, a print this page selection icon 7430b, and a percent complete indication 7435b. A user may be led through the RFP/RFI questions that were added via a question wizard. Navigation may be available at a bottom of each page along with a status bar at atop of the page identifies how much of the RFP/RFI has been completed. Page numbers may not be sequential; numbering may be based on a page number associated with each LOC, Plan Class, group and/or subgroup. Page numbers may be missing in the Go To Page dropdown box. Because questions may be tied to specific pages in the RFP/RFI portal, if no questions apply to the RFP/RFI on a particular page, that particular page may not be populate.

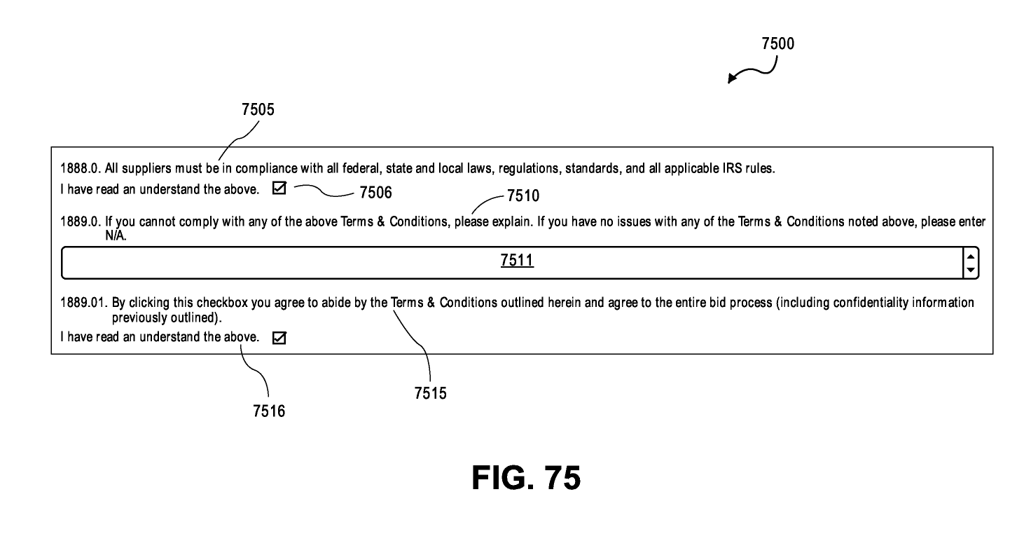

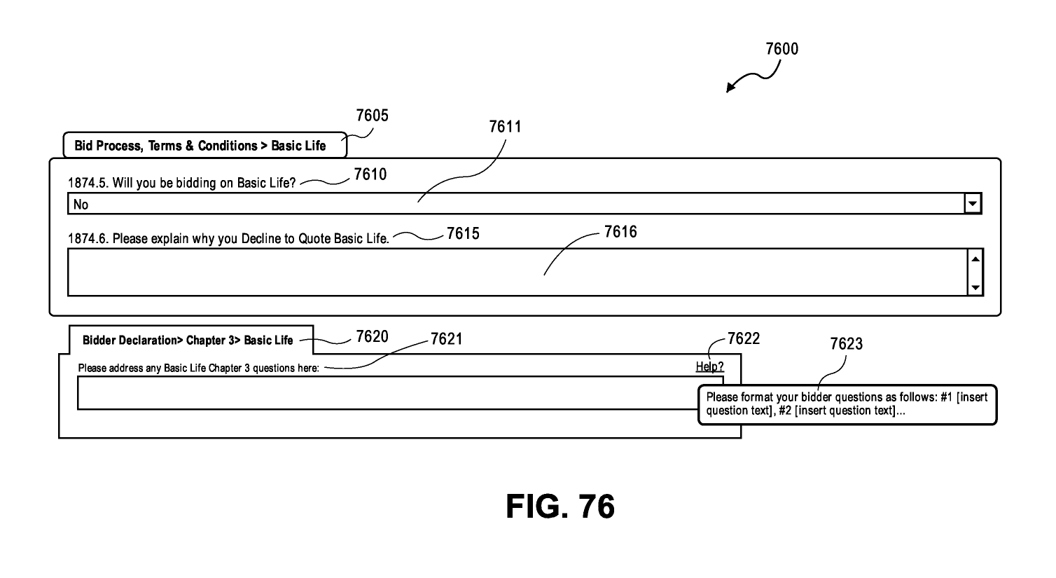

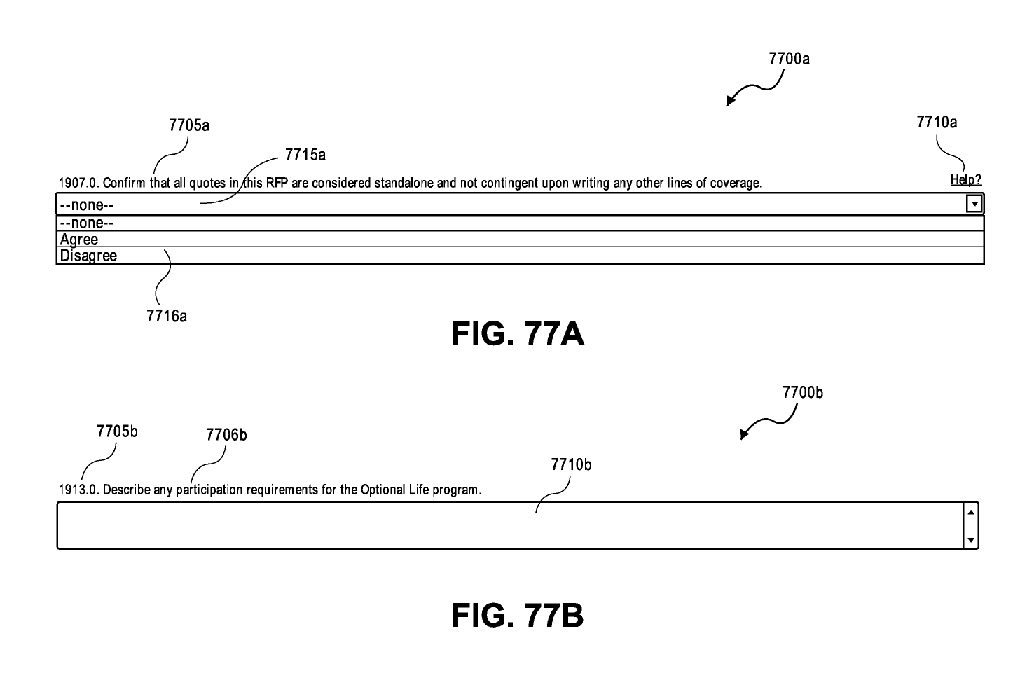

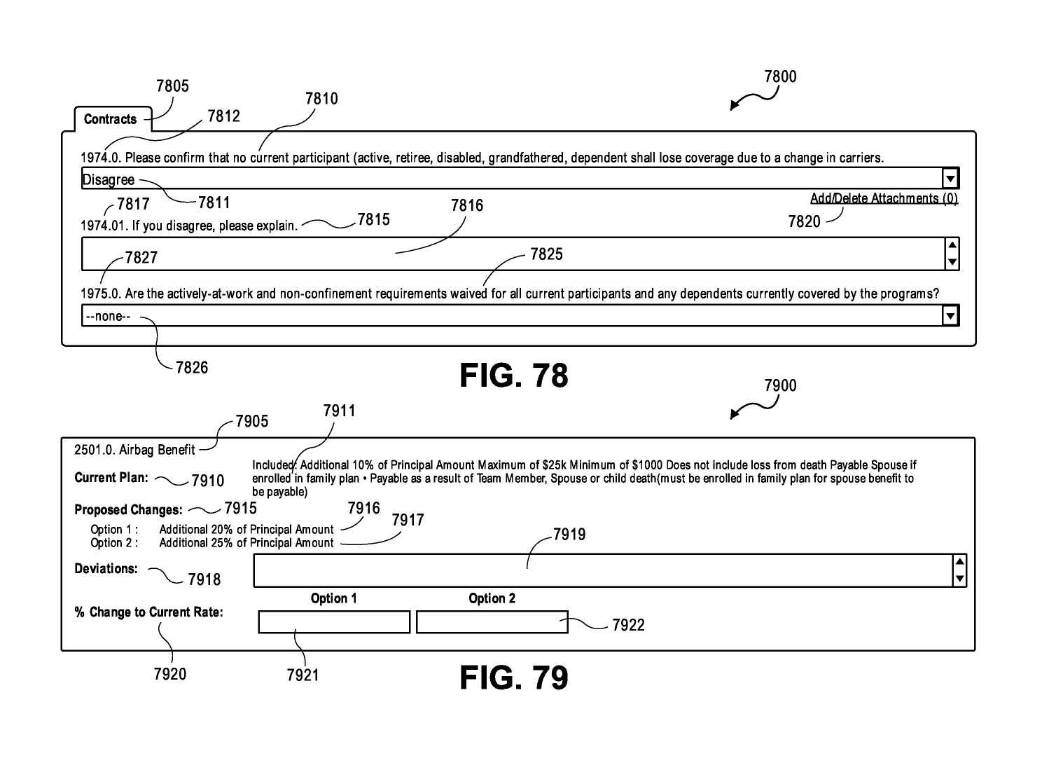

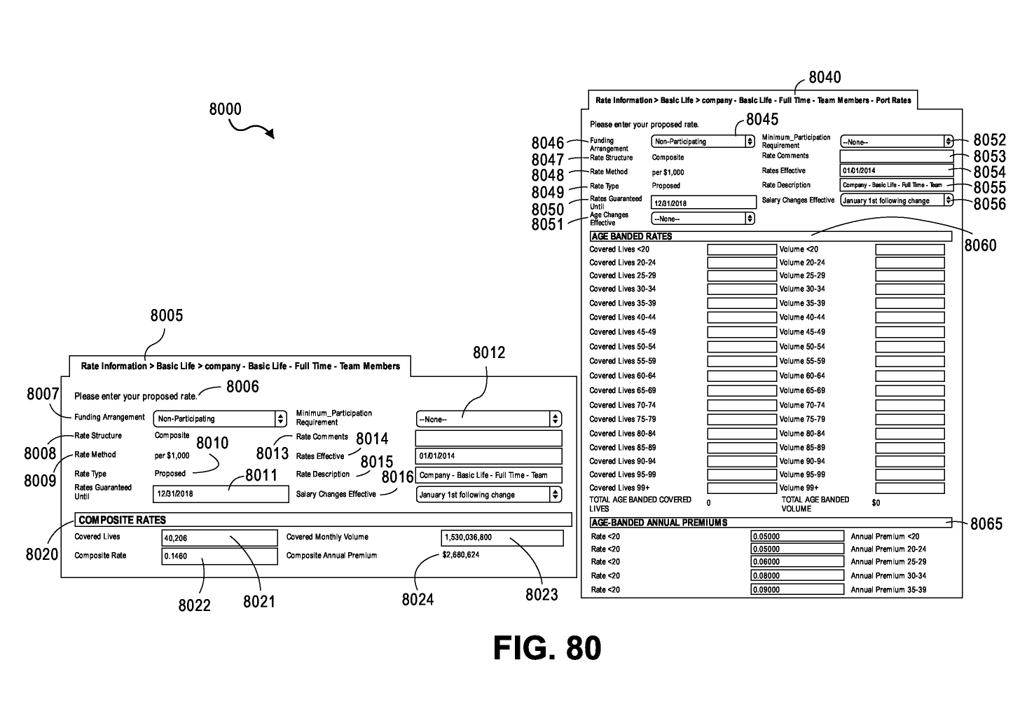

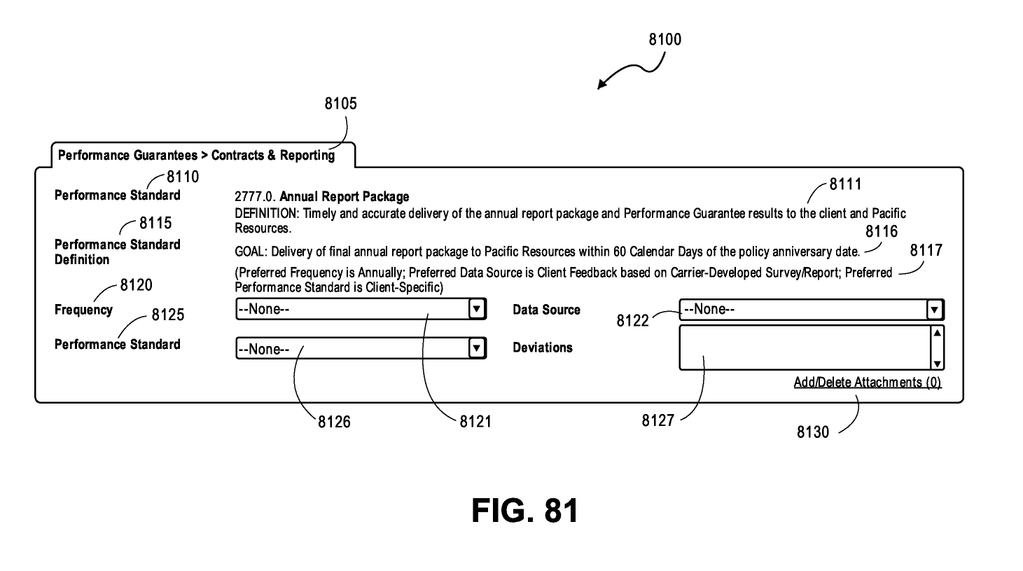

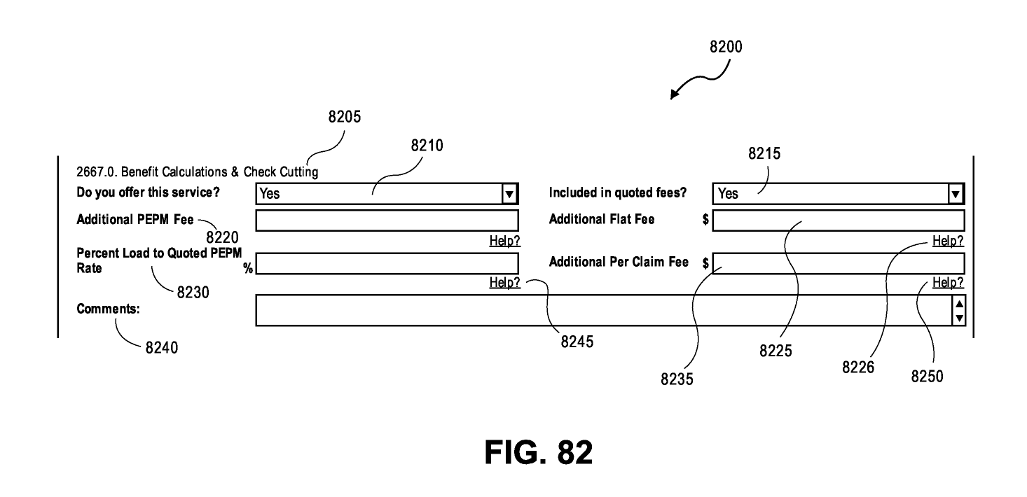

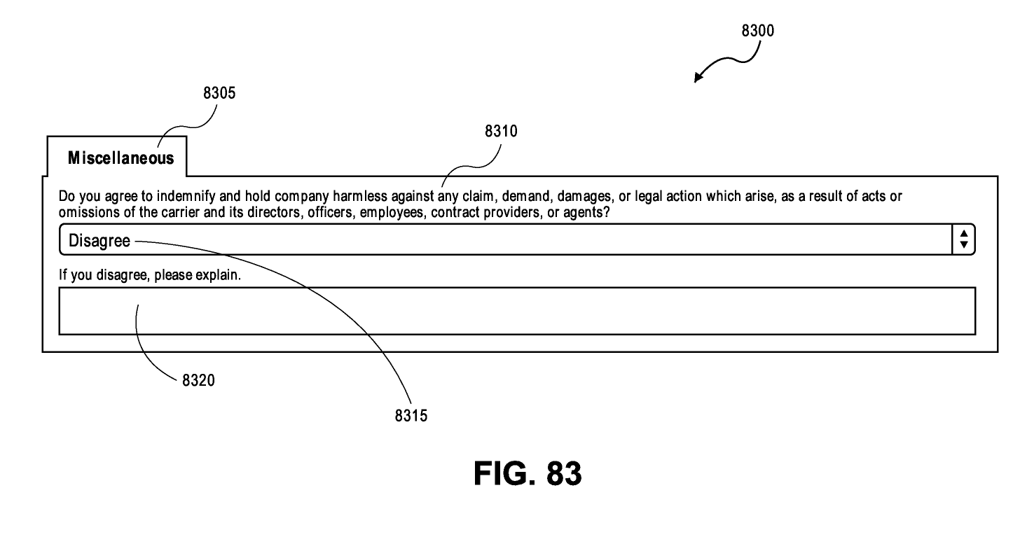

With reference to FIGS. 75-83, example user interfaces for presenting question types when creating and responding to requests for proposals (RFPs) and/or requests for information (RFIs) 7500, 7600, 7700A, 7700B, 7800, 7900, 8000, 8100, 8200, 8300 are depicted. The user interface 7500 may include a first instruction 7505 with a check the box selection 7506, a second instruction 7510 with a response entry field 7511, and an agreement statement 7515 with an agreement check box 7516. Agreement Questions: these questions may appear with only checkboxes as possible responses. Agreement questions may require a response on the page when saving. Agreement questions may only be utilized as part of the instructions for completing the RFP/RFI. An insurance carrier may be given an opportunity to note any issues or concerns with the Terms & Conditions outlined in the RFP/RFI.

The user interface 7600 may include a bid process, terms and conditions, basic life area 7605, have a first question 7610 having a response entry field 7611, an explanation instruction 7615 having an explanation entry field 7616, a bidder declaration, chapter 3, basic life area 7620 having an address entry field 7621, a help selection link 7622, and an information banner 7623. Bidding Questions: these questions may indicate whether the carrier will be bidding on a given coverage. If the carrier indicates the carrier will not be bidding on a specific minor line of coverage (LOC), that exclusion may be added to the RFP/RFI and the subsequent questions may be removed from the RFP/RFI portal visibility. Bidding questions may only be utilized as part of a bidder declaration.

The user interface 7700a may include a confirmation instruction 7705a having a data entry field and a pull-down selection menu response 7716a, and a help selection link 7710. Standard Questions: these questions may have many types of response types, including picklists, text areas, numbers and percentages. Standard Questions may represent a majority of the questions contained in a RFP/RFI. Picklist (or pull-down menu) responses may have a pre-defined set of values to choose from in a drop-down (or pull-down) menu.

The user interface 7700b may include a first question identifier 7705b, a first question text 7706b, and a response entry field 7710b. Text Area responses may be free form text boxes, and may be limited to a defined set of characters based on how the questions was established in the RFP/RFI portal. Many of the text area questions may be limited to 255 characters to limit carrier responses.

The user interface 7800 may include a contracts title 7805, a first agreement ID 7812, first agreement text 7810, a first agreement response entry field 7811, a second agreement ID 7817, second agreement text 7815, a second agreement response entry field 7816, a third agreement ID 7827, third agreement text 7825, a third agreement response entry field 7826, and an add/delete attachments selection link 7820. Text Area Responses (Chapter 3): text area responses may be mainly utilized to gather RFP/RFI data on Administrative & Underwriting practices (formerly Chapter 3). However, most of these fields may have character limits established to control the length of carrier responses, providing a more consolidated carrier response review process for the insurance client. The length of the response field may not be changed by a carrier, however, additional documentation for any question in the RFP/RFI may be provided by adding an attachment to the response.

The user interface 7900 may include a benefit ID (e.g., airbag) 7905, a current plant ID 7910, current plan text 7911, proposed changes 7915 with a first option 7916 and a second option 7917, deviations 7918 with a deviations entry field 7919, and a % change to current rate 7920 with a first option entry field 7921 and a second option entry field 7922. Provision/Proposed Changes Questions: these questions may display current and proposed plan design changes for a given provision, and may ask a carrier to fill out deviations and rate changes for each proposed change. If no proposed changes were requested for a provision, the % change to current rate field may not show.

The user interface 8000 may include a first rate information area 8005 having a proposed rate entry area 8006, a funding arrangement 8007, a rate structure 8008, a rate method 8009, a rate type 8010, a rates guaranteed until date 8011, a minimum participation requirement 8012, a rate comments 8013, a rates effective date 8014, a rate description 8015, a salary changes effective 8016, a composite rate area 8020, a covered lives 8021, a composite rate 8022, a covered monthly volume 8023, and a composite annual premium 8024. The user interface 8000 may further include a second rate information area 8040 having a rate entry area 8045, a funding arrangement 8046, a rate structure 8047, a rate method 8048, a rate type 8049, a rates guaranteed until date 8050, an age change effective date 8051, a minimum participation requirement 8052, a rate comments 8053, a rates effective date 8054, a rate description 8055, a salary changes effective 8056, an age banded rates area 8060, and an age-banded annual premiums area 8065. Rate Questions: the formatting of rate questions may depend on which options are selected for rates defined within the plan classes, e.g. composite, age banded, flat premium.

The user interface 8100 may include a performance guarantees, contracts and reporting area 8105, a performance standards area 8110 with an annual report package 8111, a performance standard definition area 8115 with a goal 8116 and a preferred frequency 8117, a frequency area 8120 with a pull-down selection menu 8121 and a data source pull-down selection menu 8122, a performance standard 8125 with a pull-down selection menu 8126 and a deviations pull-down selection menu 8127, and an add/delete attachments 8130. Performance Guarantee Questions: these questions may require a carrier to define what the minimum performance standards are for each stipulation, as well as how the performance standard is measured, the frequency of measurement, and the overall amount at risk. RFP/RFI creator standards may be included for each requested measurement.

The user interface 8200 may include a benefit calculations and check cutting area 8205 with a do you offer this service question with pull-down answer selection menu 8210 and an included in quote fee question with pull-down answer selection menu 8215, an additional PEPM fee 8220 with a first help selection link, an additional flat fee entry field with a second help selection icon 8226, a percent load to quoted PEPM rate entry area 823 with a third help selection icon 8245, an additional per claim fee entry area 8235 with a forth help selection icon 8250, and a comments entry area 8240. ASO Services Questions: these questions may only display for Self-Insured coverages and may ask carriers to define the services they offer based on the standard ASO Services library. Disabling logic may be included based on whether services are offered and if the services are included in the quoted rates.

The user interface 8300 may include a miscellaneous area 8305, and an agreement question 8310 with an agreement answer entry 8315 and an explanation entry area 8320. Parent/Child Questions: many picklist questions may be dependent questions which may be set up to display only when certain values are selected. For example, if carriers disagree to terms, a separate question may pop open asking the carrier to explain.

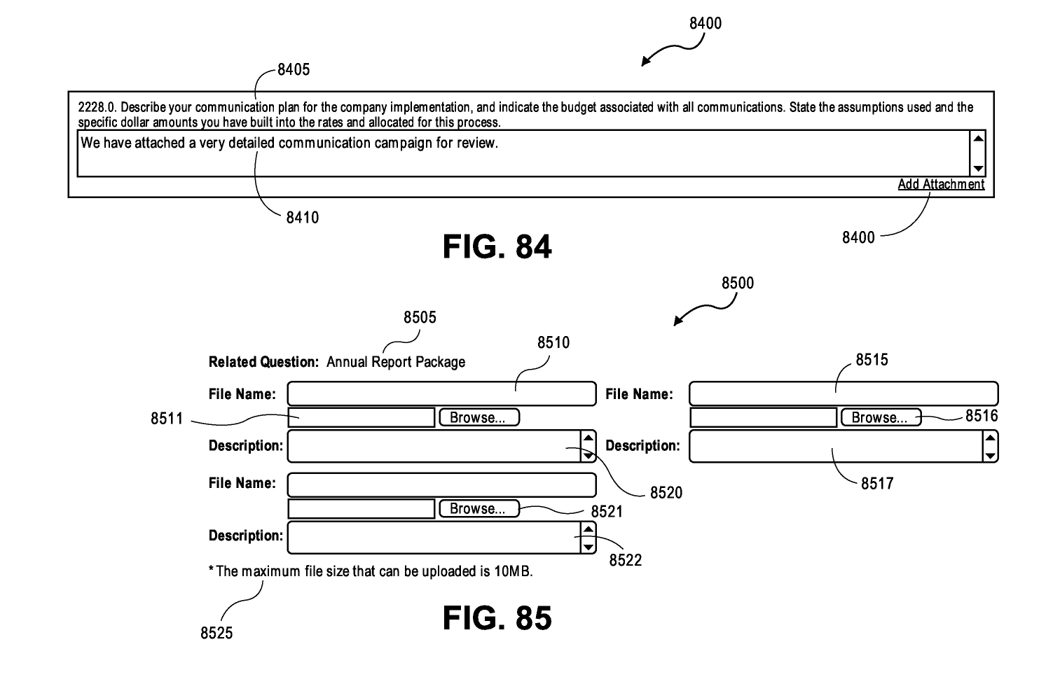

Turning to FIGS. 84 and 85, example user interfaces for attaching files when responding to requests for proposals (RFPs) and/or requests for information (RFIs) 8400, 8500 are depicted. The user interface 8400 may include a communication plan instruction 8405 with a response entry area 8410. In order to upload an attachment to a response, a carrier may first save the question response by selecting a save selection icon for the page. An upload link may display after saving the page.

The user interface 8500 may include a related questions area 8505, a first file name area 8510 with a first browse selection icon 8511 and a first description entry field 8512, a second file name area with a second browse selection icon 8516 and a second description entry field 8517, a third file name area 8520 with a third browse selection icon 8521 and a third description entry field 8522, and a maximum file size indication 8525. Attachments may be uploaded and displayed under the carrier response in the RFP/RFI portal. There may be a maximum attachment size of, for example, 10 MB per attachment, however, a user may attach as many different documents as needed per question.

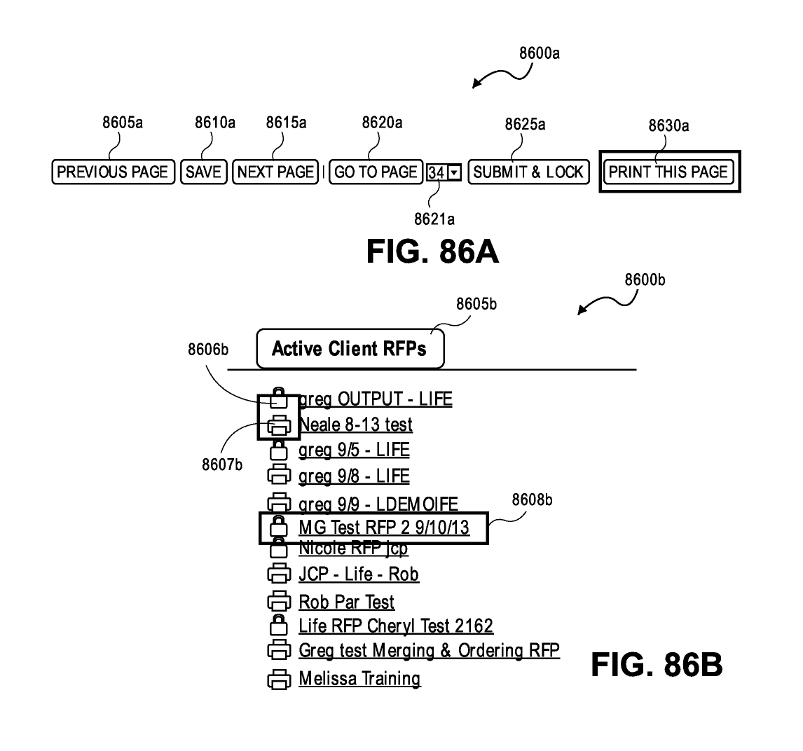

With reference to FIGS. 86A and 86B, example user interfaces for printing requests for proposals (RFPs) and/or requests for information (RFIs) 8600A, 8600B are depicted. The user interface 8600a may include a pervious page selection icon 8605a, a save selection icon 8610a, a next page selection icon 8615a, a go to page selection icon 8620a with a page selection pull-down menu 8621a, a submit and lock selection icon 8625a, and a print this page selection icon 8630a. Different print options may be available, depending on the status of the RFP. Insurance carriers may print the RFP/RFI at any time by, for example, selecting a print this page selection icon 8630a.

The user interface 8600b may include an active client RFPs/RFIs area 8605b with a plurality of insurance client lock selection icons 8606b, 8608b and a plurality of insurance client print selection icons 8607b. For an open RFP/RFI, a carrier may print each page or by selecting the print selection icon 8607b from the main carrier login page. Once the RFP/RFI is locked, the RFP/RFI is available in a printable format simply by selecting the RFP/RFI name from the main portal login page. For each phase of the RFP/RFI timeline, carriers may review and submit the RFP/RFI response to meet established deadlines. Examples of these rounds include: intent to Bid/Bidder Declarations; final RFP/RFI Submission; a RFP/RFI manager may manually lock the RFP/RFI at the Bidder Declaration deadline (4:00 CST on the date provided in the timeline). All carriers may be locked out of the RFP/RFI until the following morning when the RFP/RFI may be released for completion by the RFP/RFI manager. The RFP/RFI may be locked on the earlier of the final submission deadline (manual lock by RFP/RFI manager) or the date the carrier submits the final proposal. All correspondence regarding the RFP/RFI may be submitted through the RFP/RFI Portal. Any additional documentation supplied outside of the portal may not be considered in the bidder evaluation process. Should the RFP/RFI response require additional documentation as requested by the client or the RFP/RFI requestor, the carrier may contact the RFP/RFI manager to obtain access to the RFP. The RFP/RFI manager may “unlock” the RFP/RFI for a set timeframe to allow for updates to the proposal. Each change made after the initial RFP/RFI submission may be monitored and tracked by the RFP/RFI requestor, which allows compiling a history of carrier RFP/RFI response(s).

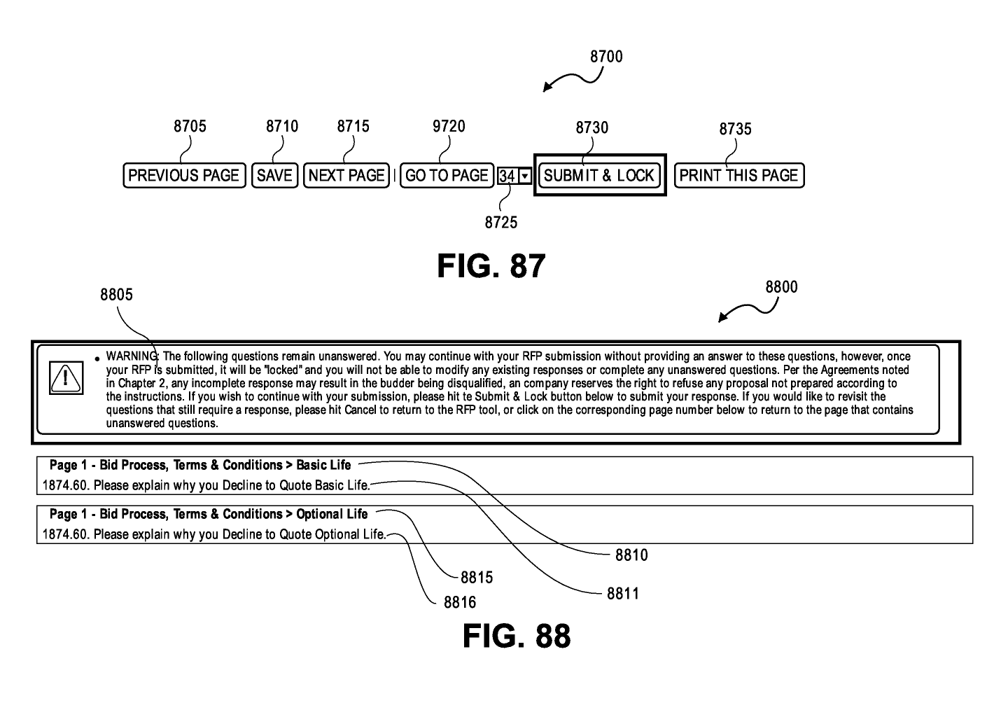

Turning to FIGS. 87 and 88, example user interfaces for locking requests for proposals (RFPs) and/or requests for information (RFIs) 8700, 8800 are depicted. The user interface 8700 may include a pervious page selection icon 8705, a save selection icon 8710, a next page selection icon 8715, a go to page selection icon 8720 with a page selection pull-down menu 8725, a submit and lock selection icon 8730, and a print this page selection icon 8735. Different print options may be available, depending on the status of the RFP. Insurance carriers may print the RFP/RFI at any time by, for example, selecting a print this page selection icon 8735. To submit a bidder declarations and/or a final RFP/RFI response, the carrier may: 1) select the submit and lock selection icon 8730; 2) review all questions that were not filled out. As part of the Review & Submit process, the RFP/RFI portal may identify which questions have not been completed and display them for review. The Carrier may select each page to complete the questions before the final submit and lock.; 3) selecting the submit and lock selection icon 8730 to submit the RFP/RFI to the RFP/RFI requestor. The user interface 8800 may include a warning banner 8805, a page 1 bid process terms and conditions, basic life area 8810 with a first instruction 8811, and a bid process, terms and conditions, optional life area 8815 with a second instruction 8816.

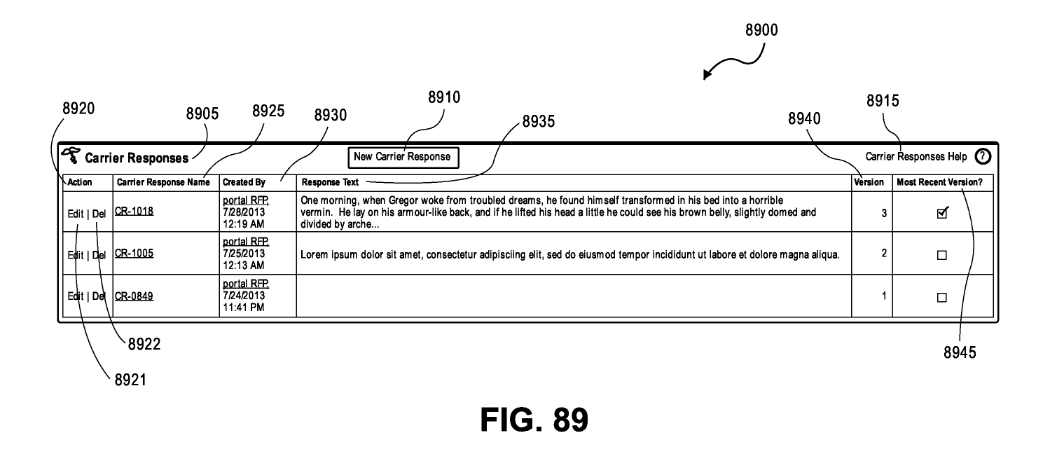

With reference to FIG. 89, an example user interface for versioning responses for requests for proposals (RFPs) and/or requests for information (RFIs) 8900 may include a carrier responses title 8905, a new carrier response selection icon 8910, a carrier responses help selection link 8915, an action column with an edit selection link 8921 and a delete selection link 8922, a carrier response name selection link column 8925, a created by selection link column 8930, a response text column 8935, a version column 8940, and a most recent version column 8945. Each time a carrier submits and locks the RFP, the RFP/RFI portal may create a ‘version’ of the answers so that any future answers may be logged. By default, each new set of responses may become the ‘most recent version’ so that the RFP/RFI requestor may drill into a question and see a history of carrier responses. This process may replace email trail or chapter updates utilized in the RPF process. All additional information provided by the carrier may be entered into the portal, including: plan design changes; rate changes; and additional attachments.

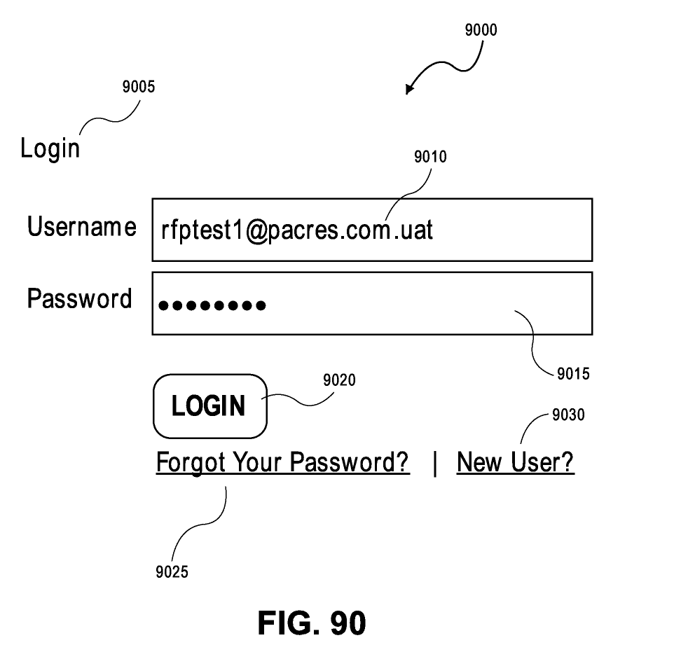

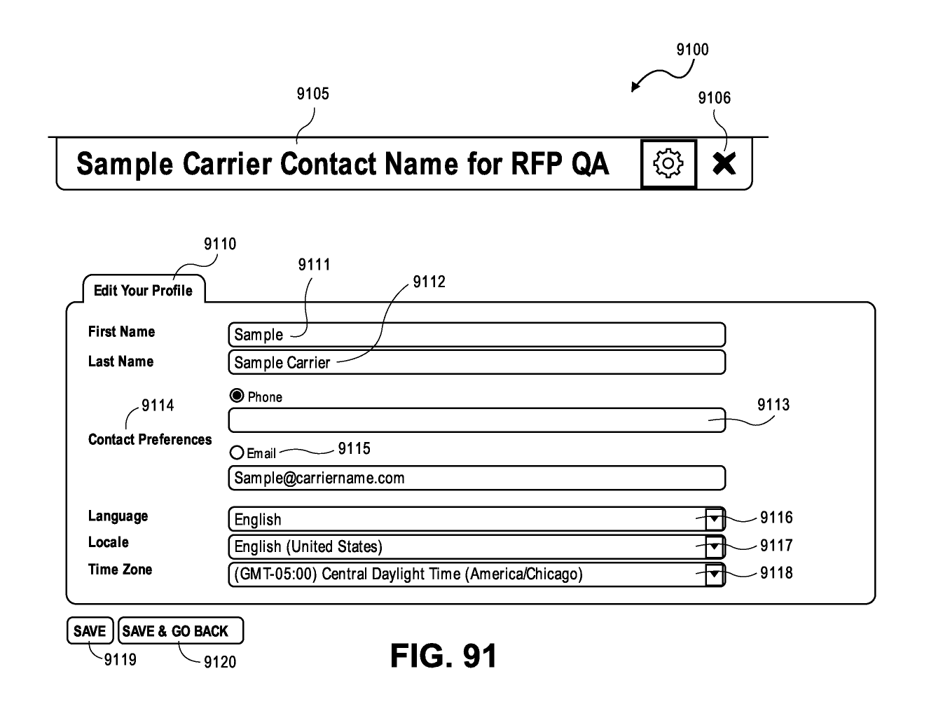

With reference to FIGS. 90 and 91, example additional features for requests for proposals (RFPs) and/or requests for information (RFIs) 9000, 9100 are depicted. The user interface 9000 may include a login title 9005, a username entry field 9010, a password entry field 9015, a login selection icon 9020, a forgot your password selection link 9025, and a new user selection link 9030. The user interface 9100 may include a sample carrier contact name title 9105, an exit selection icon 9106, an edit profile area 9110 with a first name 9111, a last name 9112, a phone number selection circle and entry field 9113, a contact preferences area 9114 with an email selection circle 9115, language pull-down menu selection 9116, a locale pull-down menu selection 9117, a time zone pull-down selection menu 9118, a save selection icon 9119, and a same and go back selection icon 9120. In addition to the main portal question screens, there may be a number of additional features for the carrier, including: forgotten password functionality which allows users to manage password credentials, based on the main email address associated with the portal user account. A request for a password reset will go to the person who established the portal user account. If multiple individuals are logging on under the same user name and, for example, the UW may need to reset the password, the reset request may go to the email address of the person who established the account. The default email address for the portal user account may be the main sales representative identified at each carrier. Carriers may choose to modify this email address by, for example, accessing the profile page. The profile page may be accessible by selecting a settings icon on the top right-hand corner of a portal screen. The profile page may allow the main portal user to manage contact preferences, language, locale, and time zone preferences.

Turning to FIG. 92, example minor lines of coverage for use in requests for proposals (RFPs) and/or requests for information (RFIs) 9200 may include a plurality of minor lines of coverage 9206, 9207.

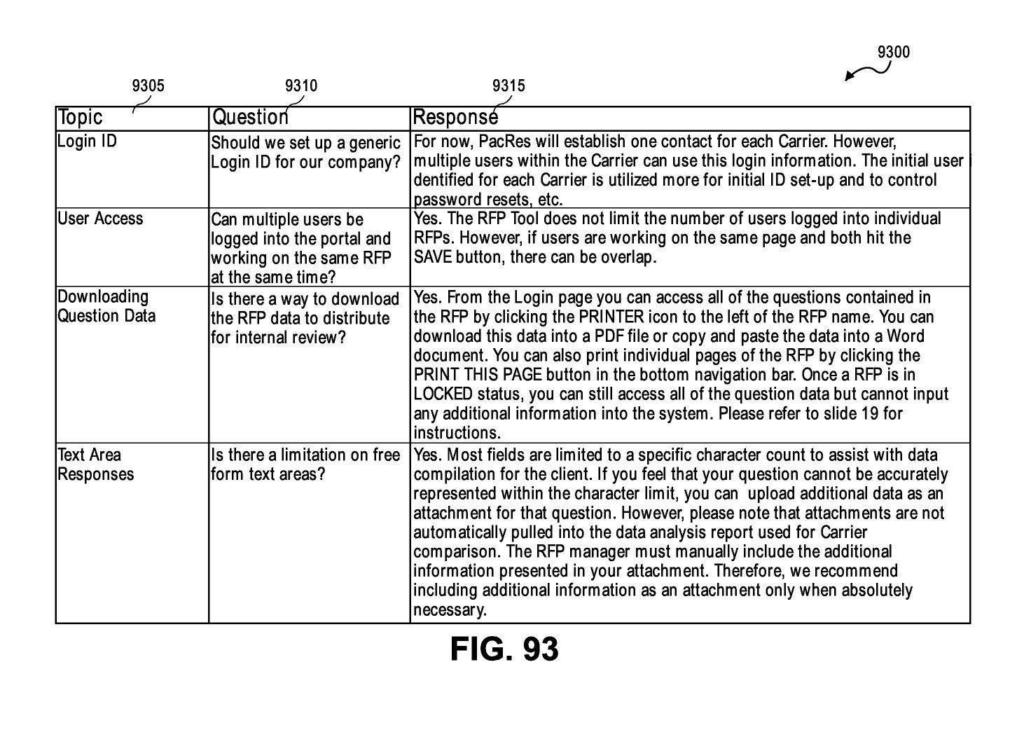

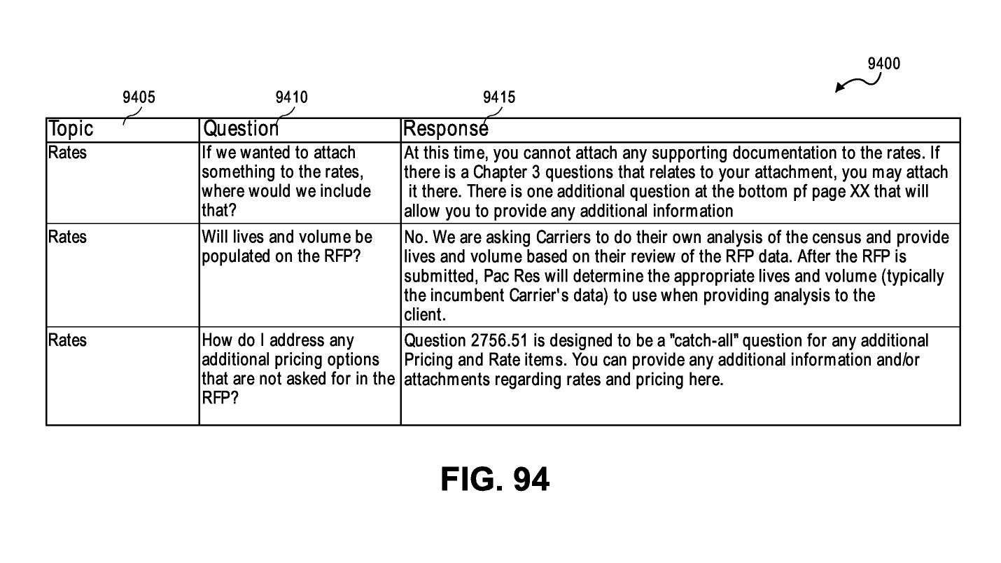

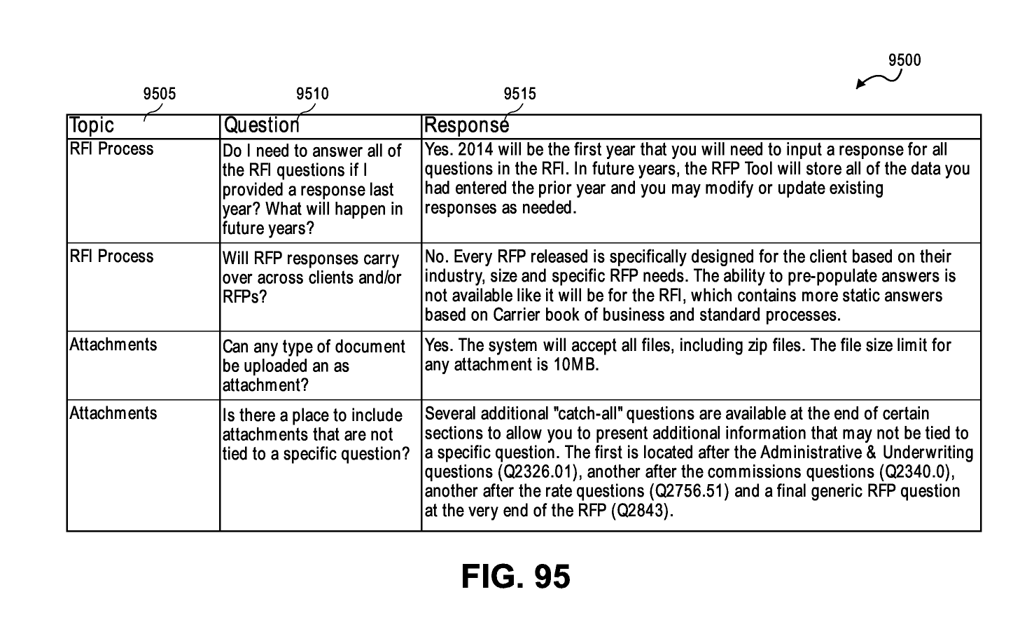

With reference to FIGS. 93-95, example frequently asked questions related to creating and responding to requests for proposals (RFPs) and/or requests for information (RFIs) 9300, 9400, 9500 are depicted. The frequently asked questions 9300, 9400, 9500 may include a topic column 9305, 9405, 9505; a question 9310, 9410, 9510; and a response 9315, 9415, 9515.

This detailed description is to be construed as exemplary only and does not describe every possible embodiment, as describing every possible embodiment would be impractical, if not impossible. One could implement numerous alternate embodiments, using either current technology or technology developed after the filing date of this application.

What is claimed is:

1. A system for generating an insurance related request for proposal (RFP) and/or a request for information (RFI), the system comprising:
a computing device having a memory and a processor;
a RFP/RFI question data receiving module stored on the memory that, when executed by the processor, causes the processor to receive RFP/RFI question data, wherein the RFP/RFI question data is representative of RFP/RFI questions to be included in the RFP and/or the RFI, and wherein at least some of the RFP/RFI questions include a respective information merge field;
a RFP/RFI creation data receiving module stored on the memory that, when executed by the processor, causes the processor to receive RFP/RFI creation data, wherein the RFP/RFI creation data is representative of information related to insurance products and insurance carriers to be included in the RFP and/or the RFI, and wherein the RFP/RFI creation data further includes information merge data;
a RFP/RFI question data and information merge data merging module stored on the memory that, when executed by the processor, causes the processor to merge the information merge data into at least one information merge field of at least one RFP/RFI question to generate RFP/RFI merged question data; and
a RFP/RFI generation module stored on the memory that, when executed by the processor, causes the processor to generate a RFP and/or a RFI based on at least a portion of the RFP/RFI question data, the RFP/RFI creation data and the RFP/RFI merged question data.

2. The system of claim 1, further comprising:
a second computing device having a second memory and a second processor; and
a RFP/RFI response data generation module stored on either the memory and/or the second memory that, when executed by either the processor and/or the second processor, causes the processor and/or the second processor to generate RFP/RFI response data, wherein the RFP/RFI response data is representative of a carrier response to the RFP and/or the RFI.

3. The system of claim 1, wherein:
the RFP/RFI question data includes lines of coverage data; and
RFP/RFI questions are included in the RFP and/or RFI based on the lines of coverage data.

4. The system of claim 3, wherein the lines of coverage data is representative of at least one line of coverage selected from the group: basic accidental death and dismemberment, basic life, California statutory short term disability, dependent life, disability reserve buy-out, family medical leave, fully-insured basic long term disability, fully-insured basic short term disability, fully-insured dental, fully-insured long term disability (core/buy-up), fully-insured short term disability (core/buy-up), fully-insured vision, fully-insured voluntary long term disability, fully-insured voluntary short term disability, group universal life, group voluntary universal life, Hawaii statutory short term disability, international business travel accident, leave of absence, New Jersey statutory short term disability, New York statutory short term disability, optional accidental death and dismemberment, optional life, Puerto Rico statutory short term disability, retiree life, retiree life Russian brotherhood organization, self-insured basic long term disability, self-insured basic short term disability/salary continuation, self-insured dental, self-insured long term disability (core/buy-up), self-insured short term disability (core/buy-up), self-insured vision, self-insured voluntary long term disability, self-insured voluntary short term disability, survivor income benefit, U.S. business travel accident, or worker's compensation.

5. The system of claim 1, wherein:
the RFP/RFI data includes insurance carrier data, wherein the insurance carrier data is representative of insurance carriers that are invited to respond to the RFP and/or the RFI; and
RFP/RFI questions are automatically included in the RFP and/or the RFI are based on the insurance carrier data.

6. The system of claim 1, wherein the a RFP/RFI question data receiving module, the RFP/RFI creation data receiving module, the RFP/RFI question data and information merge data merging module, and the RFP/RFI generation module are stored on a memory of a remote computing device, and are executed by a processor of the remote computing device, in response to a user of a requestor device logging onto the remote computing device.

7. The system of claim 1, wherein the RFP/RFI question data is representative of a library of RFP/RFI questions, and wherein only a portion of the RFP/RFI questions are automatically included in the RFP and/or the RFI based on insurance carrier data.

8. The system of claim 1, further comprising:
a RFP/RFI question data generation module stored on the memory that, when executed by the processor, causes the processor to generate RFP/RFI question data in response to RFP/RFI questions entered by a user via a user interface; and
a RFP/RFI question data storage module stored on the memory that, when executed by the processor, causes the processor to store the RFP/RFI question data in a RFP/RFI question library database.

9. A computer implemented method for generating an insurance related request for proposal (RFP) and/or a request for information (RFI), the method comprising:
receiving RFP/RFI question data in response to a processor executing a RFP/RFI question data receiving module, wherein the RFP/RFI question data is representative of a library of RFP/RFI questions;
receiving RFP/RFI creation data in response to the processor executing a RFP/RFI creation data receiving module that, when executed by the processor, causes the processor to, wherein the RFP/RFI creation data is representative of information related to insurance products and insurance carriers to be included in the RFP and/or the RFI, and wherein the RFP/RFI creation data further includes lines of coverage data;
generating included RFP/RFI question data in response to the processor executing an included RFP/RFI question data generation module, wherein the included RFP/RFI question data is representative of a first sub-set of RFP/RFI questions contained within the library of RFP/RFI questions, wherein the included RFP/RFI question data is based on the lines of coverage data, and wherein the library of RFP/RFI questions contains a second sub-set of RFP/RFI questions that are not included in the included RFP/RFI question data; and
generating a RFP and/or a RFI based on the RFP/RFI included RFP/RFI question data and the RFP/RFI creation data in response to the processor executing a RFP/RFI generation module.

10. The method of claim 9, further comprising:
generating RFP/RFI response data in response to a processor executing a RFP/RFI response data generation module, wherein the RFP/RFI response data is representative of a carrier response to the RFP and/or the RFI.

11. The method of claim 9, wherein:
at least some of the RFP/RFI questions include a respective information merge field, and wherein the RFP/RFI creation data further includes information merge data; and
merging the information merge data into at least one information merge field of at least one RFP/RFI question to generate RFP/RFI merged question data in response to a processor executing an RFP/RFI question data and information merge data merging module.

12. The method of claim 9, wherein:
the RFP/RFI data further includes insurance carrier data, wherein the insurance carrier data is representative of insurance carriers that are invited to respond to the RFP and/or the RFI; and
automatically including RFP/RFI questions in the RFP and/or the RFI based on the insurance carrier data.

13. The method of claim 9, wherein the RFP/RFI question data is representative of a library of RFP/RFI questions, and wherein only a portion of the RFP/RFI questions are automatically included in the RFP and/or the RFI based on insurance carrier data.

14. The method of claim 9, further comprising:
generating RFP/RFI question data in response to a processor executing a RFP/RFI question data generation module and further in response to RFP/RFI questions entered by a user via a user interface; and
storing the RFP/RFI question data in a RFP/RFI question library database in response to a processor executing a question data storage module.

15. A non-transitory computer-readable medium storing instructions that, when executed by a processor, cause the processor to generate an insurance related request for proposal (RFP) and/or a request for information (RFI), the non-transitory computer-readable medium comprising:
a RFP/RFI question data receiving module that, when executed by a processor, causes the processor to receive RFP/RFI question data, wherein the RFP/RFI question data is representative of a library of RFP/RFI questions;
a RFP/RFI creation data receiving module that, when executed by a processor, causes the processor to receive RFP/RFI creation data, wherein the RFP/RFI creation data is representative of information related to insurance products and insurance carriers to be included in the RFP and/or the RFI, and wherein the RFP/RFI creation data further includes lines of coverage data;
an included RFP/RFI question data generation module that, when executed by a processor, causes the processor to generate included RFP/RFI question data, wherein the included RFP/RFI question data is representative of a first sub-set of RFP/RFI questions contained within the library of RFP/RFI questions, wherein the included RFP/RFI question data is based on the lines of coverage data, and wherein the library of RFP/RFI questions contains a second sub-set of RFP/RFI questions that are not included in the included RFP/RFI question data; and
a RFP/RFI generation module that, when executed by a processor, causes the processor to generate a RFP and/or a RFI based on the RFP/RFI included RFP/RFI question data and the RFP/RFI creation data.

16. The non-transitory computer-readable medium of claim 15, further comprising:
a RFP/RFI response data generation module that, when executed by a processor, causes the processor to generate RFP/RFI response data, wherein the RFP/RFI response data is representative of a carrier response to the RFP and/or the RFI.

17. The non-transitory computer-readable medium of claim 15, wherein:
at least some of the RFP/RFI questions include a respective information merge field, and wherein the RFP/RFI creation data further includes information merge data; and
an RFP/RFI question data and information merge data merging module that, when executed by a processor, causes the processor to merge the information merge data into at least one information merge field of at least one RFP/RFI question to generate RFP/RFI merged RFP/RFI question data.

18. The non-transitory computer-readable medium of claim 15, wherein:
the RFP/RFI data further includes insurance carrier data, wherein the insurance carrier data is representative of insurance carriers that are invited to respond to the RFP and/or the RFI; and
RFP/RFI questions are automatically included in the RFP and/or the RFI based on the insurance carrier data.

19. The non-transitory computer-readable medium of claim 15, wherein the RFP/RFI question data is representative of a library of RFP/RFI questions, and wherein only a portion of the RFP/RFI questions are automatically included in the RFP and/or the RFI based on insurance carrier data.

20. The non-transitory computer-readable medium of claim 15, further comprising:
a RFP/RFI question data generation module that, when executed by a processor, causes the processor to generate RFP/RFI question in response to RFP/RFI questions entered by a user via a user interface; and
a RFP/RFI question data storage module that, when executed by a processor, causes the processor to store the RFP/RFI question data in a RFP/RFI question library database.
